(19) United States
(12) Patent Application Publication
(10) Pub. No.: US 2021/0206670 A1
(43) Pub. Date: Jul. 8, 2021

(54) COMPOSITIONS AND METHODS FOR REMOVAL OF PER- AND POLYFLUOROALKYL SUBSTANCES (PFAS)

(71) Applicant: AUBURN UNIVERSITY, Auburn, AL (US)

(72) Inventors: Dongye ZHAO, Auburn, AL (US); Wen LIU, Auburn, AL (US); Fan LI, Auburn, AL (US); Tianyuan XU, Auburn, AL (US); Yangmo ZHU, Auburn, AL (US); Jun DUAN, Auburn, AL (US); Zongsu WEI, Auburn, AL (US)

(21) Appl. No.: 17/032,291

(22) Filed: Sep. 25, 2020

Related U.S. Application Data
(60) Provisional application No. 62/906,922, filed on Sep. 27, 2019.

(51) Int. Cl. C02F 1/58; B01J 21/06; C02F 1/28; B01D 53/02; C02F 101/36

(52) U.S. Cl. CPC C02F 1/58; B01J 21/063; C02F 1/281; C02F 2101/36; B01D 2253/102; C02F 2305/10; B01D 53/02

(57) ABSTRACT

The invention relates to composite compositions including a carbonaceous material and a photocatalyst. The invention includes compositions and various methods, including methods for removing one or more contaminants from a substance such as air, soil, and water.

### CROSS-REFERENCE TO RELATED APPLICATIONS

This application claims priority under 35 U.S.C. § 119(e) to U.S. Provisional Application No. 62/906,922, filed Sep. 27, 2019, which is expressly incorporated by reference herein in its entirety.

### GOVERNMENT SUPPORT CLAUSE

This invention was made with government support under Contract No. ER18-1515, awarded by the U.S. Department of Defense—Strategic Environmental Research and Development Program (SERDP). Further, this invention was made with government support under W912HQ-18-C-0063, awarded by the U.S. Army Corps of Engineers. The government has certain rights in the invention.

### TECHNICAL FIELD

The invention relates to composite compositions including a carbonaceous material and a photocatalyst. The invention includes compositions and various methods, including methods for removing one or more contaminants from a substance such as air, soil, and water.

### BACKGROUND AND SUMMARY

Perfluoroalkyl substances and polyfluoroalkyl substances (i.e., “PFAS”) have been widely used since the 1940s in numerous industrial and consumer applications, including fluoropolymeric surfactants, aqueous film-forming foams, metal plating, and textile and household products. PFAS are extremely persistent to environmental degradation and biological processes due to the high electronegativity of fluorine and strong stability of the C—F bonds. As a result, the discharge of PFAS-laden wastewater and release from PFAS-laden solid waste have caused widespread detection of PFAS in soil, groundwater and surface waters. In particular, PFAS contaminants include perfluorooctanoic acid (PFOA) and perfluorooctanesulfonic acid (PFOS).

However, conventional treatment technologies, including both oxidative and reductive processes, are ineffective for removal of PFAS from substances. Accordingly, the present disclosure provides composite compositions including a carbonaceous material and a photocatalyst and methods of utilizing the composite compositions.

The composite compositions and methods of the present disclosure provide several advantages compared to alternatives known in the art. First, the novel the composite compositions offer an improved mechanism for removal of contaminants from multiple contaminated substances.

Second, the composite compositions of the present disclosure provide a synergistic effect in adsorption and degradation of contaminants. The degradation of contaminants can result in regeneration of the composite compositions and allow for use in multiple operations, including consecutive cycles of performing the method.

Third, the composite compositions of the present disclosure provide an innovative “Concentrate-&-Destroy” strategy to remove contaminants. For instance, low concentrations of PFAS can first be concentrated on the composite compositions and then photodegraded in situ. Compared to methods of directly treating bulk contaminated substances using energy- or chemical-intensive approaches, the “Concentrate-&-Destroy” strategy can be a cost-effective and energy-efficient alternative to achieve contaminant removal.

The following numbered embodiments are contemplated and are non-limiting:

1. A composite composition comprising a carbonaceous material and a photocatalyst.
2. The composite composition of clause 1, any other suitable clause, or any combination of suitable clauses, wherein the carbonaceous material comprises charcoal.
3. The composite composition of clause 2, any other suitable clause, or any combination of suitable clauses, wherein the charcoal is activated charcoal, powder activated charcoal, activated carbon fibers, biochar, or a mixture thereof.
4. The composite composition of clause 1, any other suitable clause, or any combination of suitable clauses, wherein the carbonaceous material comprises activated charcoal (AC).
5. The composite composition of clause 1, any other suitable clause, or any combination of suitable clauses, wherein the carbonaceous material comprises a carbon sphere (CS).
6. The composite composition of clause 1, any other suitable clause, or any combination of suitable clauses, wherein the carbonaceous material comprises particles formed via hydrothermal treatment of a hydrocarbon precursor.
7. The composite composition of clause 6, any other suitable clause, or any combination of suitable clauses, wherein the hydrocarbon precursor is a sugar.
8. The composite composition of clause 6, any other suitable clause, or any combination of suitable clauses, wherein the hydrocarbon precursor is a polysugar.
9. The composite composition of clause 1, any other suitable clause, or any combination of suitable clauses, wherein the carbonaceous material comprises graphite.
10. The composite composition of clause 1, any other suitable clause, or any combination of suitable clauses, wherein the carbonaceous material comprises graphene.
11. The composite composition of clause 1, any other suitable clause, or any combination of suitable clauses, wherein the carbonaceous material comprises graphite carbon nitride.
12. The composite composition of clause 1, any other suitable clause, or any combination of suitable clauses, wherein the photocatalyst comprises a metallic nanotube.
13. The composite composition of clause 12, any other suitable clause, or any combination of suitable clauses, wherein the metallic nanotube is a titanium nanotube.
14. The composite composition of clause 1, any other suitable clause, or any combination of suitable clauses, wherein the photocatalyst comprises a metal.
15. The composite composition of clause 14, any other suitable clause, or any combination of suitable clauses, wherein the metal is selected from the group consisting of titanium, iron, gallium, bismuth, and any combination thereof.
16. The composite composition of clause 1, any other suitable clause, or any combination of suitable clauses, wherein the photocatalyst comprises a metallic oxide.
17. The composite composition of clause 16, any other suitable clause, or any combination of suitable clauses, wherein the metallic oxide is titanate.
18. The composite composition of clause 17, any other suitable clause, or any combination of suitable clauses, wherein the titanate is a titanate nanotube.
19. The composite composition of clause 17, any other suitable clause, or any combination of suitable clauses, wherein the titanate is a titanate nanosheet.
20. The composite composition of clause 16, any other suitable clause, or any combination of suitable clauses, wherein the metallic oxide is titanium dioxide (TiO₂).
21. The composite composition of clause 16, any other suitable clause, or any combination of suitable clauses, wherein the metallic oxide is iron (hydr)oxide (FeO).
22. The composite composition of clause 1, any other suitable clause, or any combination of suitable clauses, wherein the photocatalyst comprises bismuth phosphate (BiOHP).
23. The composite composition of clause 1, any other suitable clause, or any combination of suitable clauses, wherein the photocatalyst is conjugated with the carbonaceous material.
24. The composite composition of clause 1, any other suitable clause, or any combination of suitable clauses, wherein the composite composition comprises a dopant.
25. The composite composition of clause 24, any other suitable clause, or any combination of suitable clauses, wherein the dopant is a metal.
26. The composite composition of clause 24, any other suitable clause, or any combination of suitable clauses, wherein the dopant is a metal oxide.
27. The composite composition of clause 24, any other suitable clause, or any combination of suitable clauses, wherein the dopant is selected from the group consisting of iron, cobalt, nickel, gallium, bismuth, palladium, copper, aluminum, zirconium, platinum, and any combination thereof.
28. The composite composition of clause 24, any other suitable clause, or any combination of suitable clauses, wherein the dopant comprises iron.
29. The composite composition of clause 24, any other suitable clause, or any combination of suitable clauses, wherein the dopant comprises gallium.
30. A method of removing one or more contaminants from an environmental medium, the method comprising the step of contacting a composite composition according any one of above clauses with the environmental medium to adsorb the contaminant on a surface of the composite composition.
31. The method of clause 30, any other suitable clause, or any combination of suitable clauses, wherein the contaminant is a per- and polyfluoroalkyl substance (PFAS).
32. The method of clause 31, any other suitable clause, or any combination of suitable clauses, wherein the PFAS is perfluorooctanoic acid (PFOA).
33. The method of clause 31, any other suitable clause, or any combination of suitable clauses, wherein the PFAS is perfluorooctane sulfonate (PFOS).
34. The method of clause 30, any other suitable clause, or any combination of suitable clauses, wherein the environmental medium is air.
35. The method of clause 30, any other suitable clause, or any combination of suitable clauses, wherein the environmental medium is soil.
36. The method of clause 30, any other suitable clause, or any combination of suitable clauses, wherein the environmental medium is water.
37. The method of clause 36, any other suitable clause, or any combination of suitable clauses, wherein the pH of the contaminated water is selected from a range of about 2 to about 12.
38. The method of clause 36, any other suitable clause, or any combination of suitable clauses, wherein the water is wastewater.
39. The method of clause 30, any other suitable clause, or any combination of suitable clauses, wherein the adsorption comprises a mechanism selected from the group consisting of an electrostatic interaction, a Lewis acid-base interaction, a surface complexation, and any combination thereof, between the contaminant and the composite composition.
40. The method of clause 30, any other suitable clause, or any combination of suitable clauses, wherein the method further comprises the step of degrading the contaminant.
41. The method of clause 40, any other suitable clause, or any combination of suitable clauses, wherein the degrading comprises photocatalytic mineralization of the contaminant.
42. The method of clause 40, any other suitable clause, or any combination of suitable clauses, wherein the degrading comprises defluoridating the contaminant.
43. The method of clause 30, any other suitable clause, or any combination of suitable clauses, wherein the method further comprises the step of regenerating the composite composition.
44. The method of clause 43, any other suitable clause, or any combination of suitable clauses, wherein the step of regenerating comprises degrading the contaminant.
45. The method of clause 44, any other suitable clause, or any combination of suitable clauses, wherein the degrading is carried out by exposing the pre-adsorbed contaminant to light.
46. The method of clause 45, any other suitable clause, or any combination of suitable clauses, wherein the light is ultraviolet light.
47. The method of clause 45, any other suitable clause, or any combination of suitable clauses, wherein the light is sunlight.
48. The method of clause 30, any other suitable clause, or any combination of suitable clauses, wherein the composite composition produces radicals in response to being exposed to light.
49. The method of clause 48, any other suitable clause, or any combination of suitable clauses, wherein the radicals comprise a substance selected from the group consisting of holes, electrons, reactive oxygen species, and any combination thereof.
50. The method of clause 48, any other suitable clause, or any combination of suitable clauses, wherein the light is ultraviolet light.
51. The method of clause 48, any other suitable clause, or any combination of suitable clauses, wherein the light is sunlight.
52. The method of clause 30, any other suitable clause, or any combination of suitable clauses, wherein the environmental medium is soil, and wherein the method further comprises a step of desorption.
53. The method of clause 52, any other suitable clause, or any combination of suitable clauses, wherein the step of desorption comprises contacting the contaminant with an oil dispersant.
54. The method of clause 53, any other suitable clause, or any combination of suitable clauses, wherein the oil dispersant comprises Corexit 9500A.
55. The method of clause 52, any other suitable clause, or any combination of suitable clauses, wherein the step of desorption comprises contacting the contaminant with a surfactant.
56. The method of clause 30, any other suitable clause, or any combination of suitable clauses, wherein the method comprises repeating the step of contacting the composite composition with the environmental medium to form a composite-contaminant complex.
57. The method of clause 56, any other suitable clause, or any combination of suitable clauses, wherein the initial step of contacting and the repeated step of contacting are performed consecutively.
58. The method of clause 56, any other suitable clause, or any combination of suitable clauses, wherein the method comprises 3 repetitions of the step of contacting the composite composition with the environmental medium to form a composite-contaminant complex.
59. The method of clause 56, any other suitable clause, or any combination of suitable clauses, wherein the method comprises 4 repetitions of the step of contacting the composite composition with the environmental medium to form a composite-contaminant complex.
60. The method of clause 56, any other suitable clause, or any combination of suitable clauses, wherein the method comprises 5 repetitions of the step of contacting the composite composition with the environmental medium to form a composite-contaminant complex.
61. The method of clause 56, any other suitable clause, or any combination of suitable clauses, wherein the method comprises 6 repetitions of the step of contacting the composite composition with the environmental medium to form a composite-contaminant complex.
62. The method of clause 56, any other suitable clause, or any combination of suitable clauses, wherein the method comprises 7 repetitions of the step of contacting the composite composition with the environmental medium to form a composite-contaminant complex.
63. The method of clause 56, any other suitable clause, or any combination of suitable clauses, wherein the method comprises 8 repetitions of the step of contacting the composite composition with the environmental medium to form a composite-contaminant complex.
64. The method of clause 56, any other suitable clause, or any combination of suitable clauses, wherein the method comprises 9 repetitions of the step of contacting the composite composition with the environmental medium to form a composite-contaminant complex.
65. The method of clause 56, any other suitable clause, or any combination of suitable clauses, wherein the method comprises 10 repetitions of the step of contacting the composite composition with the environmental medium to form a composite-contaminant complex.
66. The method of clause 56, any other suitable clause, or any combination of suitable clauses, wherein the method comprises more than 10 repetitions of the step of contacting the composite composition with the environmental medium to form a composite-contaminant complex.
67. The method of clause 30, any other suitable clause, or any combination of suitable clauses, wherein at least 75%, at least 85%, at least 90%, or at least 95% of the contaminant is degraded within about four hours.
68. The method of clause 30, any other suitable clause, or any combination of suitable clauses, wherein at least 75%, at least 85%, at least 90%, or at least 95% of the contaminant is degraded within about two hours.
69. The method of clause 30, any other suitable clause, or any combination of suitable clauses, wherein at least 75%, at least 85%, at least 90%, or at least 95% of the contaminant is degraded within about one hour.
70. The method of clause 30, any other suitable clause, or any combination of suitable clauses, wherein the composite composition has a binding capacity of at least 2 mg contaminant per gram of composite composition.
71. The method of clause 30, any other suitable clause, or any combination of suitable clauses, wherein the composite composition has a binding capacity of at least 4 mg contaminant per gram of composite composition.
72. The method of clause 30, any other suitable clause, or any combination of suitable clauses, wherein the composite composition has a binding capacity of at least 10 mg contaminant per gram of composite composition.
73. The method of clause 30, any other suitable clause, or any combination of suitable clauses, wherein the composite composition has a binding capacity of at least 100 mg contaminant per gram of composite composition.
74. The method of clause 30, any other suitable clause, or any combination of suitable clauses, wherein the composite composition has a binding capacity of at least 200 mg contaminant per gram of composite composition.
75. The method of clause 30, any other suitable clause, or any combination of suitable clauses, wherein the composite composition has a binding capacity of at least 500 mg contaminant per gram of composite composition.
76. The method of clause 30, any other suitable clause, or any combination of suitable clauses, wherein the step of contacting is performed for about 2 minutes to about 48 hours.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1A shows an SEM image and FIG. 1B shows the corresponding EDS spectra of Fe/TNTs@AC (Fe=1 wt. %, calcination temperature=550° C.).

FIGS. 2A, 2B, and 2C show TEM images of calcined Fe/TNTs@AC at various scales (circled areas indicate the close-up spots). FIG. 2D shows XRD patterns of F-400, TNTs@AC, and calcined Fe/TNTs@AC.

FIG. 3 shows TEM-EDS mappings of various elements on the surface of Fe/TNTs@AC (Fe=1 wt. %, calcination temperature=550° C.).

FIGS. 4A and 4B demonstrate XPS spectra of Fe/TNTs@AC (Fe=1 wt. %, calcination temperature=550° C.). FIG. 4A shows the survey XPS and FIG. 4B shows high resolution of Fe 2p.

FIG. 5A shows N₂ adsorption-desorption isotherms. FIG. 5B shows pore size distributions of unmodified TNTs@AC and Fe/TNTs@AC. V: Pore volume, and D: pore diameter.

FIG. 6A shows adsorption kinetics of PFOA. FIG. 6B shows adsorption isotherms of PFOA. FIG. 6C shows photodegradation kinetics of PFOA. FIG. 6D shows defluorination of PFOA. Experimental conditions in adsorption kinetic tests (a): initial [PFOA]=100 μg L⁻¹, material dosage=1.0 g L⁻¹, solution volume=40 mL, and pH=7.0±0.3; Conditions in isotherm tests (b): initial [PFOA]=0.1-100 mg L⁻¹, material dosage=1.0 g L⁻¹, solution volume=40 mL, and pH=7.0±0.3, temperature=25° C., and reaction time=24 h; UV in (c) and (d): Wavelength=254 nm, Intensity=21 mW cm⁻².

FIG. 7 shows Zeta potential of Fe/TNTs@AC and TNTs@AC with or without calcination at 550° C. Fe in Fe/TNTs@AC=1 wt. %.

FIG. 8 shows adsorption isotherms of PFOA by Fe/TNTs@AC prepared with 1 wt. % and 5 wt. % Fe and at a calcination temperature of 550° C. Experimental conditions: Initial [PFOA]=100-100 mg L⁻¹; material dosage=1.0 g L⁻¹, solution volume=40 mL, pH=7.0±0.3, temperature=25° C., and equilibration time=24 h.

FIG. 9 shows conceptualized illustration of the adsorption modes and molecular orientation of PFOA on carbon- and Fe-modified TNTs (Fe/TNTs).

FIG. 10A shows calculated on molecular structures of PFOA. FIG. 10B shows calculated on molecular structures of Fe(III) dimer. FIG. 10C shows calculated on molecular structures of mono-dentate complexation. FIG. 10D shows calculated on molecular structures of bi-dentate complexation of PFOA. Optimized geometries are calculated at the B3LYP/6-311+G(d,p) level. The numbers indicate angular values between the bonds.

FIG. 11 shows defluorination of PFOA in control solution (i.e., without photocatalyst) and defluorination of PFOA pre-sorbed on F-400 GAC after 4 h of UV irradiation. Conditions: Initial [PFOA]=100 μg L⁻¹, material dosage=1.0 g L⁻¹, solution volume=40 mL, pH=7.0±0.3. UV wavelength=254 nm, Intensity=21 mW cm².

FIG. 12 shows UV-DRS spectra of TNTs@AC and Fe/TNTs@AC (Fe=1 wt. %, calcination temperature=550° C.).

FIG. 13 shows PL spectra of Fe/TNTs@AC, calcined TNTs@AC, non-calcined Fe/TNTs@AC, and non-calcined TNTs@AC in the presence of terephthalic acid upon UV irradiation. Conditions: material dosage=1 g L⁻¹, NaOH=0.4 M, terephthalic acid=0.1 M, Irradiation time=1 h, excitation=315 nm, and emission=360-490 nm.

FIG. 14A shows defluorination of PFOA by Fe/TNTs@AC calcined at 300, 550, 650, and 850° C. with at a fixed Fe content of 1 wt. %. FIG. 14B shows defluorination of PFOA by Fe/TNTs@AC prepared with Fe contents of 0.5, 1, 3, and 5 wt. % with a fixed calcination temperature of 550° C. Experimental conditions: initial [PFOA]=100 μg L⁻¹, material dosage=1.0 g L⁻¹, solution volume=40 mL, pH=7.0±0.3; UV: Wavelength=254 nm, Intensity=21 mW cm-2.

FIG. 15 demonstrates the effects of solution pH on equilibrium uptake of PFOA by Fe/TNTs@AC (Fe=1 wt. %, calcination temperature=550° C.). Experimental conditions: initial [PFOA]=100 μg L⁻¹, material dosage=1.0 g L⁻¹, solution volume=40 mL, and reaction time=2 h.

FIG. 16 shows pH effect on defluorination of PFOA pre-sorbed on Fe/TNTs@AC. Experimental conditions: Initial [PFOA]=100 μg L⁻¹, material dosage=1.0 g L⁻¹, solution volume=40 mL, and reaction time=4 h; UV: Wavelength=254 nm, Intensity=21 mW cm-2.

FIG. 17 shows adsorption and defluorination of PFOA in six consecutive cycles using the same Fe/TNTs@AC. Experimental conditions: For each adsorption cycle, initial [PFOA]=100 μg L⁻¹, material dosage=1.0 g L⁻¹, solution volume=40 mL, pH=7.0±0.3, adsorption time=2 h; For photodegradation, reaction time=4 h; UV: Wavelength=254 nm, Intensity=21 mW cm-2.

FIG. 18 shows effects of various scavengers on defluorination of PFOA pre-sorbed on Fe/TNTs@AC. Adsorption conditions: Initial [PFOA]=100 μg L⁻¹, material dosage=1.0 g L⁻¹, solution volume=40 mL, pH=7.0±0.3; Photodegradation conditions: UV Wavelength=254 nm, Intensity=21 mW cm⁻². Isopropanol (IP), KI, or benzoquinone (BQ) concentration=0.1 or 1 mM, and reaction time=4 h.

FIG. 19A shows conceptualized illustration of photocatalytic reaction mechanisms of Fe/TNTs@AC. FIG. 19B shows NBO analysis of reactive sites of a PFOA molecule at the B3LYP/6-31+G (d,p) level: Chemical structure of PFOA (numbers indicate the atomic position). FIG. 19C shows electrostatic potential mapping of a model PFOA molecule.

FIG. 20A shows XRD patterns of neat CS, iron oxide (FeO), and FeO/CS (m:n) prepared at various Fe/Glucose molar ratios (m:n). FIG. 20B shows k³-weighted Fe K-edge EXAFS spectra of neat CS, iron oxide (FeO), and FeO/CS (m:n) prepared at various Fe/Glucose molar ratios (m:n). FIG. 20C shows FTIR (c) of neat CS, iron oxide (FeO), and FeO/CS (m:n) prepared at various Fe/Glucose molar ratios (m:n).

FIG. 21 shows fourier-transformed EXAFS spectra of FeO/CS (1:1) with Fh and Ht references.

FIGS. 22A-J shows various patterns of neat FeO, FeO/CS (1:1) and neat CS. FIGS. 22A, 22E, and 22I show SEM of neat FeO, FeO/CS (1:1), and neat CS, respectively. FIGS. 22B and 22F show TEM of neat FeO and FeO/CS (1:1), respectively. FIGS. 22C and 22G show HRTEM of neat FeO and FeO/CS (1:1), respectively. FIGS. 22D and 22H show FFT of neat FeO and FeO/CS (1:1), respectively. FIG. 22J shows EDS elemental mapping of FeO/CS (1:1).

FIG. 23A shows UV-Vis DRS of neat CS, FeO, and FeO/CS prepared at various Fe/C molar ratios. FIG. 23B shows the Tauc plot of (αhv)² versus the photon energy (hv) for FeO/CS (1:1). (α refers to the absorption coefficient).

FIG. 24A shows adsorption kinetics of PFOA by neat CS, neat FeO and FeO/CS prepared at various Fe/Glucose molar ratios. FIG. 24B shows isotherms of PFOA by neat CS, neat FeO and FeO/CS prepared at various Fe/Glucose molar ratios. Experiment conditions: dosage=1.0 g/L, pH=7.0±0.1, initial PFOA=5 mg/L in FIG. 24A and 200 μg/L-10 mg/L in FIG. 24B. qₜ: mass of PFOA adsorbed per unit mass of adsorbent (mg/g).

FIG. 25A shows adsorption kinetics of pre-adsorbed PFOA, by neat CS, FeO, and FeO/CS prepared at various Fe/Glucose molar ratios. FIG. 25B shows photodegradation kinetics of pre-adsorbed PFOA, by neat CS, FeO, and FeO/CS prepared at various Fe/Glucose molar ratios. FIG. 25C shows defluorination kinetics of pre-adsorbed PFOA, by neat CS, FeO, and FeO/CS prepared at various Fe/Glucose molar ratios. Adsorption conditions: dosage=1.0 g/L, initial PFOA=200 μg/L, pH=7.0±0.1; Photodegradation conditions: solar light intensity: 100 mW/cm²; M₀: initial mass of PFOA in the material, and Mₜ: PFOA remaining at time t; Defluorination: conversion of fluorine into fluoride ions.

FIG. 26A shows FTIR patterns of Water contact angles of neat CS. FIG. 27B shows FTIR patterns of FeO/CS (1:1).

FIG. 27A shows FTIR patterns of FeO/CS (1:1). FIG. 27B shows FTIR patterns of neat FeO.

FIG. 28 shows XPS spectra of O1s in FeO/CS (1:1) before and after PFOA adsorption.

FIGS. 29A and 29B show XPS patterns of Fe 2p and F is in FeO/CS (1:1) before and after adsorption and photodegradation of PFOA, respectively. FIGS. 29C and 29D show XPS patterns of neat iron oxide before and after adsorption and photodegradation of PFOA, respectively.

FIG. 30 shows XPS spectra of F is of PFOA adsorbed on neat carbon spheres.

FIG. 31 shows defluorination kinetics of PFOA by FeO/CS (1:1) with or without the pre-concentrating step. Experiment conditions: dosage=1.0 g/L, initial PFOA=200 μg/L, pH=7.0±0.1.

FIG. 32 shows repeated adsorption/photodegradation of PFOA using FeO/CS (1:1) in three consecutive cycles. Experimental conditions: dosage=1.0 g/L, initial PFOA=200 μg/L, pH=7.0±0.1.

FIG. 33 shows XPS spectra of Fe 2p in raw and solar light irradiated FeO/CS (1:1) in the absence of PFOA.

FIG. 34 shows molecular orbitals of PFOA structure showing the HOMO and LUMO. Green: negative phase; Purple: positive phase; Blue: F; Deep grey: C; Light grey: H.

FIG. 35A-35B show simulated binding modes of PFOA on the outer layer of ferrihydrite (FIG. 35A) and hematite (FIG. 35B). Grey: F; Deep brown: C Light brown: Fe; Red: O; Light grey: H.

FIG. 36A-36B show atomic structures of ferrihydrite (FIG. 36A) and hematite (FIG. 36B). Blue: Fe; Red: O Light grey: H.

FIG. 37A shows density of states of PFOA-adsorbed hematite and ferrihydrite. For visual clarity, the data of PFOA is scaled up by a factor of 10. FIG. 37B shows charge density difference of the PFOA-adsorbed hematite. FIG. 37C shows PFOA-adsorbed ferrihydrite. The yellow and blue iso-surfaces represent charge accumulation and depletion in the space, respectively.

FIG. 38 shows photodegradation of PFOA pre-sorbed on FeO/CS (1:1) with or without isopropyl alcohol (ISA). Adsorption conditions: material dosage=1.0 g/L, initial PFOA=200 μg/L, pH=7.0±0.1; Photodegradation: solar light irradiation time=4 h, ISA=0 or 10 mM.

FIG. 39A shows defluorination rate of PFOA by FeO/CS (1:1) with or without ISA. FIG. 39B shows EPR spectra of DMPO-.OH adducts produced by FeO/CS (1:1) under air with or without PFOA and upon solar light irradiation for 20 min.

FIG. 39C shows EPR spectra of DMPO-.OH adducts produced by FeO/CS (1:1) under Ar with or without PFOA and upon solar light irradiation for 20 min. FIG. 39D shows the iso-surface plots of frontier orbitals of C₇F₁₅. when combined with .OH or H₂O, and the corresponding Gibbs free energy change at 298.15 K and reaction enthalpy change. The purple and blue iso-surfaces represent charge accumulation and depletion in the space, respectively. FIG. 39E shows the proposed pathway of PFOA degradation by FeO/CS under solar light.

FIGS. 40A-40B show ESI/MS spectra of the ion peaks assigned as byproducts of PFOA photodegradation by FeO/CS (1:1) (FIG. 40A) and neat FeO (FIG. 40B) after simulated solar light irradiation. Adsorption conditions: material dosage=1.0 g/L, initial PFOA=200 μg/L, pH=7.0±0.1; Photodegradation: reaction time under solar light=4 h.

FIG. 41 shows SEM of neat CS, neat BiOHP, and BiOHP/CS prepared at various BiOHP contents. The squares indicate BiOHP-attached carbon spheres.

FIGS. 42A-C show XRD patterns (FIG. 42A), UV-vis diffuse reflectance spectra (FIG. 42B), and FTIR spectra (FIG. 42C) of neat CS, BiOHP, and BiOHP/CS prepared at various BiOHP contents.

FIG. 43 shows the Tauc plot of (αhv)² versus the photon energy (hv) for neat BiOHP.

FIGS. 44A-D show the DFT optimized models of BiOHP (FIG. 44A), BiOHP/CS (FIG. 44B), CS (FIG. 44C), and defective CS (FIG. 44D).

FIG. 45 shows equilibrium uptakes of PFOA by neat CS, BiOHP, and BiOHP/CS prepared at various BiOHP contents. Experiment conditions: material dosage=1.0 g/L, initial PFOA=5 mg/L, pH=7.0±0.1, adsorption time=2 h.

FIGS. 46A-C show adsorption kinetics of PFOA from water (FIG. 46A); and kinetics of photodegradation (FIG. 46B) and defluorination (FIG. 46C) of the pre-adsorbed PFOA by neat CS, BiOHP, and BiOHP/CS prepared at various BiOHP contents. Adsorption conditions: material dosage=1.0 g/L, initial PFOA=200 μg/L, and pH=7.0±0.1. Photodegradation: UV 254 nm, intensity=21 mW/cm², M₀: initial mass of PFOA in the material, and Mₜ: PFOA remaining at time t. Defluorination: conversion of fluorine into fluoride ions. Data are plotted as mean of duplicates and error bars indicate relative error from the mean.

FIGS. 47A-C show Time dependent in situ ATR-FTIR spectra of adsorbed PFOA on neat CS (FIG. 47A), BiOHP (FIG. 47B), and 9% BiOHP/CS (FIG. 47C).

FIG. 48 shows the water contact angle of neat CS.

FIG. 49 shows F is XPS patterns of neat CS and 9% BiOHP/CS after PFOA adsorption.

FIGS. 50A-B show EPR spectra of neat CS and 9% BiOHP/CS (FIG. 50A); PL spectra of neat BiOHP and 9% BiOHP/CS (FIG. 50B).

FIGS. 51A-E show optimized adsorption modes and charge density distributions of PFOA on CS (FIG. 51A), defective CS with end-on configuration (FIG. 51B) and side-on configuration (FIG. 51C); Density of states of neat BiOHP (FIG. 51D) and BiOHP/CS (FIG. 51E). Yellow: charge accumulation, blue: charge depletion, T: Total; Iso-surface=0.0005.

FIGS. 52A-B show plots of −ln(Mₜ/M₀) versus time for PFOA degradation (FIG. 52A) and −ln(Cₜ/C₀) versus time defluorination (FIG. 52B) by neat BiOHP and 9% BiOHP/CS. PFOA degradation, M₀: initial mass of PFOA in the material, and Mₜ: PFOA remaining at time t; PFOA defluorination, C₀: the total content of fluorine in initial concentration of PFOA, Cₜ: C₀ subtract the concentration of F⁻ formed in solution at time t.

FIGS. 53A-D show photodegradation (4 h) (FIG. 53A) and defluorination kinetics (FIG. 53B) of PFOA pre-sorbed on 9% BiOHP/CS in the presence of various radical scavengers under UV light irradiation; EPR spectra of DMPO-.OH adducts (FIG. 53C) and DMPO-O₂.⁻ adducts (FIG. 53D) produced by neat BiOHP and 9% BiOHP/CS after 20 min UV irradiation. Adsorption conditions: material dosage=1.0 g/L, initial PFOA=200 μg/L, pH=7.0±0.1; Photodegradation conditions: UV 254 nm, intensity=21 mW/cm², ISA (.OH scavenger)=10 mM, BQ (O₂.⁻ scavenger)=10 mM, EDTA (h+ scavenger)=10 mM.

FIGS. 54A-B show XRD patterns of neat BiOHP (FIG. 54A) and 9% BiOHP/CS (FIG. 54B) before and after photoreaction.

FIGS. 55A-B shows photo images of neat BiOHP before (FIG. 55A) and after FIG. 55B) 4 h UV light irradiation.

FIG. 56 shows adsorption photo-mineralization of PFOA using the same 9% BiOHP/CS in four consecutive cycles without regeneration. Experimental conditions: material dosage=1.0 g/L, initial PFOA=200 μg/L, pH=7.0±0.1, UV: 254 nm, time=4 h.

FIG. 57 shows the proposed mechanism and pathway of enhanced photodegradation of PFOA by BiOHP/CS.

FIG. 58 shows ESI/MS spectrum of the ion peaks assigned to byproducts of the PFOA degradation by 9% BiOHP/CS after 4 h UV irradiation. The negative-ion mode was used. Scan range: 100-410 M/Z. Experimental conditions: dosage=1.0 g/L, initial PFOA=200 μg/L, pH=7.0±0.1.

FIG. 59A shows the as-prepared powder Ga/TNTs@AC, whose size, shape and morphology resemble those of Fe/TNTs@AC. FIG. 59B shows that Ga/TNTs@AC was able to rapidly and nearly completely (>99%) remove PFOS from water within 10 min.

FIG. 60A shows that ˜75% of PFOS was photodegraded by Ga/TNTs@AC in 4 h under the UV irradiation. FIG. 60B shows that Ga/TNTs@AC was able to achieve >66% of defluorination.

FIG. 61 compares the defluorination effectiveness of PFOS by Fe/TNTs@AC and Ga/TNTs@AC at the same dosage of 2 g L⁻¹. After 4 h UV irradiation, Ga/TNTs@AC defluorinated 56% of the PFOS, while Fe/TNTs@AC mineralized 46%.

FIG. 62 shows batch equilibrium desorption of PFOS from the Willow Grove Soil using two common oil dispersants (Corexit EC9500A and SPC1000) at various concentrations and with or without NaCl. Experimental conditions: soil mass=2 g, solution volume=40 mL, pH=7±0.2, temperature=22±1° C., equilibrium time=24 h. Error bars refer to standard deviation of triplicates. (Mₑ is the mass of PFOS remaining in soil at equilibrium, and M₀ is the initial mass).

FIG. 63 shows successive desorption of PFOS from the Willow Grove soil using Corexit EC9500A dispersant solution. Experimental conditions: mass of soil=2 g, solution volume=40 mL, dispersant concentration=300 mg L⁻¹, pH=7±0.2, temperature=22±1° C. (Mₜ is the mass of PFOS remaining at time t, and M₀ is the initial mass).

FIG. 64 shows re-adsorption of desorbed PFOS by 2%-Ga/TNTs@AC. Experimental conditions: mass of soil=2 g, solution volume=40 mL, Corexit EC9500A=300 mg L⁻¹, material dosage=5 g L⁻¹, pH=7±0.2, temperature=22±1° C.

FIG. 65 shows equilibrium desorption of PFOS from the Willow Grove soil using fresh or recycled Corexit EC9500A. Experimental conditions: mass of soil=2 g, solution volume=40 mL, pH=7±0.2, temperature=22±1° C. Mₑ is the mass of PFOS remaining at equilibrium, and M₀ is the initial mass.

FIG. 66 shows degradation and defluorination of desorbed PFOS using Ga/TNTs@AC (Ga=2 wt. %). Experimental conditions: mass of soil=2 g, solution volume=40 mL, Corexit EC9500=300 mg L⁻¹, materials dosage=5-10 g L⁻¹, UV irradiation=4 h, pH=7±0.2, temperature=22±1° C. UV: k=254 nm, intesntiy=21 mW cm².

### DETAILED DESCRIPTION

Various embodiments of the invention are described herein as follows. In one embodiment described herein, a composite composition is provided. The composite composition comprises a carbonaceous material and a photocatalyst.

In another embodiment, a method of removing one or more contaminants from an environmental medium is provided. The method comprises the step of contacting a composite composition according any one of above claims with the environmental medium to adsorb the contaminant on a surface of the composite composition.

In the various embodiments, the composite composition comprises a carbonaceous material and a photocatalyst. As used herein, a carbonaceous material refers to a material that comprises carbon. In some embodiments, the carbonaceous material comprises charcoal. In other embodiments, the charcoal is activated charcoal, powder activated charcoal, activated carbon fibers, biochar, or a mixture thereof.

In one embodiment, the carbonaceous material comprises activated charcoal (AC). In another embodiment, the carbonaceous material comprises a carbon sphere (CS). In yet another embodiment, the carbonaceous material comprises particles formed via hydrothermal treatment of a hydrocarbon precursor. In one aspect, the hydrocarbon precursor is a sugar. In another aspect, the hydrocarbon precursor is a polysugar.

In one embodiment, the carbonaceous material comprises graphite. In another embodiment, the carbonaceous material comprises graphene. In yet another embodiment, the carbonaceous material comprises graphite carbon nitride.

In some aspects, the composite composition comprises a particular weight percentage of carbon. In some embodiments, the composite composition comprises less than about 90% carbon, less than about 85% carbon, less than about 80% carbon, or less than about 75% weight percentage of carbon. In some embodiments, the percentage carbon of the composite composition may be about 40%, about 50%, about 55%, about 60%, about 65%, about 70%, about 75%, or about 80% weight percentage of carbon. In some embodiments, the composite composition comprises about 40% to about 80% carbon, about 50% to about 80% carbon, about 60% to about 80% carbon, or about 50% to about 70% weight percentage of carbon.

In various embodiments, the photocatalyst comprises a metallic nanotube. In some embodiments, the metallic nanotube is a titanium nanotube.

In various embodiments, the photocatalyst comprises a metal. In some embodiments, the metal is selected from the group consisting of titanium, iron, gallium, bismuth, and any combination thereof.

In various embodiments, the photocatalyst comprises a metallic oxide. In some embodiments, the metallic oxide is titanate. In one aspect, the titanate is a titanate nanotube. In another aspect, the titanate is a titanate nanosheet.

In various embodiments, the metallic oxide is titanium dioxide (TiO₂). In some embodiments, the metallic oxide is iron (hydr)oxide (FeO). In other embodiments, the photocatalyst comprises bismuth phosphate (BiOHP). In some aspects, the photocatalyst is conjugated with the carbonaceous material.

In some aspects, the composite composition comprises a particular atomic percentage of a metal. In some embodiments, the composite composition comprises at least 1%, at least 3%, at least 5%, or at least 7% atomic percentage of a metal. In some embodiments, the composite composition comprises about 1%, about 1.5%, about 2%, about 3%, about 4%, about 5%, about 6%, about 7%, about 8%, about 9%, about 10%, about 12%, or about 15% atomic percentage of a metal. In some embodiments, the composite composition comprises about 1% to about 15%, about 1% to about 5%, about 2% to about 15%, about 2% to about 12%, about 4% to about 12%, or about 5% to about 10% atomic percentage of a metal.

In various embodiments, the composite composition comprises a dopant. In some embodiments, the dopant is a metal. In some embodiments, the dopant is a metal oxide. In various aspects, the dopant is selected from the group consisting of iron, cobalt, nickel, gallium, bismuth, palladium, copper, aluminum, zirconium, platinum, and any combination thereof. In one aspect, the dopant comprises iron. In another aspect, the dopant consists essentially of iron. In another aspect, the dopant consists of iron. In one aspect, the dopant comprises gallium. In another aspect, the dopant consists essentially of gallium. In another aspect, the dopant consists of gallium.

Illustratively, the carbonaceous material and the photocatalyst have a particular mass ratio. In some embodiments, the mass ratio of the carbonaceous material to the photocatalyst may be about 0.3:1, about 0.4:1, about 0.5:1, about 0.7:1, about 1:1, about 1.5:1, about 1.7:1, about 2:1, about 2.5:1, about 3:1, about 3.5:1, about 4:1, about 4.5:1 or about 5:1.

Illustratively, the composite composition has a pH_{pze} corresponding to the solution pH where the composite does not have a charge. In some embodiments, the pH_{pze} may be at least about 2.8 or at least about 3. In some embodiments, the pH_{pze} may be less than about 7.5, less than about 7, or less than about 6.5. In some embodiments, the pH_{pze} may be about 2.8, about 2.9, about 3, about 3.1, about 3.2, about 3.3, about 3.4, about 3.5, or about 4. In some embodiments, the pH_{pze} may be about 2.8 to about 4, about 2.8 to about 3.5, or about 2.9 to about 3.4.

Illustratively, the carbonaceous material comprises a plurality of pores. In some embodiments, the pores of the carbonaceous material each have a diameter. In some embodiments, the diameter of each pore is about 2 nm to about 50 nm. Illustratively, the pores of the carbonaceous material are narrower after forming the composite than before forming the composite composition. Without being bound by theory, some of the photocatalysts may extend from the pore walls into the pore to narrow the pore size.

Illustratively, the composite composition may have a pore volume that is less than the pore volume of the carbonaceous material alone. In some embodiments, the pore volume may be less than about 0.7 g/cm³, less than about 0.65 g/cm³, or less than about 0.6 g/cm³. In some embodiments, the pore volume of the composite composition may be about 0.4 g/cm³, about 0.45 g/cm³, about 0.5 g/cm³, about 0.55 g/cm³, about 0.6 g/cm³, about 0.65 g/cm³, or about 0.7 g/cm³. In some embodiments, the pore volume of the composite composition may be about 0.4 g/cm³ to about 0.7 g/cm³, about 0.4 g/cm³ to about 0.65 g/cm³, about 0.4 g/cm³ to about 0.6 g/cm³, or about 0.45 g/cm³ to about 0.6 g/cm³.

In some embodiments, the metallic nanotube comprises tubular walls. In some embodiments, the metallic nanotube has an inner diameter. Illustratively, the metallic nanotube has an inner diameter of about 1 nm, about 2 nm, about 3 nm, about 4 nm, about 5 nm, about 6 nm, about 7 nm, about 8 nm, about 9 nm, about 10 nm, or about 12 nm. In some embodiments, the metallic nanotube has an inner diameter of about 1 nm to about 12 nm, about 2 nm to about 12 nm, about 2 nm to about 10 nm, about 2 nm to about 8 nm, or about 3 nm to about 8 nm. In some embodiments, each pore of the carbonaceous support is generally larger than a diameter of the metallic nanotube.

In another aspect of the present invention, a method of removing one or more contaminants from an environmental medium is provided. The method comprises the step of contacting a composite composition according any one of above claims with the environmental medium to adsorb the contaminant on a surface of the composite composition. The method may be utilized using any of the composite compositions described herein.

As described herein, a contaminant may be a per- and polyfluoroalkyl substance (PFAS). In some embodiments, the PFAS is perfluorooctanoic acid (PFOA). In some embodiments, the PFAS is perfluorooctane sulfonate (PFOS). Other PFAS materials that may be removed according to the described methods would be understood by the skilled artisan.

In some embodiments, the environmental medium is air. In other embodiments, the environmental medium is soil. In yet other embodiments, the environmental medium is water.

In some embodiments, contaminated water may have a particular pH. In some aspects, the pH of the contaminated water is selected from a range of about 2 to about 12. The pH of the contaminated water may be about 2, about 3, about 4, about 5, about 6, about 7, about 8, about 9, about 10, about 11, about 12, or about 13. In certain aspects, the water is wastewater.

In some embodiments, the adsorption comprises a mechanism selected from the group consisting of an electrostatic interaction, a Lewis acid-base interaction, a surface complexation, and any combination thereof, between the contaminant and the composite composition.

In some aspects, the method further comprises the step of degrading the contaminant. As used herein, degrading refers to breakdown or conversion of PFAS into other compounds. In certain embodiments, the degrading comprises photocatalytic mineralization of the contaminant. In other embodiments, the degrading comprises defluoridating the contaminant. As used herein, mineralization or defluoridating refers to conversion of fluorine in PFAS into fluoride ions.

In some aspects, the method further comprises the step of regenerating the composite composition. In certain embodiments, the step of regenerating comprises degrading the contaminant. In some embodiments, the degrading is carried out by exposing the pre-adsorbed contaminant to light. In one aspect, the light is ultraviolet light. In another aspect, the light is sunlight.

In some aspects, the composite composition produces radicals in response to being exposed to light. In certain embodiments, the radicals comprise a substance selected from the group consisting of holes, electrons, reactive oxygen species, and any combination thereof. In one aspect, the light is ultraviolet light. In another aspect, the light is sunlight.

In one aspect of the present disclosure, the environmental medium is soil, and wherein the method further comprises a step of desorption. In some embodiments, the step of desorption comprises contacting the contaminant with an oil dispersant. For instance, the oil dispersant can comprise Corexit 9500A or other dispersants known in the art. In another aspect, the step of desorption comprises contacting the contaminant with a surfactant.

In some aspects, the method comprises repeating the step of contacting the composite composition with the environmental medium to form a composite-contaminant complex. In certain embodiments, the initial step of contacting and the repeated step of contacting are performed consecutively.

In one embodiment, the method comprises 3 repetitions of the step of contacting the composite composition with the environmental medium to form a composite-contaminant complex. In another embodiment, the method comprises 4 repetitions of the step of contacting the composite composition with the environmental medium to form a composite-contaminant complex. In yet another embodiment, the method comprises 5 repetitions of the step of contacting the composite composition with the environmental medium to form a composite-contaminant complex. In one embodiment, the method comprises 6 repetitions of the step of contacting the composite composition with the environmental medium to form a composite-contaminant complex. In another embodiment, the method comprises 7 repetitions of the step of contacting the composite composition with the environmental medium to form a composite-contaminant complex. In yet another embodiment, the method comprises 8 repetitions of the step of contacting the composite composition with the environmental medium to form a composite-contaminant complex. In one embodiment, the method comprises 9 repetitions of the step of contacting the composite composition with the environmental medium to form a composite-contaminant complex. In another embodiment, the method comprises 10 repetitions of the step of contacting the composite composition with the environmental medium to form a composite-contaminant complex. In yet another embodiment, the method comprises more than 10 repetitions of the step of contacting the composite composition with the environmental medium to form a composite-contaminant complex.

In some embodiments, at least 75%, at least 85%, at least 90%, or at least 95% of the contaminant is degraded within about four hours. In other embodiments, at least 75%, at least 85%, at least 90%, or at least 95% of the contaminant is degraded within about two hours. In yet other embodiments, at least 75%, at least 85%, at least 90%, or at least 95% of the contaminant is degraded within about one hour. In other embodiments, the composite composition has a binding capacity of at least 2 mg contaminant per gram of composite composition. In yet other embodiments, the composite composition has a binding capacity of at least 4 mg contaminant per gram of composite composition. In other embodiments, the composite composition has a binding capacity of at least 10 mg contaminant per gram of composite composition. In yet other embodiments, the composite composition has a binding capacity of at least 100 mg contaminant per gram of composite composition. In other embodiments, the composite composition has a binding capacity of at least 200 mg contaminant per gram of composite composition. In yet other embodiments, the composite composition has a binding capacity of at least 500 mg contaminant per gram of composite composition. In other embodiments, the step of contacting is performed for about 2 minutes to about 48 hours.

The following publications are expressly incorporated by reference herein in their entirety: i) Li et al, “A concentrate-and-destroy technique for degradation of perfluorooctanoic acid in water using a new adsorptive photocatalyst,” Water Research, 2020; 185: 116219, ii) Xu et al, “Enhanced adsorption and photocatalytic degradation of perfluorooctanoic acid in water using iron (hydr)oxides/carbon sphere composite,” Chemical Engineering Journal, 2020; 388: 124230, and iii) Xu et al, “Enhanced photocatalytic degradation of perfluorooctanoic acid using carbon-modified bismuth phosphate composite: Effectiveness, material synergy and roles of carbon,” Chemical Engineering Journal, 2020; 395: 124991.

### EXAMPLES

### Example 1

### Synthesis and Characterization of Fe/TNTs@AC Composite Compositions

For preparation of the exemplary composite composition Fe/TNTs@AC, chemicals of analytical grade or higher were obtained. NaOH (granular), absolute ethanol, and HCl were obtained from Acros Organics (Fair Lawn, N.J., USA). PFOA was acquired from Sigma-Aldrich (St. Louis, Mo., USA), and a stock solution of 10 mg/L was prepared and stored at 4° C. Table 1 provides salient physicochemical properties of PFOA. Perfluoro-n-[1,2,3,4,5,6,7,8-13C8]octanoic acid (13C-PFOA or M8PFOA) was purchased from Wellington Laboratories Inc. (Guelph, Ontario, Canada Perfluoro), and was used as isotopically labeled internal standards. All solutions were prepared using deionized (DI) water (18.2 MΩ cm, Millipore Co., USA).

TABLE 1
Physicochemical properties of PFOA.

| Parameters | Values |
|---|---|
| Chemical formula | C₈HF₁₅O₂ |
| Chemical structure | 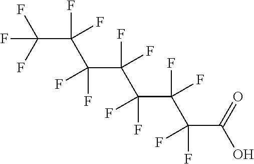 |
| Molecule weight | 414.07 g mol⁻¹ |
| Boiling point | 192° C. |
| Log K_{ow} | 4.81 |
| Solubility in water | 3300 mg L⁻¹ (25° C.) |
| CAS Number | 335-93-3 |

Nano-TiO2 (P25, 80% anatase and 20% rutile) was purchased from Evonik (Worms, Germany). Filtrosorb-400® granular activated carbon (F-400 GAC) (particle size=0.55-0.75 mm) was acquired by courtesy of Calgon Carbon Corporation (Pittsburgh, Pa., USA) and was used as received. F-400 GAC was made from bituminous coal to achieve high density (2100 kg m-3) and high specific surface area (1050-1200 m2 g-1) for organic pollutant removal.

First, TNTs@AC were synthesized through a hydrothermal method. Briefly, 1.2 g of TiO2 was mixed with 1.2 g of F-400 GAC and then dispersed into 67 mL of a 10 M NaOH solution. Upon thorough mixing, the mixture was transferred into a Teflon-lined reactor in an autoclave and heated at ° C. for 72 h. The gray precipitates, i.e., TNTs@AC, were separated and washed with DI water until neutral pH, and then oven-dried at 105° C. for 4 h. Then, 1 g of the dried TNTs@AC was dispersed in 100 mL of DI water, and then 10 mL of an FeCl₂ solution (1 g L⁻¹ as Fe, pH=3.0) was dropwise added into the TNTs@AC suspension. Upon equilibrium, >99.7% Fe(II) was adsorbed by TNTs@AC. The solid particles were then separated and oven-dried at 105° C. for 24 h, which also oxidized Fe(II) to Fe(III). The dried particles were then calcined at 550° C. under nitrogen flow at 100 mL min-1 for 3 h. The Fe content in the resulting Fe/TNTs@AC was ˜1 wt. %. The resulting Fe/TNTs@AC had a particle size of 0.59-0.84 mm and a density 2630 kg m⁻³.

The calcination temperature and Fe content were varied to obtain the optimal Fe/TNTs@AC based on the adsorption rate/capacity and photoactivity. The following calcination temperatures were tested at a fixed Fe content of 1 wt. %: 300, 550, 650, and 850° C., whereas the Fe contents were tested at 0.5, 1, 3, and 5 wt. % with a fixed calcination temperature of 550° C. Based on the subsequent adsorption and photodegradation tests, Fe/TNTs@AC prepared at 550° C. calcination temperature and 1 wt. % of Fe was chosen for further examples.

Fe/TNTs@AC was characterized with respect to various physicochemical and photochemical properties. The surface morphology was imaged using a scanning electron microscope (SEM) (20 kV; FEI XL30F, Philips, USA), equipped with energy-dispersive X-ray spectroscopy (EDS). Additionally, transmission electron microscopy (TEM) and high resolution TEM (HRTEM) analysis was conducted on a Tecnai30 FEG microscopy (FEI, USA) operated at 300 kV. The zeta potential (ζ) was measured using a Malvern Zetasizer Nano-ZS90 (Malvern Instrument, Worcestershire, UK). The crystalline structures were analyzed on a Bruker D2 PHASER X-ray diffractometer (XRD, Bruker AXS, Germany) using Cu Kα radiation (λ=1.5418 Å) and at a scanning rate (2θ) of 2° min⁻¹. The surface chemical compositions and oxidation states were analyzed using an AXIS-Ultra X-ray photoelectron spectroscopy (XPS) (Kratos, England) operated at 15 kV and 15 mA (Al Kα X-ray). The standard C 1s peak (Binding energy, E_{b}=284.80 eV) was used to calibrate all the peaks and eliminate the static charge effects. The Brunauer-Emmett-Teller (BET) surface area was obtained using an ASAP 2010 BET surface area analyzer (Micromeritics, USA) in the relative pressure (P/P₀) range of 0.06-0.20. The pore size distribution was determined following the Barret-Joyner-Halender (BJH) method. The nitrogen adsorption at the relative pressure of 0.99 was used to determine the pore volumes and the average pore diameters. Diffuse reflectance UV-visible absorption spectra (UV-DRS) were obtained using a UV-2400 spectrophotometer (Shimadzu, Japan). BaSO₄ powder was selected as the reference at all energies to achieve 100% reflectance.

The generation of hydroxyl radicals (.OH) was measured through the photoluminescence (PL) technique using a fluorescence spectrophotometer (SpectraMax M2, Molecular Devices, CA, USA). Terephthalic acid was used as the probe molecule, which can rapidly react with .OH radicals to produce highly fluorescent 2-hydroxyterephthalic acid. The test solution included 0.1 mM terephthalic acid and 0.1 mM NaOH. In each test, 0.4 g of a solid sample was added in 200 mL of the solution, and the PL measurement was performed after 60 min. The excitation wavelength was set at 215 nm, and the emission wavelength varied from 360 to 490 nm.

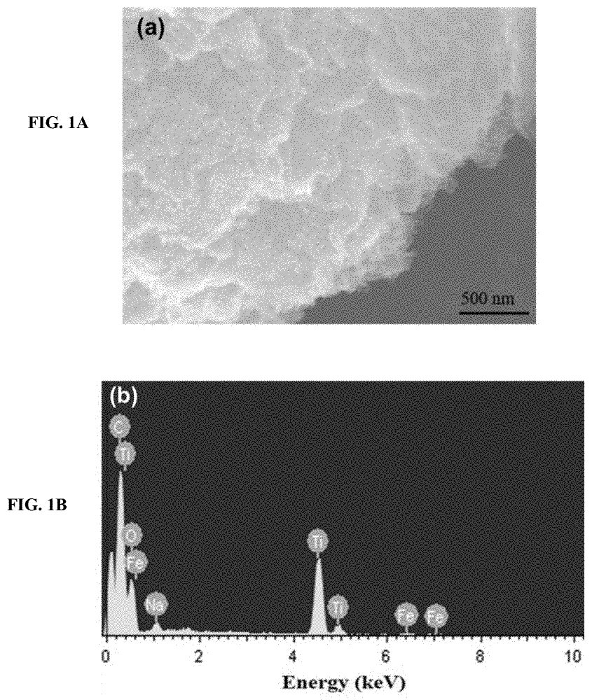

FIG. 1A presents a representative SEM image of calcined Fe/TNTs@AC, displaying a cotton-like surface structure consisting of interwoven carbon- and Fe-modified TNTs. This structure is expected to be conducive to concentrating PFAS on the outer shell of the particles due to partial blockage of the inner pores during the hydrothermal treatment, thereby facilitating the subsequent photocatalytic destruction of PFAS in situ. FIG. 1B shows the EDS spectra of Fe/TNTs@AC, confirming the presence of the five major elements (C, O, Na, Fe, and Ti) on the surface of Fe/TNTs@AC. Tables 2 and 3 provide the percentiles of the elements based on the EDS and XPS analyses, respectively. The fairly high percentage of carbon (53.02 wt. % per EDS and 51.08 wt. % per XPS) indicates that some of the core AC was broken into fine particles that are attached or blended with the Fe/TNTs on the outer shell of the Fe/TNTs@AC.

TABLE 2
EDS-based distribution of five key elements on the
surface of Fe/TNTs@AC prepared with 1 wt. %
of Fe and at a calcination temperature of 550° C.

| Element | Weight % | Atomic, % |
|---|---|---|
| C | 53.02 | 65.75 |
| O | 30.89 | 28.76 |
| Na | 1.51 | 0.98 |
| Ti | 13.99 | 4.35 |
| Fe | 0.59 | 0.16 |
| Totals | 100.00 | |

TABLE 3
Surface atomic percentiles of TNTs@AC and Fe/TNTs@AC obtained
by XPS. Fe/TNTs@AC was prepared with 1 wt. % Fe
content and at a calcination temperature of 550° C.

| | Element weight percentage (wt. %) | | | | | |
|---|---|---|---|---|---|---|
| Materials | C | O | Na | Ti | Fe | Cl |
| TNTs@AC | 60.11 | 24.40 | 5.14 | 8.34 | 0 | 2.01 |
| Fe/TNTs@AC | 51.08 | 30.52 | 5.42 | 11.35 | 0.68 | 0.95 |

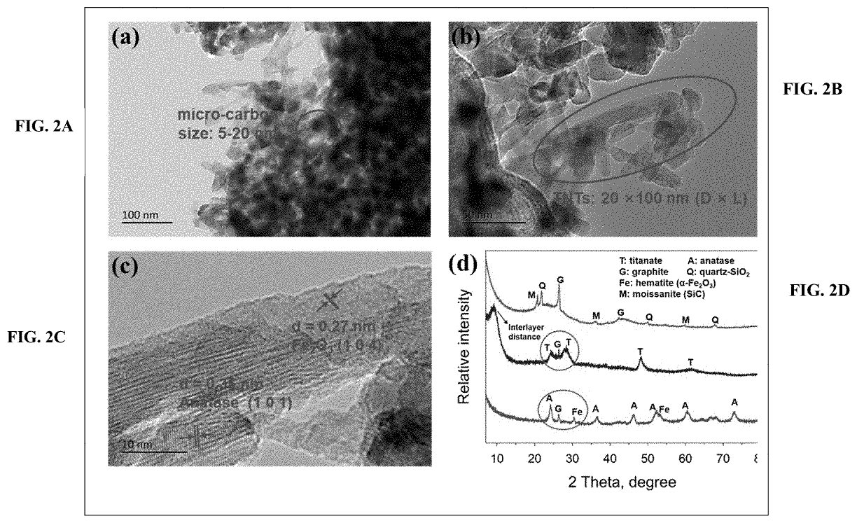

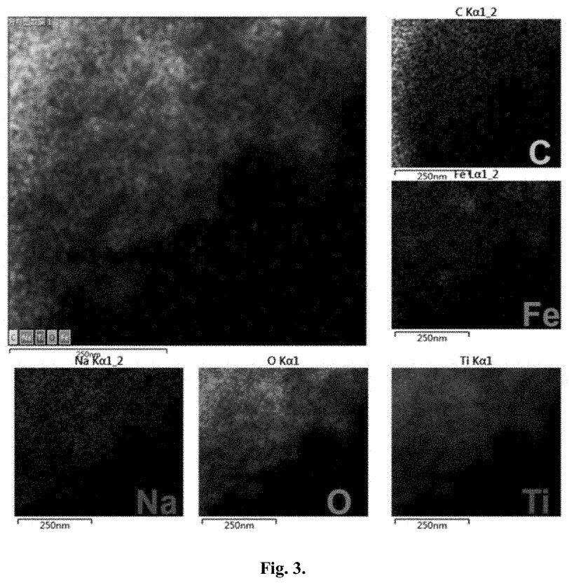

FIG. 2A shows the TEM images of Fe/TNTs@AC, which confirms that some micro-carbon particles are blended with TNTs, with a particle size in the range of 5 to 20 nm. The attachment of these carbon nanoparticles on TNTs suppresses the surface negative potential of TNTs and facilitates the adsorption of PFOA through enhanced hydrophobic interactions and weakened electrostatic repulsion. Moreover, the micro-carbon particles may facilitate electron transfer to result in enhanced photoactivity. FIGS. 2B and 2C show close-ups of the Fe- and carbon-modified TNTs. FIG. 2B reveals that the TNTs have an outer diameter of ˜20 nm and a length of ˜100 nm. FIG. 3 presents the EDS mappings of the elements, indicating that Fe was well distributed on the surface of Fe/TNTs@AC, while Ti, O and C were the predominant elements.

FIG. 2D shows the XRD patterns of F-400 GAC, TNTs@AC, and calcined Fe/TNTs@AC. Table 4 lists the six crystalline phases, where quartz-SiO₂ and moissanite (SiC) are from the parent AC.

TABLE 4
Standard XRD pattern powder diffraction file (PDF).

| Crystalline Phases | PDF # |
|---|---|
| graphite | 41-1487 |
| titanate | 48-0693 |
| anatase | 21-1272 |
| quartz-SiO₂ | 46-1045 |
| Moissanite (SiC) | 42-1360 |
| Hematite (α-Fe₂O₃) | 33-0664 |

For the parent AC (F-400), the peaks at 26.7° and 43.4° are assigned to the diffractions of the (002) and (100) crystal planes of graphite, respectively. For TNTs@ AC, the peaks at 9.2°, 24.1°, 28.1°, 48.4° and 61.4° are attributed to sodium trititanate (expressed as NaₓH₂₋ₓTi₃O₇), which is composed of corrugated ribbons of triple edge-sharing [TiO₆] (the skeletal structure) with cations (e.g., Na⁺, H⁺, and Fe³⁺) attached at the interlayers. The peak at 9.2° signifies the interlayer distance (9.1 Å) (crystal plane (200)) of sodium trititanate. The peak at 26.1° represents the crystal plane of graphite (002), confirming that the carbon nanoparticles were intermingled with TNTs. For calcined Fe/TNTs@AC, the peaks at 24.1°, 36.6°, 46.2°, 52.4°, 60.2°, and 73° are attributed to anatase, whereas the peaks at 26.1° and 31.4° are assigned to graphite (002) and hematite (α-Fe₂O₃) (104), respectively. Evidently, upon calcination and Fe deposition, the sodium tri-titanate of TNTs@AC was transformed into anatase. This observation agrees with the EDS mapping data (FIG. 1B and FIG. 3). The HRTEM images in FIG. 2C display the layered crystalline structures of TNTs and Fe₂O₃ on the calcined Fe/TNTs@AC, revealing an interlayer distance of 0.35 nm for anatase and 0.27 nm for Fe₂O₃. The interlayer distance for anatase is much smaller than that for neat TNTs (0.75 nm for the crystal plane (200) of titanate), and 0.79 nm for unmodified TNTs@AC, indicating the iron modification and calcination altered the crystalline structure of TNTs@AC.

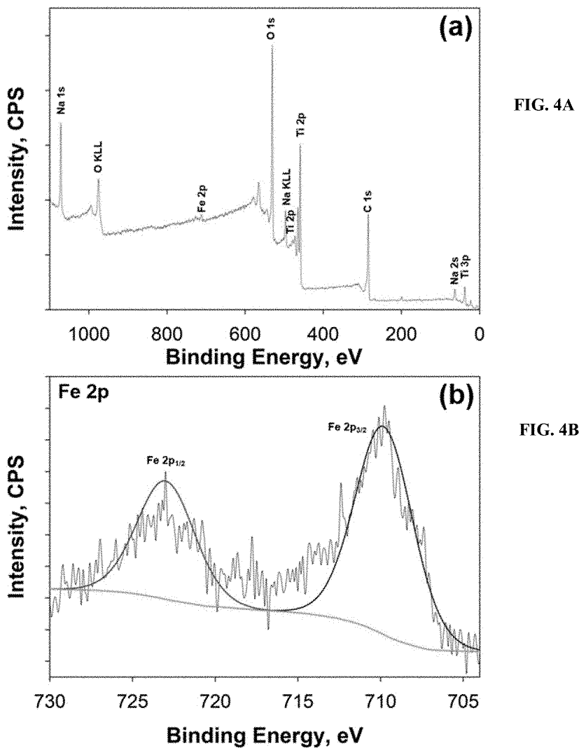

FIG. 4A shows the XPS spectra of Fe/TNTs@AC, and Table 3 lists the corresponding atomic compositions of Fe/TNTs@AC and TNTs@AC. Previously, TNTs have been described as Na_{0.7}H_{1.3}Ti₃O₇ with a mass ratio of AC:TNTs in TNTs@AC of ˜1.2:1. After the Fe loading and calcination, the C content decreased from 60.11 to 51.08 wt. %, while the contents of Ti and O increased from 8.34 to 11.35 wt. % and from 24.40 to 30.52 wt. %, respectively. Meanwhile, the XPS data indicated an Fe content of 0.68 wt. %, which was close to the EDS-based value (0.59 wt. %). FIG. 4B shows the high-resolution XPS spectra of Fe 2p, where the two main peaks at ˜710 and ˜723 eV correspond to Fe 2p_{3/2} and Fe²p_{1/2} of oxidized iron Fe(III), respectively. These observations confirmed that the initially adsorbed Fe(II) ions were converted to Fe(III), resulting in the α-Fe₂O₃ phase, which is consistent with the TEM and XRD data.

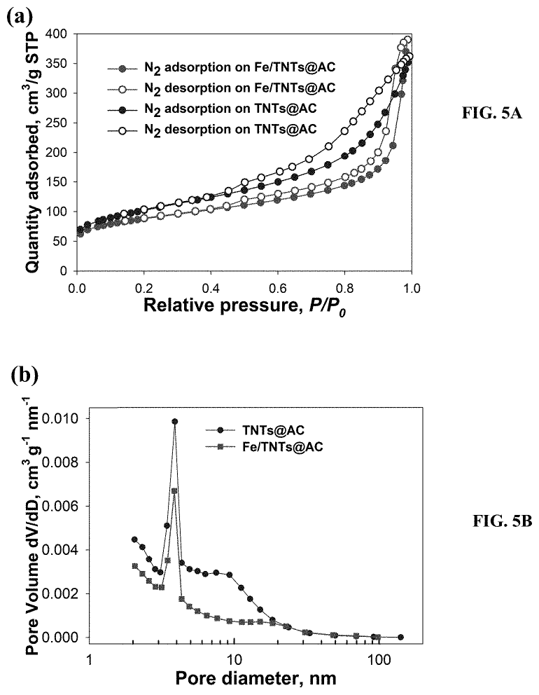

FIGS. 5A and 5B show the pore size distributions of TNTs@AC and Fe/TNTs@AC. The parent AC (F-400), which has been well characterized by previous researches, has an large specific surface area of 1069.2 m² g⁻¹ and a porosity of 0.4, and 80% of the surface area is situated in pores of <2 nm (diameter). TNTs@AC displayed a bimodal pore size distribution profile with a primary peaking at ˜4 nm and a secondary peaking at 2-2.5 nm. The enlarged pore size distribution for TNTs@AC than the parent AC can be attributed to 1) blockage of some micropores in the parent AC due to the hydrothermal alkaline treatment, and 2) conversion of larger pores (>10 nm) of TNTs into smaller micropores in TNTs@AC. A similar distribution profile was observed for Fe/TNTs@AC. However, Fe/TNTs@AC showed a much lower peak at ˜4 nm and higher changes in dV/dD from ˜4 to ˜10 nm than TNTs@AC. Given that the AC:TNTs mass ratio is ˜1.2:1 and the SSA of neat TNTs is 272.3 m² g⁻¹, the combined SSA of TNTs@AC or Fe/TNTs@AC would be about 707 m² g⁻¹ if they were combined without distortion. Yet, the measured specific surface area (292.1 m² g⁻¹) for Fe/TNTs@AC was much lower, indicating that the hydrothermal alkaline treatment, Fe loading, and calcination blocked or narrowed some pores in the AC. The blockage of the interior pores is expected to favor the accumulation of PFOA on the outer shell of Fe/TNTs@AC. Moreover, the Fe loading and the calcination treatment of TNTs@AC increased the pore volume from 0.55 to 0.61 cm³ g⁻¹.

### Example 2

### Adsorption Kinetics and Isotherms of Fe/TNTs@AC

Adsorption kinetic tests were performed in batch reactors using 40 mL high-density polyethylene (HDPE) vials under the following experimental conditions: initial PFOA=100 μg L⁻¹, material dosage=1 g L⁻¹, and temperature=22+/−1° C.; the initial pH was adjusted to 7.0 using diluted HClO4 and NaOH. The adsorption was initiated by mixing a given material with the PFOA solution. The vials were kept in the dark and under shaking at 100 rpm. At predetermined times, the vials were sampled in duplicate and centrifuged for 2 min at 4000 rpm, and the supernatants were analyzed for the remaining PFOA. Each adsorption kinetic test lasted for 4 h, which was sufficient to reach equilibrium.

Adsorption isotherms for PFOA were conducted following the same procedure and under the following conditions: initial PFOA=0 to 100 mg L⁻¹, material dosage=1 g L⁻¹, pH=7.0, solution volume=40 mL, and equilibrium time=24 h.

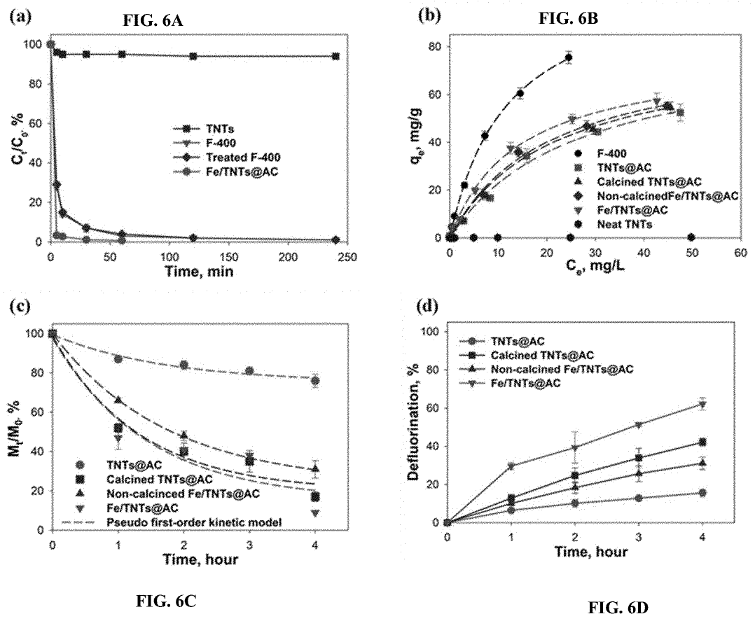

FIG. 6A shows the adsorption kinetics of PFOA by various materials. More than 95% of PFOA (100 μg L⁻¹) was rapidly adsorbed in 5 min using 1 g L⁻¹ of Fe/TNTs@AC, and over 99% was adsorbed after 60 min. The rapid adsorption allows for efficient removal of PFOA from bulk water with a small hydraulic residence time (HRT) (i.e., a small reactor). Moreover, the adsorption pre-concentrates PFOA from a large volume of water onto a small volume of Fe/TNTs@AC, enabling the subsequent photocatalytic degradation to be carried out in a much smaller volume of photo-reactor with much less energy consumption compared to directly treating the bulk raw water.

FIG. 6A also displays that both pristine and hydrothermally treated F-400 AC were able to adsorb PFOA under the same conditions, but at a slower rate, with ˜70% of PFOA removed in the first 5 min and >99% at 2 h. Neat TNTs were not effective in adsorption of PFOA due to the inorganic structure and negative surface charges (the point of zero charge pH, pH_{pze}=2.57). The observations indicate that blending Fe, AC nanoparticles, and TNTs induced corporative adsorption mechanisms, resulting in the synergistic effect on both adsorption capacity and rate for PFOA.

The pseudo first-order (Eq. 8) and pseudo second-order kinetic models (Eq. 9) are tested to interpret the kinetic data:

$$\begin{matrix}{q}_{t} = {q}_{e} - {q}_{e}^{- {k}_{1} t} & ( 8 ) \\ \frac{t}{{q}_{t}} = \frac{1}{{k}_{2} {q}_{e}^{2}} + \frac{t}{{q}_{e}} & ( 9 )\end{matrix}$$

where qₜ and qₑ are the PFOA uptakes (μg g⁻¹) at time t (min) and equilibrium, respectively, k₁ is the first-order rate constant (min⁻¹), and k₂ is the second-order rate constant (g (μg·min)⁻¹).

Table 5 indicates the pseudo second-order model fits the experimental kinetic data (R²=0.997) much better than the pseudo first-order model (R²=0.894) for Fe/TNTs@AC, whereas both models adequately fit the experimental kinetic data for the plain AC(R²=0.996 vs. R²=0.976), which is in accord with the characterization results that the Fe- and TNTs-modifications of the GAC along with the hydrothermal and calcination treatments altered accessibility of the adsorption sites (i.e., shifted the primary sites to the shell part).

TABLE 5
Kinetic model parameters for adsorption
of PFOA by Fe/TNTs@AC and F-400 GAC.

Materials

| Models | Parameters | Fe/TNTs@AC | F-400 |
|---|---|---|---|
| Pseudo | k₁ (min⁻¹) | 0.330 | 0.317 |
| first- | R² | 0.894 | 0.976 |
| order | | | |
| Pseudo | k₂ (g (μg · min)⁻¹) | 8.54 × 10⁻³ | 9.06 × 10⁻³ |
| second- | R² | 0.997 | 0.996 |
| order | | | |

FIG. 6B shows the adsorption isotherms of PFOA by uncalcined or calcined Fe/TNTs@AC and various forms of the precursor materials. Again, neat TNTs showed negligible PFOA adsorption (<10 μg g⁻¹). The classical Langmuir model and Freundlich model were applied to fit the adsorption isotherm data:

$$\begin{matrix}{q}_{e} = \frac{{Q}_{m ax} b {C}_{e}}{1 + b {C}_{e}} & ( 10 ) \\ {q}_{e} = {K}_{F} {C}_{e}^{1 / n} & ( 11 )\end{matrix}$$

where Cₑ (mg L⁻¹) is the equilibrium concentration of PFOA in the aqueous phase, Qₘₐₓ (mg g⁻¹) is the Langmuir maximum adsorption capacity, and b (L mg⁻¹) is the Langmuir affinity constant related to the free energy of adsorption; K_{F} (mg (g·(L mg⁻¹)^{1/n})⁻¹) is the Freundlich capacity constant, and n is the heterogeneity factor indicating the adsorption intensity.

Table 6 provides the best-fitted model parameters.

TABLE 6
Adsorption isotherm model parameters for adsorption of PFOA by various adsorbents.

| | | Adsorbents | | | | |
|---|---|---|---|---|---|---|
| | | | | Non-calcined | | Non-calcined |
| Models | Parameters | F-400 | Fe/TNTs@AC* | Fe/TNTs@AC | TNTs@AC | TNTs@AC |
| Langmuir | Qₘₐₓ (mg g⁻¹) | 110.6 | 84.5 | 81.4 | 80.2 | 77.6 |
| isotherm | b (L mg⁻¹) | 0.089 | 0.063 | 0.052 | 0.047 | 0.041 |
| model | R² | 0.999 | 0.992 | 0.994 | 0.991 | 0.997 |
| Freundlich | K_{F} mg (g · | 12.38 | 8.84 | 6.95 | 6.32 | 5.89 |
| isotherm | (L mg⁻¹)^{1/n})⁻¹ | | | | | |
| model | n | 1.75 | 1.96 | 2.08 | 1.84 | 1.81 |
| | R² | 0.993 | 0.971 | 0.968 | 0.972 | 0.959 |

*Fe/TNTs@AC was calcined at 550° C.

In all cases, both models were able to adequately fit the experimental data, though the Langmuir model provided slightly better goodness of fitting based on the R² values, suggesting that the adsorption of PFOA conforms to the homogeneous monolayer adsorption model. The Qₘₐₓ values for the different materials followed the order of: F-400 (110.6 mg g⁻¹)>calcined Fe/TNTs@AC (84.5 mg g⁻¹)>non-calcined Fe/TNTs@AC (81.4 mg g⁻¹)>TNTs@AC (80.2 mg g⁻¹)>non-calcined TNTs@AC (77.6 mg g⁻¹). Comparing plain F-400 AC and Fe/TNTs@AC, while both adsorbents showed high PFOA adsorption capacity, the latter contained nearly 50% of the less adsorptive TNTs. Moreover, while the specific surface area of F-400 AC is ˜3.7 times larger than that of Fe/TNTs@AC, the Langmuir maximum capacity of F-400 AC was only 1.3 times higher. Taken together, these observations indicate that carbon and α-Fe₂O₃ modifications of TNTs and the multi-phase induced multi-mechanism binding of PFOA notably enhanced the overall PFOA adsorption and compensated the capacity loss due the lost surface area in the parent AC. Moreover, while AC adsorbs PFOA in both deep and shallow pores, Fe/TNTs@AC tends to accumulate more PFOA on the shallow outer shell sites that are more photo-accessible (also backed by the photodegradation rate data) because of the hybrid modifications. The calcination treatment, which was intended to enhance the photocatalytic activity, slightly enhanced the PFOA adsorption capacity, which can be attributed to the opening up of some more adsorption sites.

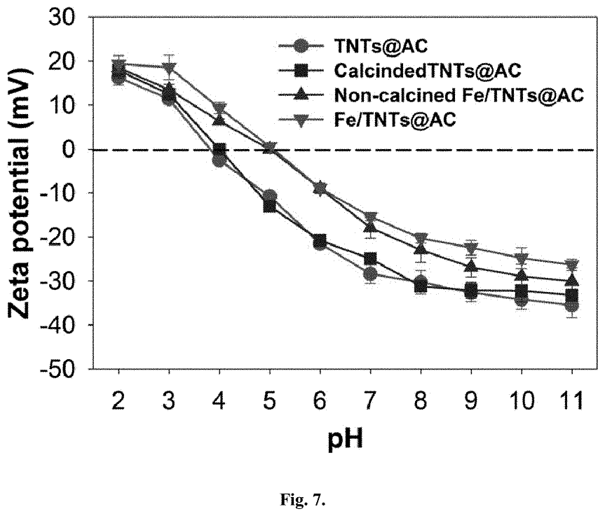

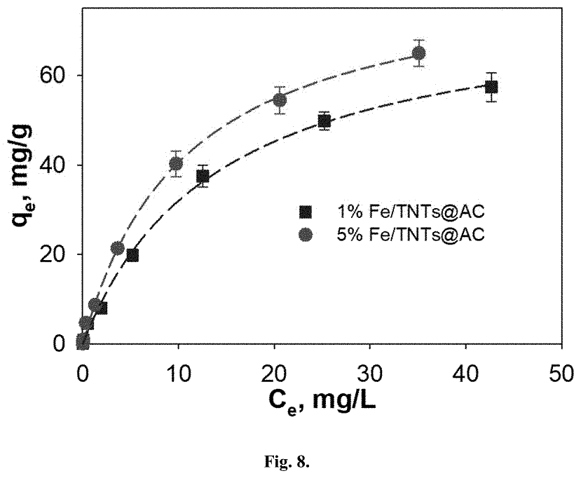

FIG. 7 compares the zeta potential of TNTs@AC and Fe/TNTs@AC with or without calcination. Evidently, the loading of a small fraction of Fe₂O₃ on TNTs@AC suppressed the surface negative potential and elevated the pH_{pze} value from 3.8 to 5.2, rendering the adsorption of PFOA anions more favorable. When the Fe content was increased from 1 to 5 wt. %, the Qₘₐₓ value for Fe/TNTs@AC increased by ˜14% (FIG. 8).

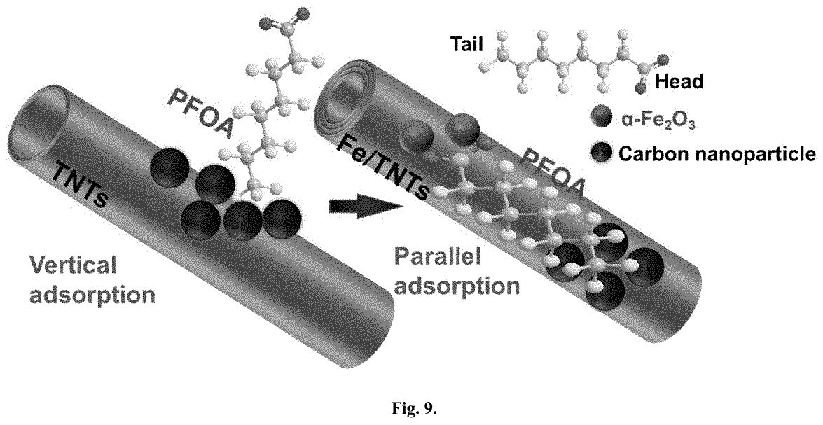

Generally, hydrophobic adsorbents such as AC take up PFOA via hydrophobic interaction with the hydrophobic chain (—CF₃(CF₂)₆) of PFOA and anion-π interaction, whereas charged sorbents like ion exchangers by electrostatic interactions with the head carboxylate group. While the tail group of PFOA is inert to TNTs, it can interact with the hydrophobic micro-carbon particles on the surface of Fe/TNTs@AC. Furthermore, the α-Fe₂O₃ particles, which have a pH_{PZC} of 6.7, can attract the carboxylate group (pK_{α}≤3) of PFOA through concurrent electrostatic and Lewis-acid base interactions. These cooperative adsorption modes allowed PFOA to be adsorbed on the photocatalyst surface in the parallel orientation (side-on), i.e., the carbon chain of PFOA is attached to the surface with both tail and head groups anchored (FIG. 9). This spatial orientation is expected to be more conducive to the subsequent photochemical bond-breaking than the vertical orientation such as tail-on only for AC or head-on only for ion exchangers. For instance, the closer contact between PFOA and the reactive surface allows for direct electron transfer between PFOA and photo-generated h⁺ or e⁻, greatly facilitating the decomposition and mineralization of PFOA.

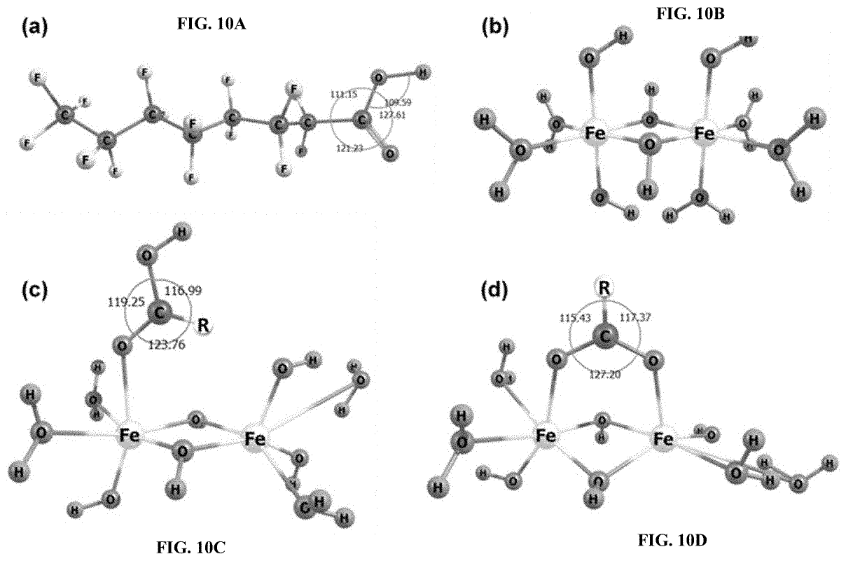

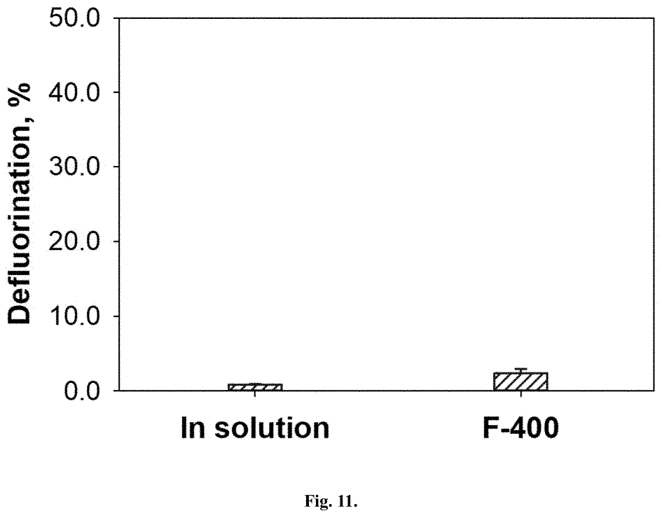

The side-on adsorption mode is also confirmed by the DFT calculation results. FIG. 10A-10D show the resulting optimized molecular orientations with minimum energy from the frequency and optimization calculations. The angle between the hydroxyl group and the carbon chain of PFOA is between 110° and 120° (FIG. 10A). The angles remain in the same range for mono- and bi-dentate complexed PFOA (FIGS. 10C and 10D). Based on the structural properties, PFOA adsorbed through mono-dentate complexation is likely oriented “parallel” to the Fe(III) dimer, i.e., the iron oxide surface; whilst PFOA via bi-dentate complexation is “perpendicular” to the iron oxide surface in the head-in mode. As used herein, the terms “parallel” and “perpendicular” are not necessarily mathematically strictly defined, but include up to ˜10° variations. In both cases, the binding between the head carboxylate and Fe can facilitate the head-first decarboxylation reactions. Between the two molecular orientations, the side-on complexation is believed to be the predominant adsorption mode because of the cooperative adsorption role of the AC nanoparticles, and this mode is more conducive to the subsequent photocatalytic degradation of PFOA.

The solution pH remained nearly the same after the adsorption for all cases (Table 7 and Table 8), which is in accordance with the surface complexation and hydrophobic interaction mechanisms.

TABLE 7
Initial and final pH in the adsorption kinetic experiments.

| Materials | Initial pH | Final pH |
|---|---|---|
| TNTs | 7.0 ± 0.3 | 7.0 ± 0.2 |
| F-400 | 7.0 ± 0.3 | 7.0 ± 0.3 |
| Treated F-400 | 7.0 ± 0.3 | 7.1 ± 0.2 |
| Fe/TNTs@AC | 7.0 ± 0.3 | 7.1 ± 0.3 |

TABLE 8
Final pH in the adsorption isotherm experiments (initial pH = 7.0 ± 0.3).

| | Initial PFOA concentration (mg L⁻¹) | | | | | | |
|---|---|---|---|---|---|---|---|
| Materials | 1 | 5 | 10 | 25 | 50 | 75 | 100 |
| F-400 | 7.2 ± 0.4 | 7.2 ± 0.2 | 7.5 ± 0.2 | 7.8 ± 0.1 | 7.8 ± 0.1 | 8.2 ± 0.3 | 8.6 ± 0.1 |
| TNTs@AC | 7.0 ± 0.1 | 7.3 ± 0.3 | 7.4 ± 0.1 | 7.3 ± 0.2 | 7.2 ± 0.3 | 7.3 ± 0.3 | 7.6 ± 0.2 |
| Calcined | 7.1 ± 0.1 | 7.1 ± 0.2 | 7.4 ± 0.2 | 7.3 ± 0.4 | 7.4 ± 0.2 | 7.6 ± 0.1 | 7.7 ± 0.2 |
| TNTs@AC | | | | | | | |
| Non-calcined | 7.0 ± 0.1 | 7.1 ± 0.1 | 7.2 ± 0.1 | 7.3 ± 0.4 | 7.4 ± 0.3 | 7.3 ± 0.4 | 7.4 ± 0.4 |
| Fe/TNTs@AC | | | | | | | |
| Fe/TNTs@AC | 7.1 ± 0.3 | 7.2 ± 0.1 | 7.2 ± 0.1 | 7.1 ± 0.4 | 7.2 ± 0.3 | 7.3 ± 0.1 | 7.5 ± 0.2 |
| TNTs | 7.0 ± 0.3 | 7.0 ± 0.3 | 7.0 ± 0.3 | 7.0 ± 0.3 | 7.0 ± 0.3 | 7.0 ± 0.3 | 7.0 ± 0.3 |

### Example 3

### Photodegradation of PFOA by Fe/TNTs@AC

Following the adsorption equilibrium, the mixtures were left for 1 h to allow the composite materials to settle by gravity (>99% of the materials settled). Approximately Fe/TNTs@AC settled within 30 seconds. Then, ˜95% of the supernatant was pipetted out, and the residual solid-liquid mixture was transferred into a quartz photo-reactor with a quartz cover. Afterwards, 8 mL of DI water was added to the mixture so that the solution volume in the photo-reactor reached 10 mL (i.e., solid loading=4 g L⁻¹), and the solution pH was adjusted to 7.0. The reactor was then placed in a Rayonet chamber UV-reactor (Southern New England Ultraviolet CO., Branford, Conn., USA), and subjected to UV light at a wavelength of 254 nm and an intensity of 21 mW cm-2 at a 38 cm distance. At predetermined times (1, 2, 3, and 4 h), the solid and liquid were sacrificially separated through centrifugation, with the solid subjected to hot-methanol extraction and the liquid analyzed for fluoride. After UV irradiation, the solid-liquid mixture was transferred into a HDPE tube, and the solid was separated from the liquid by centrifuging. Then, 1 mL of M8PFOA (0.4 mg L⁻¹) was spiked on the solid and the mixture was shaken at 20 rpm for 1 h to allow for complete adsorption of M8PFOA. Then, 40 mL methanol was added. The mixture was transferred into a 40 mL glass vial with an HDPE cap and then placed in a ProBlot™ 12S HybridizationShaking Oven (Tomas Scientific, NJ, USA) and extracted for 4 h at 80° C. and at a rotating rate of 20 rpm. With the M8PFOA correction, the 4-h extraction achieved 88%-95% recoveries.

Duplicate experiments were carried out for each time point. M8PFOA was used as the internal standard (IS) to correct the mass recovery, and the average method recovery was >90% for PFOA. All tests were carried out in duplicate.

As described herein, the term “degradation” refers to decomposition or breakdown of contaminants into other compounds. For instance, degradation of PFOA can result in shorter-chain perfluorinated carboxylic acids (PFCAs), whereas the terms “defluorination” or “mineralization” indicates the conversion of fluorine in PFOA into fluoride ions. The degradation in the instant example was quantified by comparing the PFOA concentrations before and after the photodegradation, whereas defluorination was determined by measuring the fluoride produced upon the photocatalytic reactions.

The effects of pH on PFOA photodegradation were studied in the initial pH range from 4.0 to 10.0. Roles of h+, .OH, and .O₂− were tested through the classical scavenger experiments using potassium iodide (KI), isopropanol (IP), and benzoquinone (BQ) as the respective radical scavengers.

The reusability of the photo-regenerated materials was tested by using the same material in six consecutive cycles of the adsorption-photodegradation experiments.

FIG. 6C shows that 91.3% of PFOA pre-concentrated on Fe/TNTs@AC was degraded in 4 h under the UV irradiation. The results also support the belief that PFOA was pre-concentrated in the vicinity of the photoactive shell sites as desired. In comparison, TNTs@AC, non-calcined Fe/TNTs@AC, and calcined TNTs@AC degraded 23.8%, 68.7%, and 83.3%, respectively. FIG. 6D shows that Fe/TNTs@AC converted ˜62% of organic fluorine in PFOA into F⁻ ions (defluorination), which is 1.5, 2, and 4 times higher than TNTs@AC, non-calcined Fe/TNTs@AC, and non-calcined TNTs@AC, respectively. FIG. 11 shows that the defluorination of PFOA in control solution (i.e., without photocatalyst) and defluorination of PFOA pre-sorbed on plain F-400 was negligible. Hence, both the Fe-modification and calcination played an important role in enhancing the photocatalytic defluorination of PFOA. Compared to non-adsorptive photocatalysts, Fe/TNTs@AC offers some unique advantages, including 1) it pre-concentrates PFAS on the solid surface through adsorption, and 2) photo-irradiation was applied to the PFOA-laden solid only rather than to the bulk water, resulting in much more efficient photocatalytic defluorination.

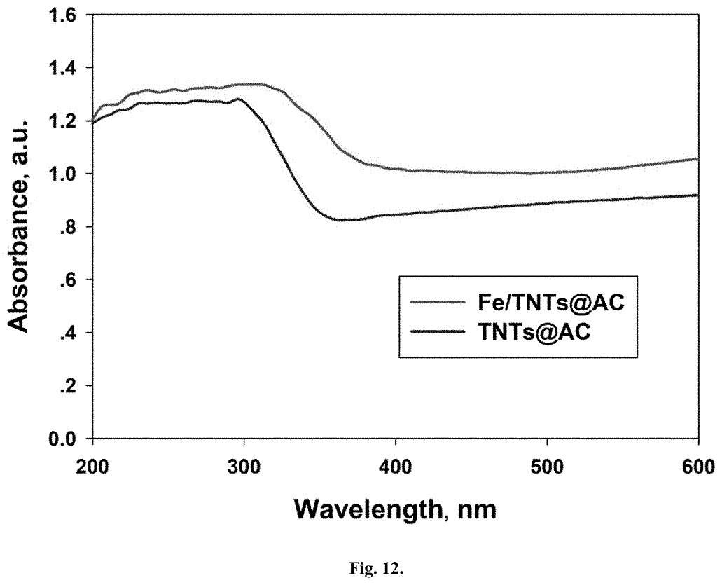

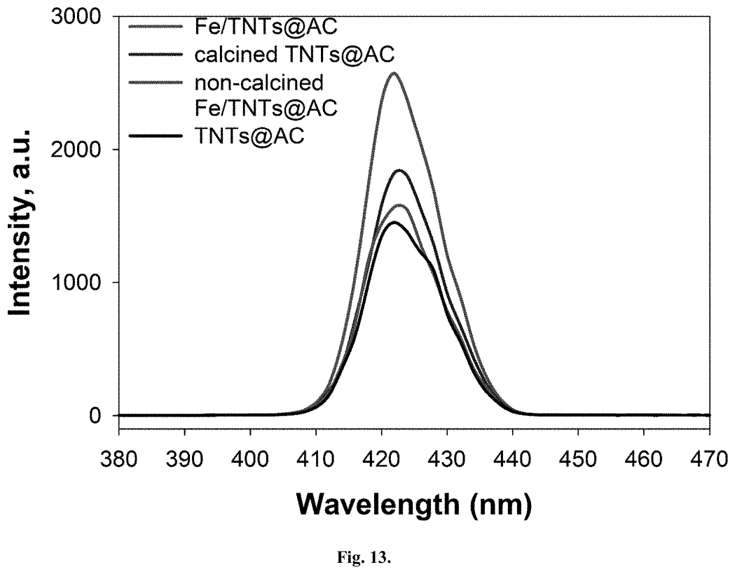

The UV-DRS results (FIG. 12) show that the spectra of Fe/TNTs@AC not only displayed a blue shift compared to those of TNTs@AC, but also a higher light absorbance, especially in the wavelength range of >300 nm, including enhanced absorbance of visible light. The PL data in FIG. 13 indicate that calcined Fe/TNTs@AC generated much more hydroxyl radicals than non-calcined Fe/TNTs@AC or TNTs@AC.

The pseudo first-order kinetic model (Eq. 12) and retarded first-order kinetic model (Eq. 13) were tested to fit the PFOA photodegradation rate data, and Table 9 presents the best-fitted parameters.

$$\begin{matrix}ln ( \frac{{M}_{t}}{{M}_{0}} ) = - {k}_{1} t & ( 12 ) \\ \frac{{M}_{0}}{{M}_{t}} = \frac{1}{{( 1 + α t )}^{- {k}_{α} / α}} & ( 13 )\end{matrix}$$

where M₀ and Mₜ are the PFOA mass (g) at time 0 and t (h), respectively, k₁ is the first-order rate constant (h⁻¹), kₐ is the retarded first-order rate constant (h⁻¹), and α is the retardation factor indicating the extent of departure from the pseudo first-order behavior.

TABLE 9
Pseudo first-order model and retarded first-order kinetic model parameters
for photo-degradation of PFOA preloaded on various catalysts.

| | | Materials | | | |
|---|---|---|---|---|---|
| | | | Calcined | Non-calcined | |
| Models | Parameters | Fe/TNTs@AC | TNTs@AC | Fe/TNTs@AC | TNTs@AC |
| Pseudo | k₁ (h⁻¹) | 0.503 | 0.424 | 0.321 | 0.074 |
| first- | R² | 0.828 | 0.932 | 0.962 | 0.868 |
| order | | | | | |
| Retarded | α (h⁻¹) | 0.930 | 0.863 | 0.389 | 1.947 |
| first- | k_{α} (h⁻¹) | 0.918 | 0.839 | 0.497 | 0.229 |
| order | R² | 0.922 | 0.977 | 0.999 | 0.982 |

The retarded first-order model incorporates a factor of a into the rate constant to accommodate the decaying reactivity during the reaction, and thus better describes the reaction kinetics with gradual deviation from the initial rate (see R² values in Table 9). Typically, the gradual deviation is caused by 1) weakening reactivity, 2) more diluted reactant concentration at the reactive sites; and 3) reactions on the deeper and less accessible sites. Moreover, the production of less degradable intermediate products (mostly shorter chain perfluoroalkyl carboxylic acids) may compete for the reactive sites. The retarded first-order model well described the PFOA degradation rate data for all materials (R²>0.9). Table 9 presents the best-fitted parameters of the kinetics model. Fe/TNTs@AC exhibited the highest kₐ value of 0.918 h⁻¹ among the materials tested.

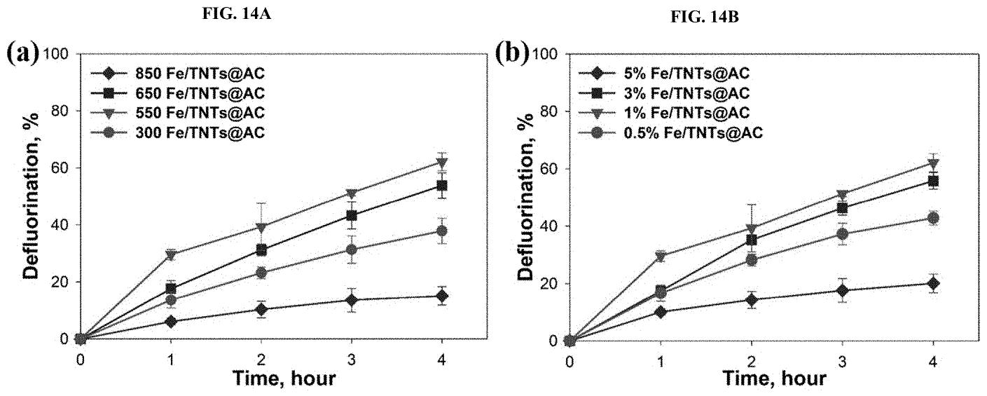

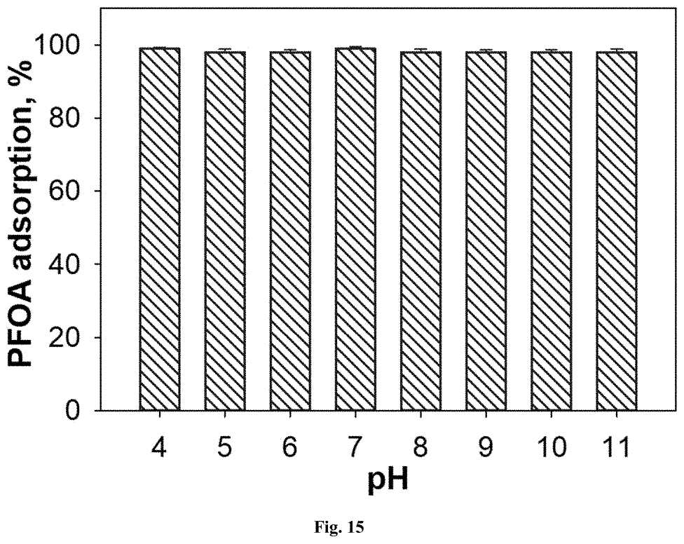

To optimize the photocatalytic performance of Fe/TNTs@AC, the calcination temperature and Fe content were varied. In all cases, Fe/TNTs@AC was able to adsorb >99% of PFOA within 2 h (adsorption conditions: initial PFOA=100 g L⁻¹, material dosage=1 g L⁻¹, pH=7.0). Consequently, material optimization was then focused on the photodegradation effectiveness. FIG. 14A compares the defluorination rates of Fe/TNTs@AC prepared at a fixed Fe content of 1 wt. % and various calcination temperatures (300-850° C.), and the results indicate that Fe/TNTs@AC prepared at 550° C. displayed the highest defluorination rate, with ˜62% of fluorine converted to fluoride after 4 h of UV irradiation. Increasing the temperature to 650 and 850° C. decreased the defluorination to 57% and 16%, respectively. Conversely, lowering the calcination temperature to 300° C. resulted in only 37% defluorination.

Substrances such as titanate can be transferred into anatase at 200° C., and the phase conversion process is highly related to interlayered Na content. As the calcination temperature increases, more anatase crystallites are formed, which can absorb a broader range of light. However, when the calcination temperature exceeds 600° C., the anatase phase tends to transform into the rutile phase, which has much lower photocatalytic activity than the anatase phase. Thus, the optimal calcination temperature range can fall between 500 to 600° C. In addition, the calcination may also affect the electron conductivity of the carbon nanoparticles and photocatalytic characteristics of the iron oxide particles, which are to be investigated in follow-on studies.

FIG. 14B compares the photocatalytic defluorination rates of PFOA by Fe/TNTs@AC prepared at a fixed calcination temperature of 550° C. and various Fe contents (0.5-5 wt. %). The highest defluorination was observed at an Fe content of 1 wt. %, with ˜62% of fluorine converted into fluoride in 4 h. Increasing the Fe content to 3 and 5 wt. % decreased the defluorination extent to 57% and 20%, respectively, and conversely, lowering the Fe content to 0.5 wt. % resulted in only 43% of PFOA defluorinated. Although increasing Fe content can suppress the surface negative potential and enhance the interactions with the head group of PFOA, excessive amounts of iron oxides may act as recombination centers for the photo-generated electrons and holes due to the quantum tunneling effects. When PFOA is taken up by iron oxide alone, the synergistic effect of the carbon nanoparticles could be compromised. Moreover, excessive loading of Fe₂O₃ aggregates on the TNTs may hamper the photocatalytic activity of anatase.

FIG. 15 shows that Fe/TNTs@AC was able to adsorb nearly all (˜99%) of PFOA in the solution over a broad pH range of 4.0-11.0 within 2 h. The different material phases of Fe/TNTs@AC adsorb PFOA through different mechanisms. The α-Fe₂O₃/TNTs phases bind with PFOA through electrostatic interactions and complexation with the head carboxylate group, whereas AC adsorbs PFOA through hydrophobic and anion-π interactions with the tail and the CF₂/CF₃ entities. The concurrent interactions result in a side-on adsorption mode, where PFOA is attached in parallel to the material surface through the multi-point synergistic interactions. Theoretically, alkaline pH could be less favorable for α-Fe₂O₃/TNTs to interact with the carboxylate group due to increased surface repulsion and competition of OH⁻. Consequently, the hydrophobic and anion-π interactions can be more important at higher pH. In other words, the PFOA adsorption switches from the parallel side-on mode to a vertical tail-on orientation at elevated pH, though the overall uptake remained comparable.

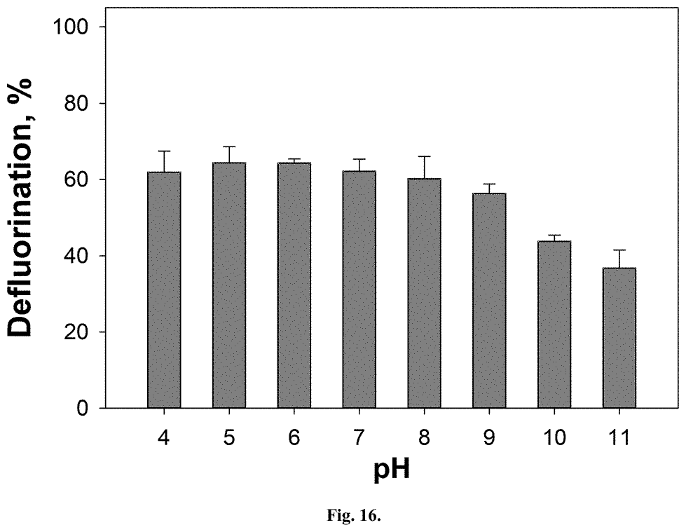

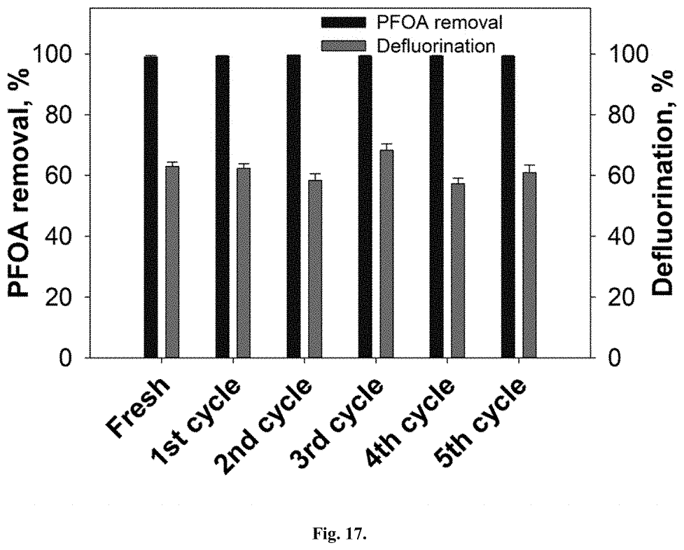

FIG. 16 compares the defluorination rates of the pre-sorbed PFOA at various pH levels. Fe/TNTs@AC performed equally well over the pH range of 4.0-8.0, with average defluorination of 61.3% after 4 h of the UV irradiation. At pH 9.0, the defluorination dropped to 56.8%, and further increasing the pH to 10.0 and 11.0 lowered the defluorination to 42.7% and 36.1%, respectively. The decrease in the photodegradation activity at pH≥9 is in accord with the less favorable adsorption mode, i.e., the tail-tethered orientation of PFOA on the AC surface is less conducive to the hole-mediated decarboxylation of the head group, which is the first step in the PFOA photodegradation. This is because the reactive species (holes and radicals) are generated at the interface of α-Fe₂O₃/TNTs upon light irradiation. As such, the head group is more favorably decarboxylated when it is adsorbed on α-Fe₂O₃/TNTs. In addition, when pH is too high, the excessive OH⁻ could react with photogenerated holes to produce excessive hydroxyl radicals, which inhibit the direct hole oxidation of PFOA.

Table 10 gives the initial and final pH. The pH change was ≤0.1 during the adsorption, indicating that the release of OH⁻ was negligible. The pH decreased by up to 0.3 after the photodegradation at acidic or neutral pH, which can be attributed to the consumption of .OH and the associated release of H⁺.

TABLE 10
Initial and final pH in the experiments at various pH levels.

| | Adsorption | | Photodegradation | |
|---|---|---|---|---|
| pH | Initial pH | Final pH | Initial pH | Final pH |
| 4 | 4.0 ± 0.1 | 4.0 ± 0.2 | 4.0 ± 0.1 | 4.0 ± 0.1 |
| 5 | 5.0 ± 0.1 | 5.1 ± 0.1 | 5.0 ± 0.1 | 4.9 ± 0.2 |
| 6 | 6.0 ± 0.2 | 6.0 ± 0.3 | 6.1 ± 0.2 | 5.8 ± 0.2 |
| 7 | 7.0 ± 0.3 | 7.1 ± 0.4 | 7.0 ± 0.3 | 6.7 ± 0.2 |
| 8 | 8.0 ± 0.2 | 8.1 ± 0.3 | 8.0 ± 0.1 | 7.9 ± 0.1 |
| 9 | 9.0 ± 0.2 | 9.0 ± 0.4 | 9.0 ± 0.2 | 9.2 ± 0.1 |
| 10 | 10.0 ± 0.1 | 10.0 ± 0.2 | 10.0 ± 0.1 | 10.1 ± 0.1 |
| 11 | 11.0 ± 0.1 | 11.1 ± 0.2 | 11.0 ± 0.1 | 11.0 ± 0.2 |

FIG. 17 shows that when Fe/TNTs@AC was repeatedly used in six consecutive cycles of adsorption-photodegradation, the PFOA adsorption remained high (>99% removal), and the defluorination rate kept at ˜60%. The results indicate that the efficient photodegradation of pre-concentrated PFOA also can regenerate Fe/TNTs@AC, and the material can be reused in multiple cycles without additional chemical regeneration. This important feature represents a unique advantage of the adsorptive photocatalyst over conventional adsorbents (e.g., AC or ion exchange resins), which often require costly regeneration and subsequent treatment of the spent regenerant wastes. The slight increase in defluorination with the number of cycles is attributed to the additional defluorination of intermediate products from the previous cycle. Indeed, short-chain PFAS were detected on Fe/TNTs@AC during the photodegradation process. No Ti leaching was detected and about 2.53 wt. % of the impregnated Fe was leached into the solution after Fe/TNTs@AC was subjected to the six adsorption/photodegradation cycles.

### Example 4

### Density Functional Theory Calculations of Fe/TNTs@AC

To understand the role of surface complexation in adsorption of PFOA anions on Fe/TNTs@AC, the Fukui index of organic compounds was obtained from the Peking University Reactive Sites for Organic Compounds Database (PKU-REOD). Specifically, the density functional theory (DFT) calculations were performed using the Gaussian 16 C.01 package (Frisch et al., 2016). The B3LYP functional 6-311+G(d,p) basis set and the Integral Equation Formalism Polarized Continuum Model (IEFPCM) as the solvation model were employed in the hybrid DFT calculations. To determine the orientation of PFOA adsorbed on the surface (e.g., parallel or perpendicular), formic acid and edge-sharing octahedral dimers with two Fe₃+ atoms were used to mimic the surface binding. This simplified configuration saves a lot of computing time and, at the same time, adequately predicts the possible orientation of PFOA anions on the surface.

The Fukui function and the calculated electrostatic potential (ESP) were used to predict the regioselectivity of reactive species (h+ and .OH) acting on PFOA. The geometry optimization and single-point energy calculations were carried out following the B3LYP approach with the 6-31+G(d,p) basis set.

The Fukui function has been widely used in the prediction of reactive sites of electrophilic, nucleophilic, and general radical attacks. Specifically, the Fukui function is defined as:

$$f ( r ) = {[ \frac{\partial ρ ( r )}{\partial N} ]}_{V ( r )} \qquad ( 4 )$$

where ρ(r) is the electron density at a point r in space, N is the electron number in the system, and the constant term ν is the external potential. In this work, the atomic population number was used to represent the electron density distribution around an atom, and the condensed Fukui functions for different radical attacks were calculated via:

$$\begin{matrix}Electrophilic attack : {f}_{A}^{-} = {q}_{N - 1}^{A} - {q}_{N}^{A} & ( 5 ) \\ Nuecleophilic attack : {f}_{A}^{+} = {q}_{N}^{A} - {q}_{N + 1}^{A} & ( 6 ) \\ Radical attack : {f}_{A}^{0} = \frac{{q}_{N - 1}^{A} - {q}_{N + 1}^{A}}{2} & ( 7 )\end{matrix}$$

where q^{A} is the charge of atom A at the corresponding state. The more reactive sites on a molecule usually have larger values of the Fukui index than other regions. In this study, the natural population analysis (NPA) charge was used to calculate the Fukui index.

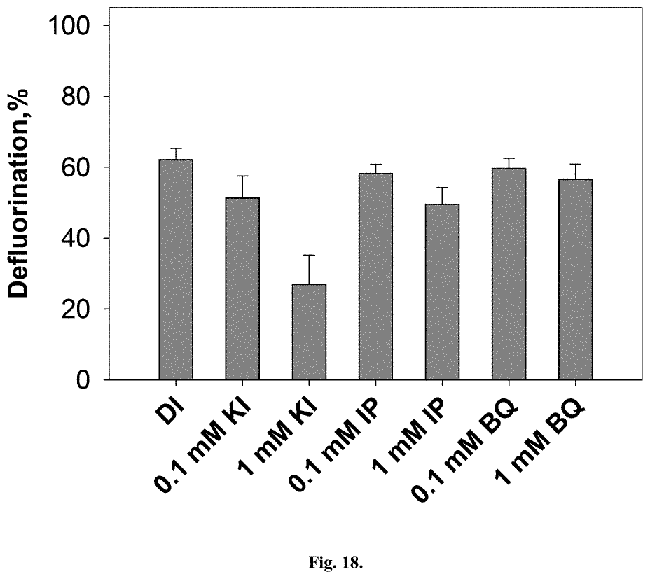

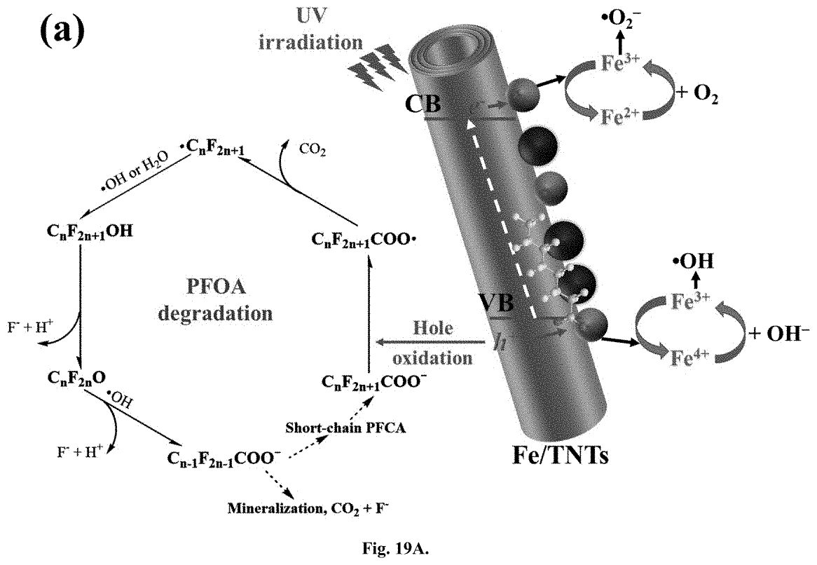

To examine roles of h⁺, .OH, and .O₂⁻, the photocatalytic defluorination of PFOA was tested in the presence of various scavengers. FIG. 18 compares the mineralization extents of PFOA, which was preloaded on Fe/TNTs@AC, after 2 h of the UV irradiation. The addition of KI, a scavenger for h⁺ (k≥1.1×10¹⁰ M⁻¹ s⁻¹), inhibited the PFOA defluorination from 62% to 51% (0.1 mM KI) and 28% (1 mM KI) at neutral pH. In contrast, the presence of 1 mM of isopropanol (P), a scavenger for .OH (k=1.9×10⁹ M⁻¹ s⁻¹) only modestly inhibited the defluorination (from 62% to 51%), whereas the addition of 0.1 or 1 mM benzoquinone (BQ), a scavenger for .O₂⁻ (k=3.7×10⁶ M⁻¹ s⁻¹) exhibited a negligible influence. These results suggest that direct h⁺-driven oxidation played a predominant role in PFOA photodegradation by Fe/TNTs@AC. The results are consistent with previous observations with In₂O₃- or TiO₂-based photocatalysts.

Table 11 lists the intermediates and products after 2 h of the photodegradation of PFOA detected by LC-QTOF-MS. The intermediates at the m/z values of 413, 363, 313, 263, 213, 163, and 113 are assigned to PFOA and various shorter chain PFCAs, including PFHpA, PFHxA, PFPeA, PFBA, PFPA, and TFA anions, respectively.

TABLE 11
Intermediates and products formed during the ACE degradation process.

| | | | Retention | |
|---|---|---|---|---|
| | | | time | |
| Compounds | Chemical formula | m/z | (min) | Chemical structure |
| Perfluorooctanoic acid (PFOA) | C₇F₁₅COO⁻ | 413 | 5.1 | 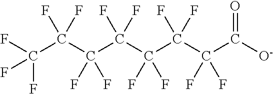 [SMILES: O=C([O-])C(F)(F)C(F)(F)C(F)(F)C(F)(F)C(F)(F)C(F)(F)C(F)(F)F] |
| Perfluoroheptanoic acid (PFHpA) | C₆F₁₃COO⁻ | 363 | 4.6 | 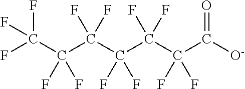 [SMILES: O=C([O-])C(F)(F)C(F)(F)C(F)(F)C(F)(F)C(F)(F)C(F)(F)F] |
| Perfluorohexanoic acid (PFHxA) | C₅F₁₁COO⁻ | 313 | 3.8 | 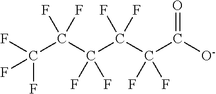 [SMILES: O=C([O-])C(F)(F)C(F)(F)C(F)(F)C(F)(F)C(F)(F)F] |
| Perfluoropentaonoic acid (PFPeA) | C₄F₉COO⁻ | 263 | 3.4 | 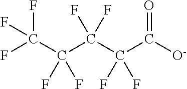 [SMILES: O=C([O-])C(F)(F)C(F)(F)C(F)(F)C(F)(F)F] |
| Perfluorobutanoic acid (PFBA) | C₃F₇COO⁻ | 213 | 2.9 | 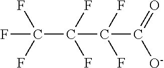 [SMILES: O=C([O-])C(F)(F)C(F)(F)C(F)(F)F] |
| Perfluoropropionic acid (PFPrA) | C₂F₅COO⁻ | 163 | 2.3 | 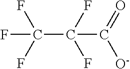 |
| Trifluoroacetic acid (TFA) | CF₃COO⁻ | 113 | 1.8 | 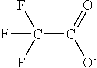 |

Based on the latest theory of photocatalysis for standard Ti-based materials and our experimental observations, the PFOA photocatalytic degradation by Fe/TNTs@AC proceeds through the following stepwise defluorination process:

C₇F₁₅COO⁻+≡FeOH₂⁺→C₇F₁₅COO⁻≡FeOH₂⁺ (14)

Fe/TNTs@AC+hv→e⁻(CB)+h⁺(VB) (15)

h⁺(VB)+H₂O→.OH+H⁺ (16)

h⁺(VB)+OH⁻→.OH (17)

C₇F₁₅COO⁻+h⁺(VB)→C₇F₁₅COO. (18)

C₇F₁₅COO.→.C₇F₁₅+COO (19)

.C₇F₁₅+.OH→C₇F₁₅OH or .C₇F₁₅+H₂O→C₇F₁₅OH+H⁺ (20)

C₇F₁₅OH→C₆F₁₃COF+H⁺+F⁻ (21)

C₆F₁₃COF+.OH→C₆F₁₃COO⁻+H⁺+F⁻ (22)

C₆F₁₃COO⁻+h⁺(VB)/.OH→C₅F₁₁COO⁻+2F⁻+CO₂+H⁺→ . . . →CₙF₂ₙ₊₁COO⁻+2F⁻+CO₂+H⁺→ . . . →F⁻+CO₂+H₂O (23)

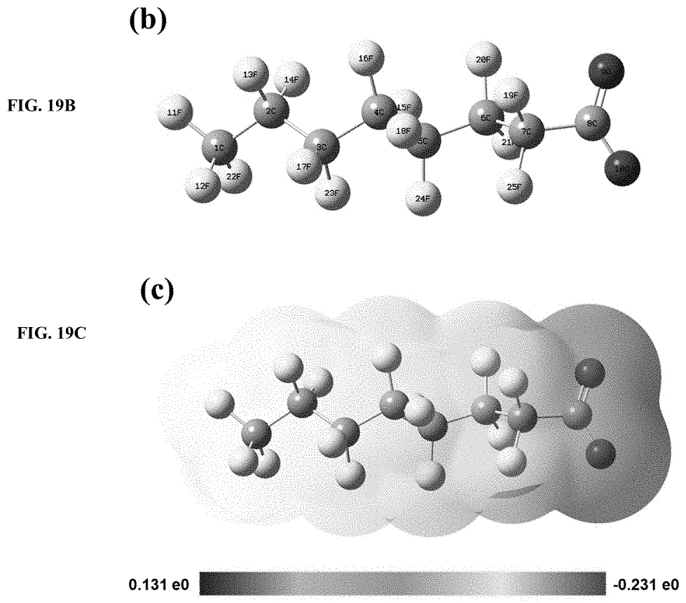

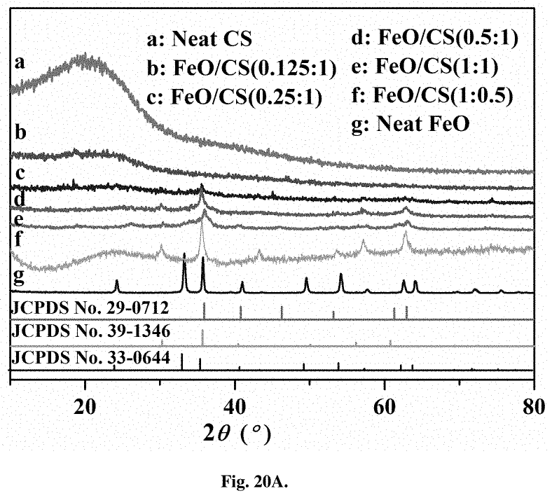

FIG. 19A illustrates the photocatalytic reaction mechanisms. First, PFOA is adsorbed on the impregnated iron (hydr)oxide nanoparticles through concurrent electrostatic and Lewis acid-base interactions between the head carboxylate group of PFOA and the center iron on the surface (Eq. 14). Second, under UV irradiation, electrons (e, conduction band) and holes (h⁺, valence band) are generated (Eq. 15). The photo-generated holes further react with H₂O and OH⁻ to give .OH radicals (Eqs. 16 and 17). Third, the adsorbed PFOA is oxidized by the photo-generated holes (h⁺) (Eq. 18) to form the unstable perfluoroalkyl radical (C₇F₁₅COO.), which decomposes into .C₇F₁₅ through a photo-Kolbe-like decarboxylation reaction with the head (COO⁻) group cleaved (Eq. 19). The resulting .C₇F₁₅ radical is further decomposed via reactions with .OH and hydrolysis (Eq. 20). The resulting C₇F₁₅OH is highly unstable, leading to the cleavage of a C—F bond and the release of one fluoride ion (Eq. 21). The intermediate product C₆F₁₃COF is easily attacked by .OH radicals, resulting in the shorter-chain PFCA (Eq. 22). The shorter-chain product C₆F₁₃COO⁻ undergoes the same decarboxylation/defluorination cycle, each of which eliminating one carbon and two fluorine atoms (CF₂) (Eq. 23).

Short-chain PFAS have been found less adsorbable and more persistent than the long-chain PFAS. Based on the stepwise defluorination mechanism (Eq. 23), the detection of intermediates (Table 11), and the high mineralization efficiency (FIGS. 14A-14B and 16), it is evident that Fe/TNTs@AC can also photocatalytically degrade short-chain PFAS. However, further detailed investigations are warranted into the degradation/mineralization rates and final products.

Although .OH may not directly initiate the PFOA degradation, .OH plays an important role in the stepwise defluorination process after the hole-mediated activation of PFOA. However, excessive .OH produced under alkaline conditions can quench the overall reaction because 1) .OH may compete with PFOA for the holes (the primary reactive species for PFOA) and 2) .OH has lower oxidation penitential than the holes.

Since the reaction starts with the head group decarboxylation, the introduction of iron plays a critical role as it can attract the head groups of PFOA to the vicinity of the photoactive sites, rendering the subsequent photodegradation much more favorable. Moreover, while .OH may not directly attack PFOA, it played an important role in reacting with the intermediate products, as revealed in Eqs. 20 and 22.

The Fukui index based on natural bond orbital (NBO) analysis was conducted to evaluate the reactivity of the active sites of PFOA. FIG. 19B shows the molecular structure of PFOA with various sites labeled, and FIG. 19C displays the calculated electrostatic potential (ESP) distribution on the PFOA molecule. As expected, the highest ESP was at the carboxyl head group, which gradually decayed towards the tail. Since the reactive species (h⁺, .OH, and .O₂⁻) in the system are all electron-deficient and electrophilic, the sites possessing more negative ESP are more prone to being attached. Consequently, decarboxylation of the head group occurred first. To describe the site reactivity towards the electrophiles, both the Fukui index representing electrophilic attack (f⁻) and radical attack (f⁰) were calculated based on the DFT approach (Table 12).

TABLE 12
Condensed Fukui index distribution of active sites on PFOA.

| | | Charge (−1) | Charge (0) | Charge (−2) | | | |
|---|---|---|---|---|---|---|---|
| Atom | No. | (e/Å³) | (e/Å³) | (e/Å³) | f⁺ | f⁻ | f⁰ |
| C | 1 | 1.07666 | 1.08701 | 1.06407 | 0.01259 | 0.01035 | 0.01147 |
| C | 2 | 0.64699 | 0.66353 | 0.63186 | 0.01513 | 0.01654 | 0.015835 |
| C | 3 | 0.67636 | 0.69537 | 0.65121 | 0.02515 | 0.01901 | 0.02208 |
| C | 4 | 0.67997 | 0.70102 | 0.64404 | 0.03593 | 0.02105 | 0.02849 |
| C | 5 | 0.67852 | 0.70209 | 0.6349 | 0.04362 | 0.02357 | 0.033595 |
| C | 6 | 0.68192 | 0.69449 | 0.62359 | 0.05833 | 0.01257 | 0.03545 |
| C | 7 | 0.63063 | 0.68158 | 0.57566 | 0.05497 | 0.05095 | 0.05296 |
| C | 8 | 0.75827 | 0.78471 | 0.56985 | 0.18842 | 0.02644 | 0.10743 |
| O | 9 | −0.52616 | −0.30838 | −0.65144 | 0.12528 | 0.21778 | 0.17153 |
| O | 10 | −0.67279 | −0.59405 | −0.74719 | 0.0744 | 0.07874 | 0.07657 |
| H | 11 | 0.50938 | 0.54418 | 0.47439 | 0.03499 | 0.0348 | 0.034895 |
| F | 12 | −0.34199 | −0.31624 | −0.35996 | 0.01797 | 0.02575 | 0.02186 |
| F | 13 | −0.34765 | −0.32588 | −0.35196 | 0.00431 | 0.02177 | 0.01304 |
| F | 14 | −0.33903 | −0.31719 | −0.35516 | 0.01613 | 0.02184 | 0.018985 |
| F | 15 | −0.34285 | −0.31082 | −0.35129 | 0.00844 | 0.03203 | 0.020235 |
| F | 16 | −0.3403 | −0.3068 | −0.36414 | 0.02384 | 0.0335 | 0.02867 |
| F | 17 | −0.33954 | −0.30556 | −0.3603 | 0.02076 | 0.03398 | 0.02737 |
| F | 18 | −0.3417 | −0.30734 | −0.35819 | 0.01649 | 0.03436 | 0.025425 |
| F | 19 | −0.34065 | −0.30587 | −0.36774 | 0.02709 | 0.03478 | 0.030935 |
| F | 20 | −0.33035 | −0.28312 | −0.3686 | 0.03825 | 0.04723 | 0.04274 |
| F | 21 | −0.33306 | −0.28947 | −0.36586 | 0.0328 | 0.04359 | 0.038195 |
| F | 22 | −0.34679 | −0.31732 | −0.38039 | 0.0336 | 0.02947 | 0.031535 |
| F | 23 | −0.34349 | −0.33184 | −0.35529 | 0.0118 | 0.01165 | 0.011725 |
| F | 24 | −0.34198 | −0.31131 | −0.35886 | 0.01688 | 0.03067 | 0.023775 |
| F | 25 | −0.34333 | −0.30782 | −0.36683 | 0.0235 | 0.03551 | 0.029505 |
| F | 26 | −0.36705 | −0.31499 | −0.40638 | 0.03933 | 0.05206 | 0.045695 |

The O9 and O10 sites possess the highest f⁻ values (0.218 and 0.079, respectively), and thus are most favorably attacked by the electrophilic species; in the meanwhile, the C8, O9 and O10 show the highest f⁰ values (0.107, 0.172, 0.077, respectively). Therefore, the carboxylate group of PFOA is the most reactive site upon ROS, which is consistent with the proposed pathway and ESP result.

In addition to the anatase-facilitated hole oxidation mechanism, the impregnated iron (hydr)oxide particles can also generate holes and initiate the same decarboxylation reaction. Besides, the redox reactions between Fe(II)/Fe(III) and photo-generated holes/electrons also facilitate the production of .OH and .O₂⁻ radicals and prevent electron-hole recombination, leading to enhanced photodegradation of PFOA (Eqs. 24-29).

≡Fe(OH)₂+h⁺→≡Fe(OH)₂⁺ (24)

≡Fe(OH)₂+O₂→≡Fe(OH)₂⁺+.O₂⁻ (25)

Fe³⁺+h⁺→Fe⁴⁺ (26)

Fe⁴⁺+OH⁻→Fe³⁺+.OH (27)

Fe³⁺+e⁻→Fe²⁺ (28)

Fe²⁺+O₂→Fe³⁺ (29)

It is noted that while the Fe cycle can facilitate the PFOA photodegradation, an excessive amount of Fe(III) may act as recombination centers through quantum tunneling, resulting in reduced photo-activity, as indicated in FIG. 14B. In addition, dissolved oxygen may be needed to facilitate the Fe(III)-Fe(II) cycle, especially at lower pH where .OH radicals may be limited.

The enhanced adsorption and photodegradation of PFOA by Fe/TNTs@AC are attributed to: 1) the carbon nanoparticles facilitate hydrophobic and anion-π interactions with PFOA, 2) the carbon coating also facilitates electron transfer and prevents electron-hole recombination, 3) the Fe(III) coating suppresses surface negative potential and enhances the interactions between the holes and the PFOA head groups (carboxylate), 4) the Fe(III)-Fe(II) redox reaction cycle facilitates the production of .OH radicals and prevents e⁻-h⁺ recombination, and 5) because of the narrower band energy gap of iron oxide (2.1-2.3 eV for Fe₂O₃ vs 3.0-3.2 eV for TiO₂), incorporating Fe in Fe/TNTs@AC also enhances absorption of visible light.

As described herein, the “concentrate-&-destroy” strategy using adsorptive photocatalysts represents a significant advancement over conventional adsorption or photochemical treatments of PFAS-contaminated water, and holds the potential to degrade PFOA in a more cost-effective manner. Compared to AC adsorption or ion exchange, Fe/TNTs@AC not only adsorbs, but also degrades PFOA, and moreover, it eliminates the need for the costly and toxic chemical regeneration via efficient solid-phase photodegradation. Compared to direct aqueous-phase degradation of PFOA using strong oxidants, photosensitizers or other photocatalysts, the pre-concentrating ability of Fe/TNTs@AC not only facilitates more efficient solid-phase photocatalytic degradation of PFOA, but also enables the photodegradation to be carried out in a much smaller reactor with less energy input.

### Example 5

### Synthesis and Characterization of FeO/CS Composite Compositions

For preparation of the exemplary composite composition FeO/CS, iron sulfate hydrate (Fe₂(SO₄)₃.xH₂O), sodium hydroxide (NaOH), nitric acid (HNO₃), ammonium hydroxide (NH₃.H₂O, 25% (m/v)), D-glucose (C₆H₁₂O₆), isopropyl alcohol ((CH₃)₂CHOH, ISA), potassium dihydrogen phosphate (KH₂PO₄), PFOA (C₈HF₁₅O₂), ¹³C8 PFOA, and 5,5-Dimethyl-1-Pyrroline N-oxide (DMPO) were purchased from Alfa Aesar, Ward Hill, Mass., USA.

FeO/CS was synthesized via a modified one-step hydrothermal method. Briefly, 0.02 mol D-glucose was dissolved in 50 mL of ultrapure water. Then a given amount of Fe₂(SO₄)₃.xH₂O (0.00125, 0.0025, 0.005, 0.01, 0.02 mol) was dissolved in the D-glucose solution, followed by 1 h stirring. Under vigorous stirring, a 28% ammonia solution was added dropwise to raise the solution pH to 7.5±0.1. The mixture was then transferred into a Teflon-lined autoclave (100 mL) and treated at 180° C. for 18 h. After cooling to room temperature, the resulting black suspension was filtered through a 0.2 μm membrane filter, and the particles were washed by deionized water five times to remove any soluble residuals. Upon gravity settling, the solid material was oven-dried at 80° C. According to the molar ratio (m:n) of iron-to-D-glucose (Fe:Glucose) of the precursors, the resulting materials are denoted as FeO/CS (m:n). For comparison, neat CS and iron oxides were also prepared through similar processes but with only one precursor (Fe₂(SO₄)₃.xH₂O or D-glucose).

FeO/CS was thoroughly characterized to understand the material properties as related to its adsorption and photocatalytic characteristics. Supporting information (SI) presents the main characterization methods, including X-ray diffraction (XRD), Fe K-edge X-ray absorption fine structure spectra (EXAFS), UV-Vis diffuse reflectance spectra (DRS), X-ray photoelectron spectroscopy (XPS), Fourier transform infrared spectra (FTIR), and scanning electron microscope (SEM) and high-resolution transmission electron microscopy (HRTEM).

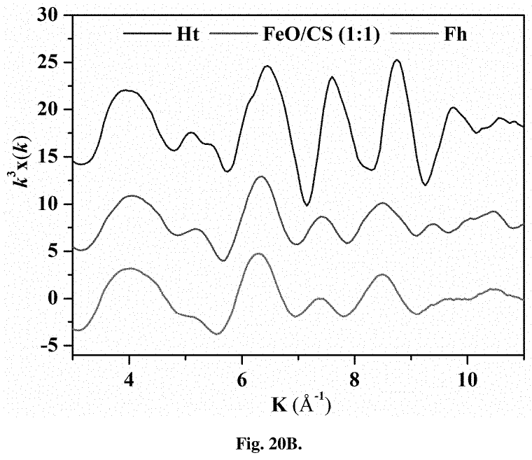

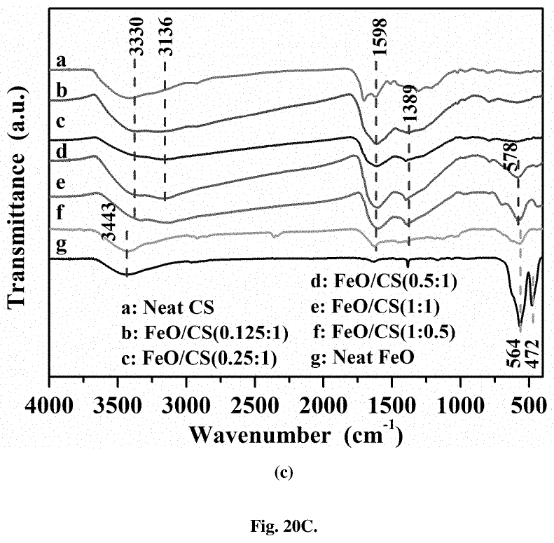

FIG. 20a shows the XRD patterns of neat FeO, CS and FeO/CS prepared at various Fe/Glucose molar ratios. In the absence of CS, the neat FeO conforms to the crystalline structure of hematite (Ht) (α-Fe₂O₃, JCPDS No. 33-0664), a form of well crystalline iron oxide. No peak was evident for neat CS and FeO/CS (0.125:1), indicating that CS and FeO/CS of low Fe content are amorphous. However, at elevated Fe/Glucose molar ratios (>0.125:1 but <1:1), FeO/CS showed two strong peaks at 35 and 63°, and four weak peaks at 41°, 46°, 53°, and 61°, which are characteristic of ferrihydrite (Fh, JCPDS No. 29-0712), a weakly crystalline hydrous ferric oxyhydroxide. However, further increasing the Fe/Glucose molar ratio to 1:0.5, FeO/CS (1:0.5) gave rise to a peak at 43.4° for γ-Fe₂O₃ (JCPDS No. 39-1346), which is another polymorph of Fe₂O₃. The XRD results indicate that the presence of CS facilitates formation of Fh crystalline structure, while hindering crystallization of Ht.

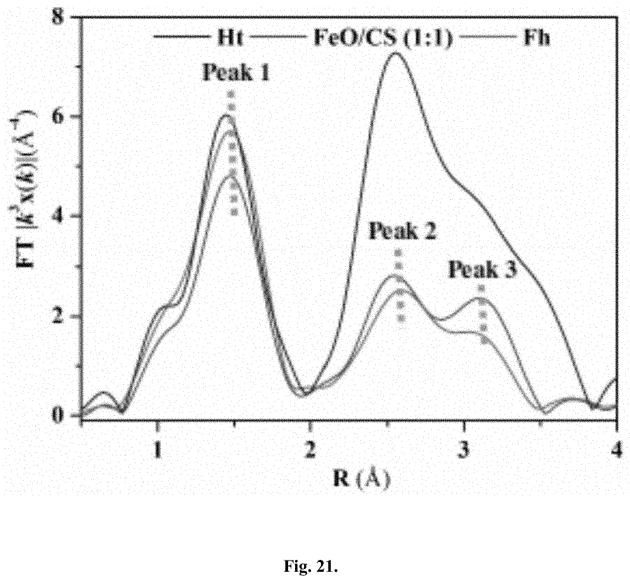

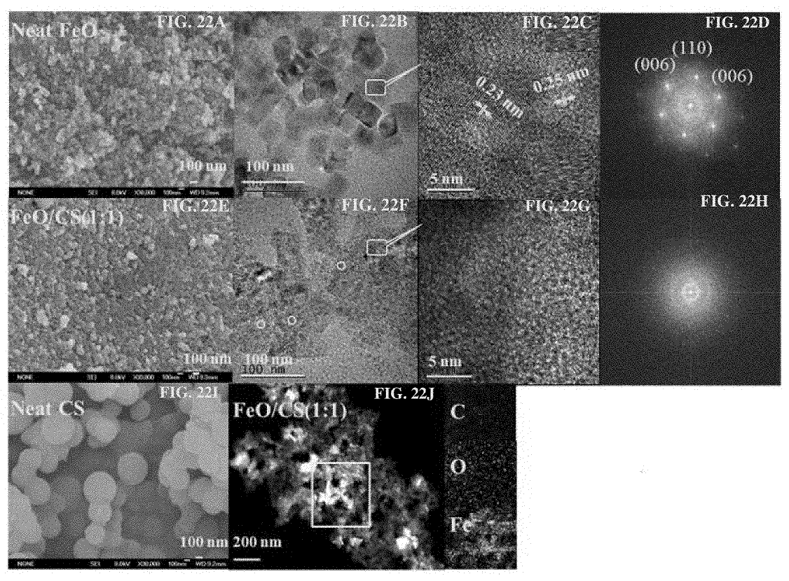

EXAFS was employed to further analyze the structure of FeO/CS (1:1) as well as neat Fh and Ht. FIG. 20b gives the Fe K-edge EXAFS spectra of FeO/CS (1:1), showing that the spectra for FeO/CS (1:1) resemble those for Fh, but differ from those for Ht, especially at ˜4.0, ˜6.5, ˜7.5 and 8.5 Å⁻¹ [32]. Furthermore, from the Fourier-transformed EXAFS spectra of the Fe K-edge in the R-space (FIG. 21), FeO/CS (1:1) exhibited three peaks corresponding to Fh, which were ascribed to Fe—O (first shell), Fe—Fe1 (second shell) and Fe—Fe2 bond (third shell), respectively [33]. Both the R-space and the K-space indicate that Fh is the predominant form of iron (hydr)oxide in FeO/CS (1:1), which agrees with the XRD results.

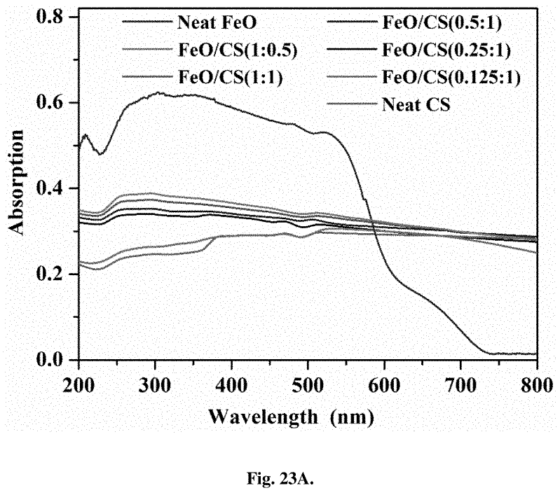

The material morphology was investigated by SEM and TEM/HRTEM (FIGS. 22A-H). Neat FeO displayed as clustered cubic crystals of 30-40 nm (FIG. 22A, 22B), whereas neat CS appeared as nearly perfect spheres, with particle size in the range of 300-700 nm (FIG. 22I). In contrast, FeO/CS (1:1) appeared as much finer and irregular agglomerated nanoparticles (FIG. 22E, 22F). The observation indicates that CS and Fe(III) may mutually affect the final composite structure and constrain the particle growth. Besides, while the HRTEM image and fast Fourier transform pattern of neat FeO (FIG. 22C, 22D) showed clear lattice fringes and reflections, those for FeO/CS (1:1) (FIG. 22G, 22H) indicated poor crystallinity of the composite, consistent with the XRD results. Moreover, the EDS elemental mapping of FeO/CS (1:1) (FIG. 22J) suggests that O, C, Fe are well distributed in the composite.

FIG. 20C shows the FTIR spectra of neat CS, FeO, and FeO/CS prepared at various Fe/Glucose molar ratios. The strong IR bands at 564 cm⁻¹ for neat FeO and FeO/CS (1:0.5) are characteristic of the Fe—O vibrations of Fe₂O₃. In contrast, for FeO/CS composites with Fe/Glucose molar ratio lower than 1:1, the Fe—O vibration was observed at 578 cm⁻¹, indicating the formation of Fh. The peak at 1703 cm⁻¹ for neat CS belongs to the C═O vibrations of carboxylic groups, whereas the band at 1570 cm⁻¹ for FeO/CS represents the stretching mode vibrations of C═C bonds of aromatic rings or conjugated carbonyl and carboxylate groups, and that at 1389 cm⁻¹ is ascribed to symmetrical bending vibrations of C—H bonds. The peaks at 3443 and 3330 cm⁻¹ are assigned to the O—H band, implying the existence of hydroxyl groups on the surface of FeO and FeO/CS.

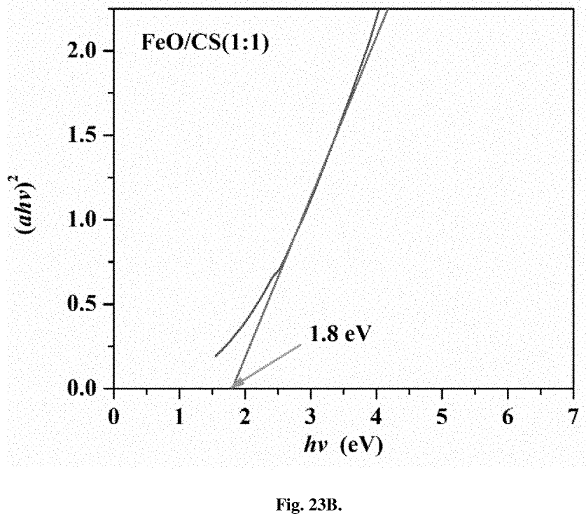

The UV-vis DRS results (FIG. 23A) show that neat FeO offered stronger absorption of light of <550 nm wavelength, while neat CS showed better light absorption at >600 nm. When combined at an Fe/Glucose molar ratio of ≥0.25:1, the FeO/CS composites showed improved light absorbance in the UV-vis region (<550 nm) than neat CS, and modestly better absorbance of visible light (>600 nm) than neat FeO. For instance, the 400 nm light absorbance for FeO/CS (1:1) was 23% higher than that for neat CS, but 39% lower than neat FeO. In addition, the Tauc plot (FIG. 23B) gives a band gap energy of 1.8 eV for FeO/CS (1:1). The results indicate that the FeO/CS composites act as effective photocatalysts under solar light.

### Example 6

### Adsorption of FeO/CS

Batch adsorption tests were carried out in 45 mL high-density polyethylene vials in the dark. The adsorption was initiated by adding 1.0 g/L of FeO/CS to 40 mL of a PFOA solution (5 mg/L or 200 μg/L, pH 7.0±0.1). Adsorption isotherm tests were conducted with 1.0 g/L FeO/CS and PFOA (pH 7.0±0.1) in the concentration range of 200 μg/L to 10 mg/L. The initial pH value of PFOA solution was adjusted using 0.1 M NaOH or HNO₃. The use of high concentration PFOA allowed to rapidly screen the materials based on their adsorption rates and extents, whereas the actual water treatment (adsorption+photodegradation) tests were carried out with 200 μg/L PFOA to be more environmentally relevant. The vials were mounted on a rotating tumbler operated at 50 rpm. At predetermined time intervals, 1 mL aliquots was sampled and filtered through a 0.22 μm poly (ether sulfones) (PES) membrane filter. The filtrate was then analyzed for PFOA.

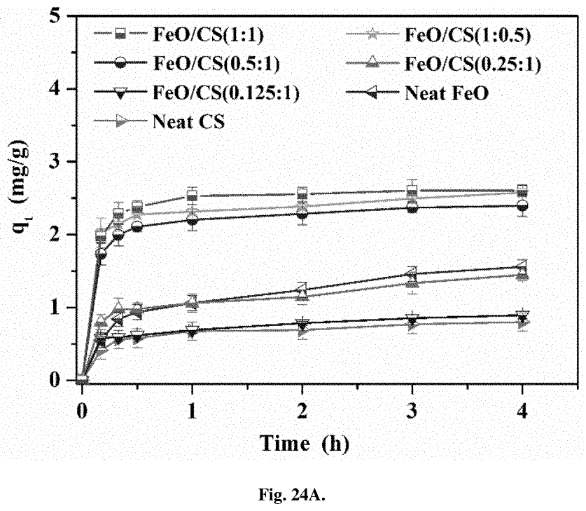

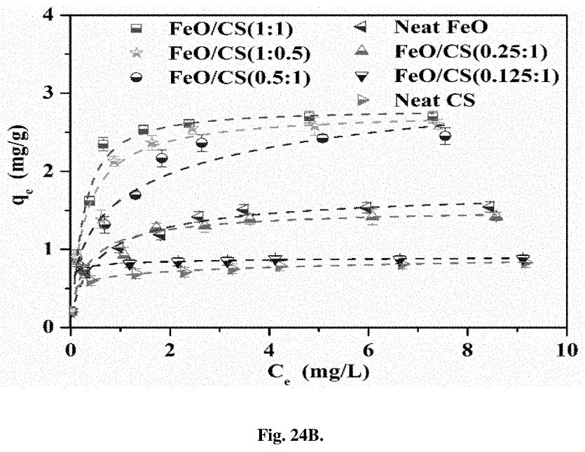

FIG. 24A compares the PFOA adsorption rates by neat CS, FeO, and FeO/CS prepared at various Fe/Glucose molar ratios (Initial PFOA=5 mg/L), and FIG. 24B shows the adsorption isotherms. Both CS and FeO were able to adsorb PFOA, despite different interacting mechanisms. Because of the relatively low carbonization temperature (180° C.) during the synthesis, the CS is expected to be less hydrophobic and less porous than typical activated carbon, thus offered lower adsorption capacity, but comparable with that of CNTs reported. FeO/CS (1:1) exhibited fastest adsorption rate, with most adsorption (>90%) completed within 30 min and with the adsorption equilibrium reached in 1 h. The adsorption of PFOA was found to increase with increasing Fe content. The maximum Langmuir capacity for FeO/CS (1:1) was 2.70 mg/g, which is 3.25 and 1.75 times higher than those for neat CS (0.83 mg/g) and FeO (1.54 mg/g). FeO/CS (1:0.5) and FeO/CS (0.5:1) also showed decent adsorption rates and capacities, though slightly underperformed than FeO/CS (1:1), which can be attributed to the different specific surface areas (Table 13) among others. Evidently, integrating CS and FeO resulted in much improved adsorption rate and capacity for PFOA than either of the individual precursors.

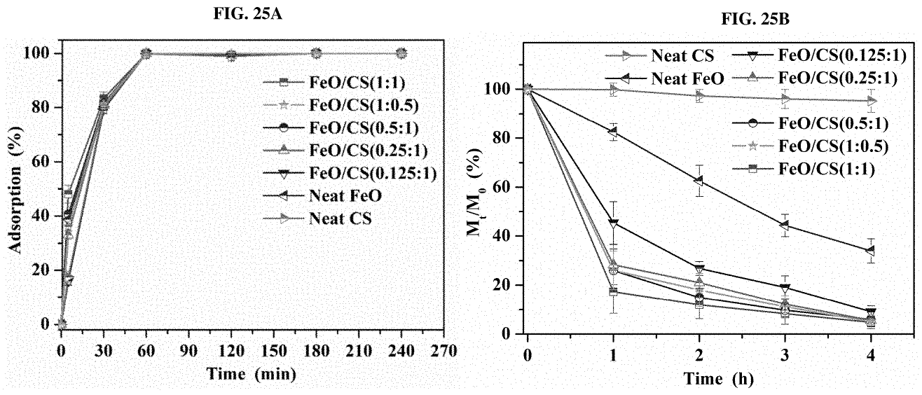

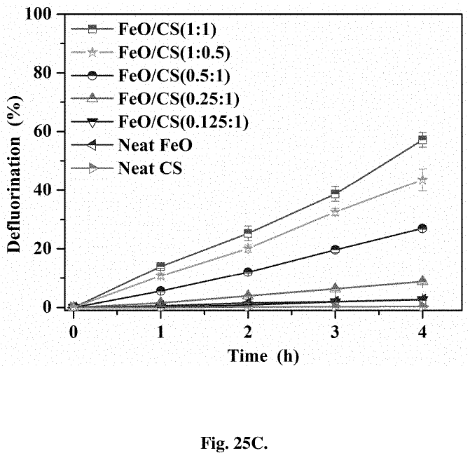

At the initial PFOA concentration of 200 μg/L, all the materials were able to remove more than 99% of PFOA within 4 h (FIG. 25A), transferring almost all PFOA from the solution to the surface of the materials.

FeO/CS may interact with PFOA through several concurrent mechanisms, including electrostatic attraction, hydrophobic interactions between CS and PFOA tail, π-anion interaction between the electron deficient aromatic rings of CS and PFOA anions, ligand exchange between PFOA carboxyl termini and coordinated OH groups on FeO surface, and hydrogen bonding between PFOA and Fe-coordinated water molecules.

The point of zero charge pH (pH_{PZC}) for neat CS and FeO/CS at various Fe/Glucose ratios ranged from 1.56 to 6.82 (Table 13), with higher Fe content giving a higher pH_{PZC}. As such, FeO/CS is expected to show a net negative potential at the experimental pH 7.0.

TABLE 13
Salient physical properties of neat iron oxide
(FeO), CS and FeO/CS prepared at various Fe/Glucose
molar ratios (indicated in the brackets).

| | | Total pore | | |
|---|---|---|---|---|
| | | volume | Mean pore | |
| | BET | (p/p₀ = 0.990) | diameter | pH of |
| | (m²/g) | (cm³/g) | (nm) | PZC |
| Neat CS | 73.41 | 0.07 | 3.63 | 1.56 |
| FeO/CS(0.125:1) | 61.08 | 0.32 | 21.01 | 3.27 |
| FeO/CS(0.25:1) | 78.91 | 0.24 | 12.31 | 4.50 |
| FeO/CS(0.5:1) | 49.12 | 0.12 | 10.04 | 4.95 |
| FeO/CS(1:1) | 57.03 | 0.08 | 5.73 | 6.08 |
| FeO/CS(1:0.5) | 46.25 | 0.18 | 12.34 | 6.82 |
| Neat FeO | 35.79 | 0.22 | 24.16 | 7.90 |

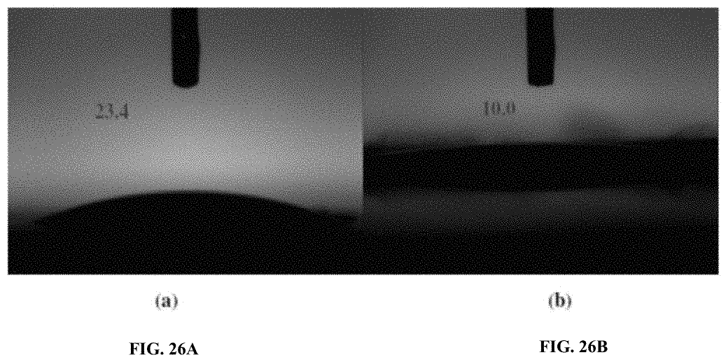

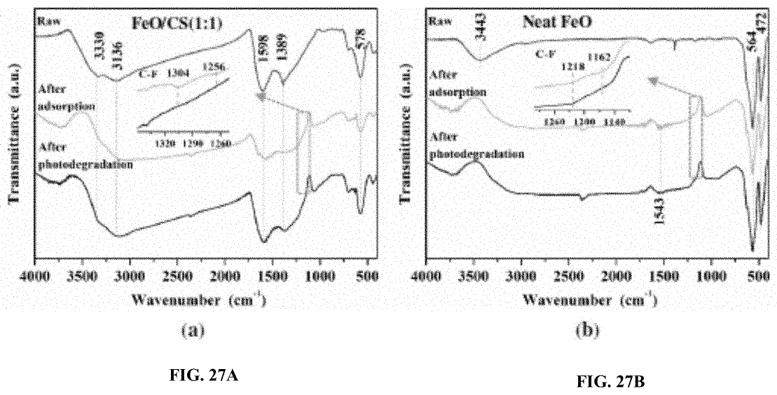

Since PFOA is present as fully dissociated anions, adsorption of PFOA by FeO/CS is unfavorable due to electrostatic repulsion. In addition, the water-contact angle of neat CS and FeO/CS (1:1) (FIGS. 26A and 26B, respectively), was measured to be 25.4° and 10.0° respectively, suggesting that both materials are rather hydrophilic due to the existence of polar groups (FIG. 20C). Hence, the hydrophobic binding between CS and PFOA is not favored. Rather, π-CF interaction between the carbon skeleton of CS and fluorine of PFOA may play an important role in PFOA adsorption. According to a study on PFOA adsorption on a Cr-based metal-organic framework, the binding energy of π-CF interaction is comparable to that of hydrogen bonding, which is ˜33% weaker than that for Cr-PFOA complexation. The FTIR patterns in FIG. 27A-27B show that upon PFOA adsorption, strong C—F vibrations in the range from 1162 to 1304 cm⁻¹ appeared for FeO/CS (1:1) (FIG. 27A), whereas the peaks of hydroxyl groups disappeared (FIG. 27B). This observation suggests that PFOA was adsorbed by exchanging with the surface hydroxyl groups.

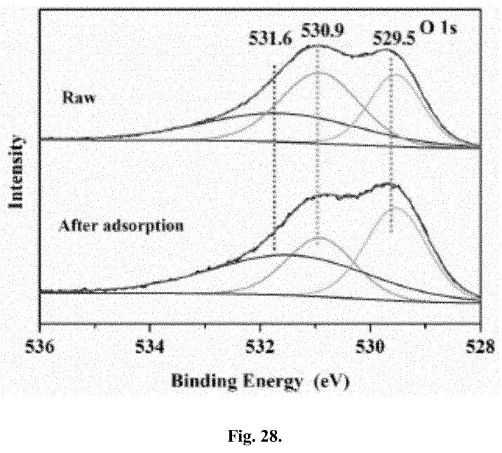

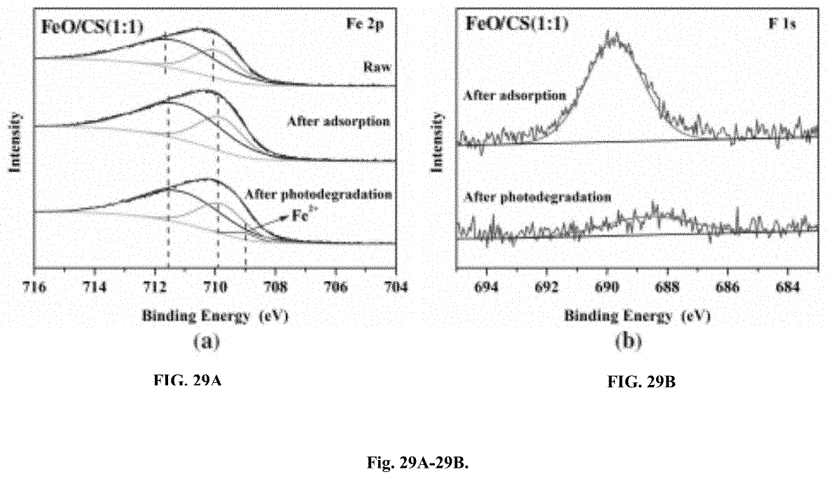

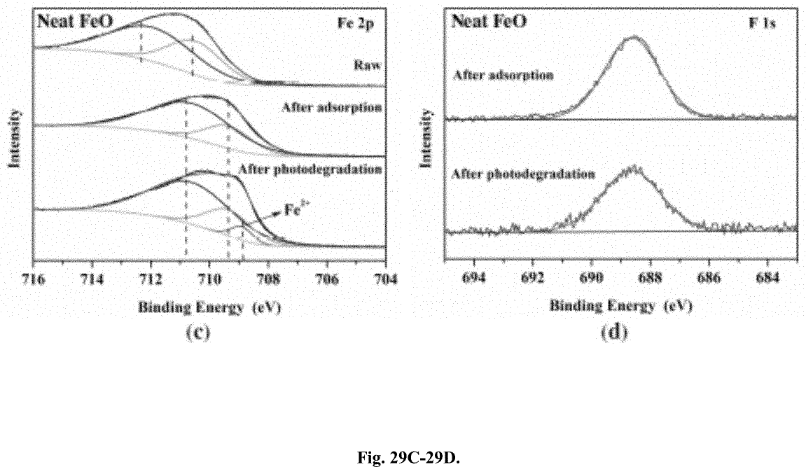

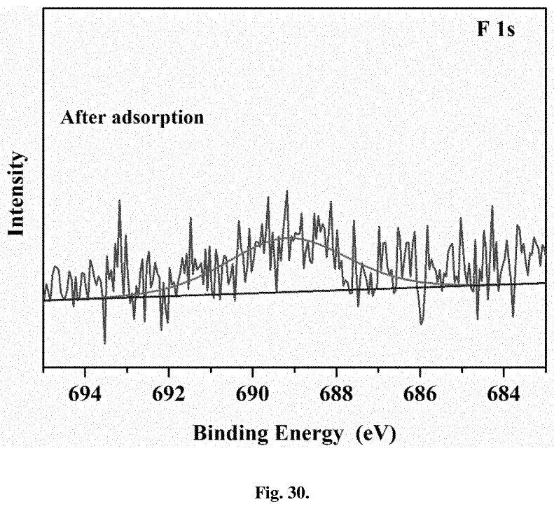

To gain further insight into the adsorption mechanisms, the O, Fe and F elements on fresh and PFOA-laden FeO/CS (1:1) were further characterized by XPS. Referring to the O1s XPS spectra (FIG. 28), the three peaks with binding energies of 531.6, 530.9, and 529.5 eV are assigned to adsorbed O (H₂O), OH groups, and structural O of FeO/CS, respectively. After adsorption of PFOA, the intensity of the OH group was decreased notably, confirming the ligand exchange between PFOA and OH group on FeO/CS surface. The Fe 2p3/2 XPS spectra of fresh FeO/CS (1:1) (FIG. 29A) show two peaks with binding energies of 710.0 and 711.3 eV, both of which belong to Fe(III). Upon adsorption of PFOA, the binding energies slightly decreased to 709.8 and 711.2 eV, respectively. In contrast, the binding energies of Fe 2p3/2 for neat FeO (FIG. 29C) decreased from 710.5 and 711.9 eV to 709.4 and 710.6 eV after PFOA adsorption. Likewise, the binding energies of F 1s also differed between FeO/CS and neat FeO, amounting to 689.8 and 688.3 eV, respectively (FIGS. 29B and 29D). Besides, the position of the F signal for PFOA-laden FeO/CS is close to that for PFOA-laden CS (689.2 eV, FIG. 30), suggesting that CS in FeO/CS also contributed to PFOA adsorption. Hence, the difference in the binding energies of Fe 2p3/2 and F 1s is attributed to different PFOA adsorption modes for neat FeO and FeO/CS. For neat FeO, PFOA is adsorbed mainly through concurrent metal-ligand interaction and electrostatic attractions (pH_{PZC} for neat FeO=7.90) under the experimental conditions; while for FeO/CS, metal-ligand interaction and π-anion interaction are the key adsorption modes as electrostatic interaction is not favored.

It is noted that the PFOA adsorption by FeO/CS is not merely affected by the Fe/CS molar ratio, but the overall physical-chemical properties of the resulting composite materials, including the specific surface area, zeta potential, porosity and pore size, crystalline structures, and adsorption modes. Consequently, FeO/CS (1:1) displayed the optimal adsorption rate and capacity. For instance, when the Fe:Glucose molar ratio is higher than 1:0.5, the FeO structure is transformed from ferrihydrite to hematite, and the BET surface area is decreased from 57.03 to 46.25 m²/g, resulting in decreased PFOA uptake.

Without being bound by any theory, the excellent PFOA adsorption by FeO/CS is believed to be attributed to the ligand exchange and formation of Fe-PFOA complexes. In addition, the presence of CS in FeO/CS also contributes to the PFOA adsorption by π-anion interactions. These multiple mechanisms may work concurrently, leading to enhanced PFOA adsorption. On the other hand, such corporative adsorption mechanisms may cause structural distortion of the long skeletal chain of PFOA, thus weakening the binding energy and reducing the energy demand for cleavage of the C—F bond.

### Example 7

### Photodegradation of Pre-Concentrated PFOA on FeO/CS

First, PFOA was pre-concentrated on FeO/CS via the batch adsorption (initial PFOA=200 μg/L, solution volume=160 mL, FeO/CS (1:1)=1.0 g/L, pH=7.0±0.1, time=4 h). Following adsorption equilibrium, FeO/CS was separated by gravity-settling, and 135 mL of the supernatant was removed by pipetting. Then, the remaining ˜25 mL of the solid-liquid mixture was transferred in a 250 mL quartz reactor and then subjected to simulated solar light through a quartz photo-reactor (see details in SI). Magnetic stirring at 200 rpm was maintained to facilitate uniform light absorbance. At predetermined times, 5 mL of the mixture was sampled. Upon gravity settling, 2 mL of the supernatant was filtered with a 0.22 μm PES membrane filter, and the filtrate was analyzed for fluoride ions (F⁻). The remaining 3 mL of solid-liquid mixture was extracted for two consecutive times, each using 20 mL of methanol at 80° C. for 8 h. Control tests indicated that the two consecutive extractions were able to recover >95% of adsorbed PFOA.

To gauge the material reusability, the same FeO/CS (1:1) was repeatedly subjected to the same adsorption/photodegradation cycle for three consecutive times.

When the PFOA-laden materials were subjected to solar light irradiation, the materials showed dramatically different photocatalytic activities for PFOA (FIG. 25B and FIG. 25C). Neat CS showed almost no PFOA degradation and defluorination after 4 h of solar irradiation. Interestingly, neat FeO was able to degrade 66.1% of the pre-sorbed PFOA, though only 2.7% was defluorinated. Given the broad presence of iron oxides in natural systems, PFOA appears rather prone to solar-light mediated weathering. In contrast, the FeO/CS composites displayed substantial synergistic effect on both photocatalytic degradation and defluorination of PFOA. FeO/CS (1:1) exhibited the highest reactivity and was able to degrade 95.2% and defluorinate 57.2% of the pre-sorbed PFOA in 4 h of solar irradiation. The degradation and defluorination rates increased with increasing the Fe/Glucose molar ratio, reaching a peak at Fe/Glucose=1:1, and then decreased at Fe/Glucose=1:0.5 because of formation of well crystalline Fe₂O₃ due to insufficient CS content.

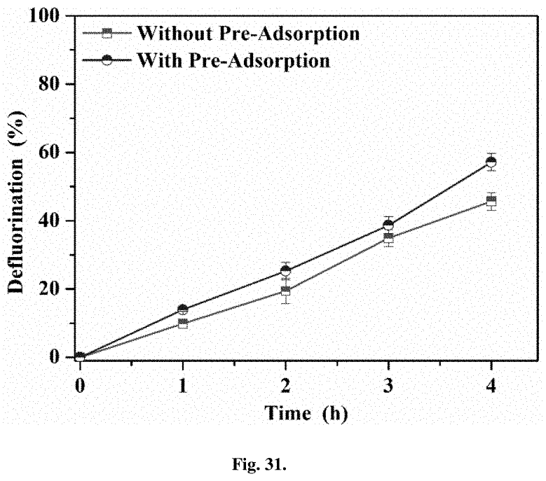

For comparison, direct defluorination of PFOA by FeO/CS (1:1) without the pre-concentrating step was carried out under otherwise identical conditions. FIG. 31 shows that 45.7% of PFOA was defluorinated in 4 h when adsorption and photodegradation were taking place concurrently and no solution was removed from the system. The result indicates that the application of when the pre-concentration step increased the PFOA mineralization by 11.5%. The reason could be attributed to the pre-concentrated procedure allow PFOA complex with Fe(III) on FeO/CS surface satisfactorily, which contribute to the electron transfer from PFOA to Fe(III) under light irradiation, which can be attributed to the improved photonic energy efficiency due to the pre-accumulation of PFOA at the reactive site and more suitable solid-to-solution ratio. Yet, the advantages of the two-step approach are not limited to improved reaction efficiency, but much reduced reactor size and energy input due to the much smaller volume of the media.

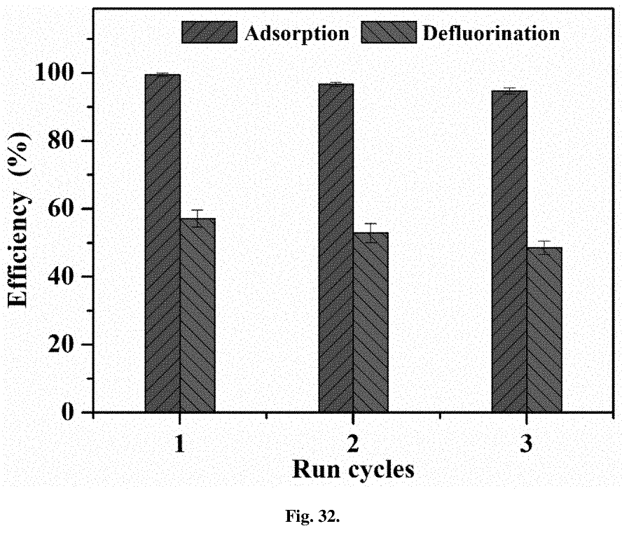

The efficient photocatalytic degradation also regenerates FeO/CS (1:1), allowing for repeated uses of the material without chemical regeneration. When it was repeatedly used in three consecutive cycles, FeO/CS (1:1) was still able to nearly completely adsorb PFOA from the solution, though the 4 h defluorination was lowered from 57.6% to 48.6% (FIG. 32). The diminished mineralization of PFOA could be due to competition of the residual intermediates for the reactive species. In practice, this limitation can be overcome by extending the solar irradiation time and intensity.

To examine the potential decay of CS during the photodegradation process, control tests were carried out by subjecting FeO/CS (1:1) to the same photo-irradiation and by comparing the CS contents (measured as total organic carbon (TOC)) in FeO/CS (1:1) before and after the solar exposure. The results indicate that the CS content in FeO/CS (1:1) changed from 46.1% to 45.7% after 4 h of the light exposure, which is statistically insignificant at the 95% confidence level (p=0.81).

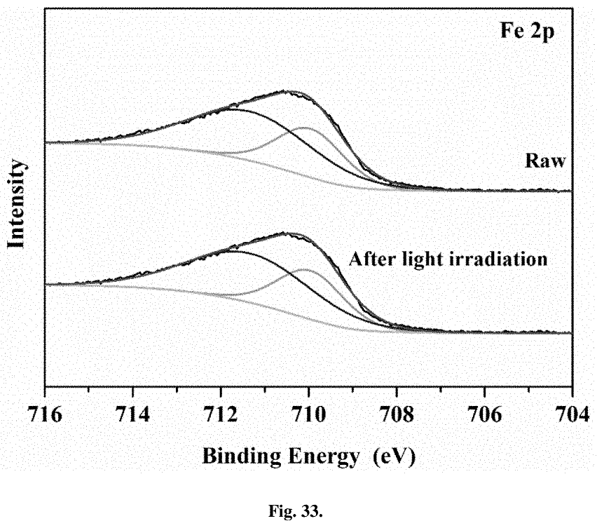

In the photochemical systems of FeO/CS (1:1) and neat FeO, and in the presence of PFOA, Fe(II) was observed in the XPS spectra (709.8 eV) after the 4 h solar irradiation (FIGS. 29A and 29C). However, no Fe(II) was evident when PFOA was absent (FIG. 33), indicating that Fe(III) was reduced into Fe(II) by accepting electrons from PFOA. In addition, a weak F signal was observed in the XPS pattern of FeO/CS (1:1) after the photocatalytic reaction with PFOA (FIG. 29B), which can be attributed to the resulting degradation intermediates of PFOA (FIG. 25B). Besides, the band energy of the F signal (688.6 eV) in FeO/CS (1:1) was close to that in neat FeO (688.3 eV), suggesting that the FeO sites of FeO/CS (1:1) dominated the adsorption of the intermediates. In contrast, for neat FeO, a strong F peak remained after the 4 h light irradiation (FIG. 29D), indicating much weaker photoactivity of neat FeO than FeO/CS (1:1). This observation is consistent with the FTIR patterns in FIG. 28 and Table 14, which show that the C—F vibrations of FeO/CS (1:1) disappeared after 4 h solar light irradiation, while those for neat FeO remained.

TABLE 14
Frequencies (cm⁻¹) and vibrational assignments
of major IR bands in FTIR spectra.

| Wavenumber | | Wavenumber | |
|---|---|---|---|
| (cm⁻¹) | Modes | (cm⁻¹) | Modes |
| 3443, 3330 | O—H | 3136 | C—H |
| 1703 | C═O | 1589 | C═C |
| 1389 | C—C | 1304 | νₐₓ(CF2) |
| 1256 | νₐₛ(CF2) | 1218 | νₐₛ(CF2) + νₐₛ(CF3) |
| 1162 | νₛ(CF2) | 578, 564, 472 | Fe—O |

To understand the much greater photocatalytic activity of FeO/CS (1:1) over neat FeO, density functional theory (DFT) calculations were performed to analyze the electron transfer process involved in the photocatalytic degradation of PFOA. Here, Fh and Ht were used as the model iron (hydr)oxides for FeO/CS (1:1) and neat FeO, respectively, based on the XRD results, and the (001) surface was considered the primary exposed face for adsorption of PFOA by both Fh and Ht.

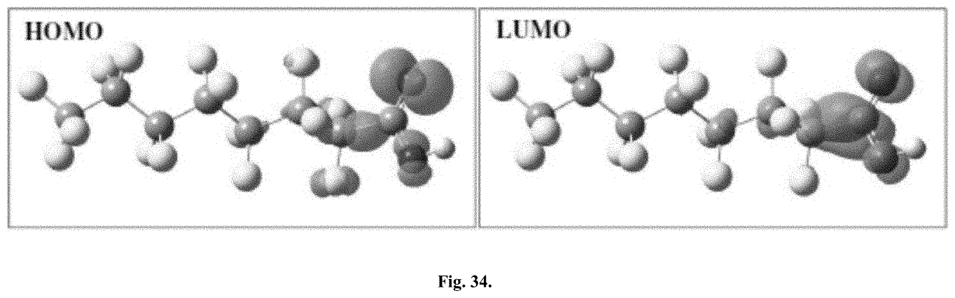

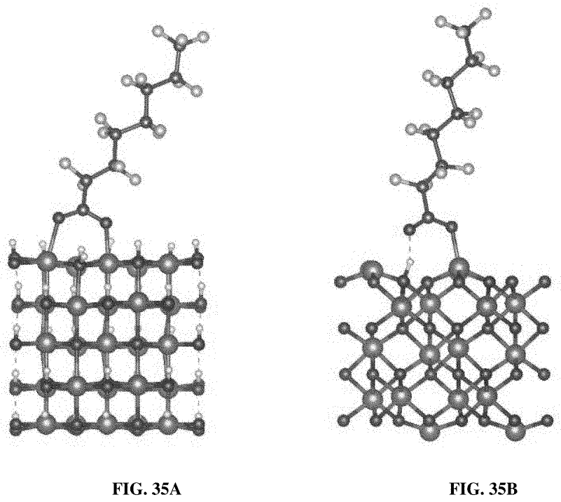

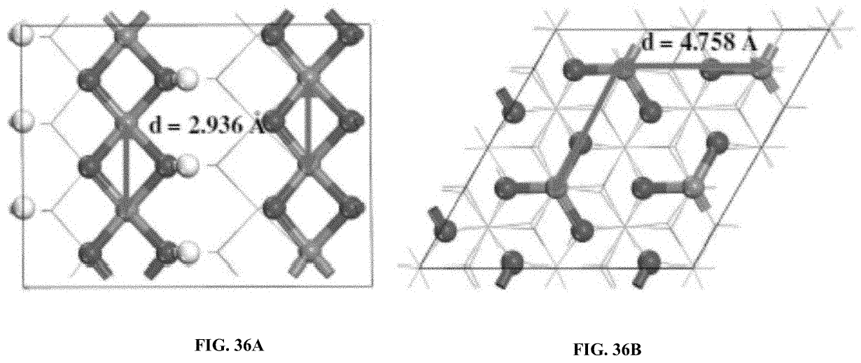

FIG. 34 shows the molecular orbitals and electron distributions of PFOA, where the highest occupied molecule orbital (HOMO) and the lowest un-occupied molecular orbital (LUMO) are found in the p orbitals of oxygen and carbon, respectively. FIG. 34 also reveals that the most electron-deficiency or electron-enrichment (i.e., the most charge density difference) is found in the carboxyl head group of PFOA. Therefore, the head group is most prone to binding with FeO/CS and/or transferring electrons to the photocatalysts. Based on the optimized PFOA-Ht (001) and PFOA-Fh (001) results (FIG. 35 and FIG. 36; Table 15), Fh shows more suitable Fe—O bond lengths for PFOA adsorption, with a distance of 2.936 Å between adjacent Fe atoms, which is much shorter than in Ht (4.758 Å). The results suggest that two oxygen atoms from COO— chelate to two Fe atoms of Fh in a binuclear bidentate mode and with a bond distance (d_{O—Fe}) of 1.955 and 2.160 Å (FIG. 36); in contrast, only one oxygen atom from COO— of PFOA may chelate to Fe of Ht (d_{O—Fe}=1.999 Å). Moreover, the relative adsorption energy for PFOA-Fh and PFOA-Ht was −1.81 and −1.28 eV, respectively. Without being bound by any theory, these results suggest that while adsorption of PFOA on both forms of iron oxides is spontaneous and thermodynamically stable, adsorption by Fh is more favorable.

TABLE 15
Optimization of the structure of PFOA
adsorbed on ferrihydrite and hematite.

| | | Ferrihydrite-PFOA | Hematite-PFOA |
|---|---|---|---|
| Adsorption energy (eV) | | −1.81 | −1.28 |
| Adsorption model | | BB | MM |
| Fe—O | Bond length (Å) | 1.955 | 1.999 |
| | | 2.160 | \ |
| | Bond angle (°) | 123.5 | 119.04 |
| | | 122.9 | \ |
| Hydrogen | Bond length (Å) | \ | 1.576 |
| bond | Bond angle (°) | \ | 156.8 |

BB: binuclear bidentate;
MM: mononuclear monodentate

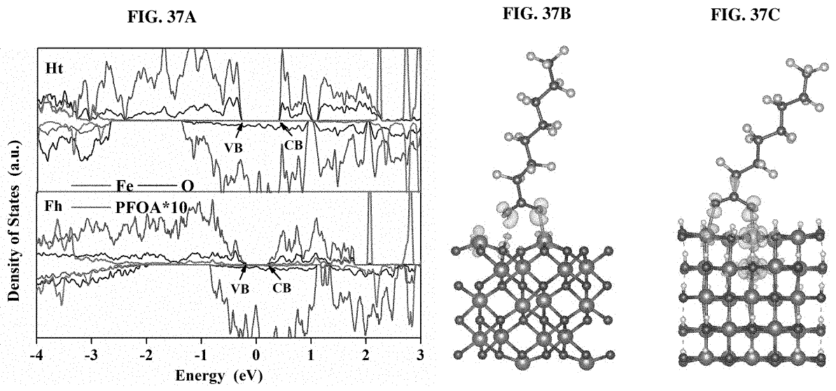

Furthermore, we hypothesized that the different PFOA adsorption modes and energies may lead to different electron transfer processes for Fh and Ht. To test this hypothesis, the density of states (DOS) was calculated to analyze the electron interactions between PFOA and iron oxide surface. As shown in FIG. 37A, upon PFOA adsorption, the surface is spin-paired with the asymmetric majority states of Fe atoms and the minority states of O atoms, which is attributed to the binding of PFOA with Fe atoms on the surface. Table 16 compares the energy levels of the HOMO and LUMO of PFOA on Fh and Ht with those of the valence band (VB) and conduction band (CB) of Fh and Ht. The smaller energy gap between the HOMO and VB or LUMO and CB for Fh predicts a more favorable electron transfer from PFOA to Fh than Ht, accounting for the observed much higher photocatalytic activity of Fh over Ht.

The charge density difference in conjunction with the Bader charge were further studied to trace down the electron transfer behaviors (FIG. 37B, 37C). Under solar light irradiation, the adsorbed PFOA on the Fh surface obtains excess electrons. These electrons are delocalized around the neighboring Fe atoms, and accumulated mainly at the nearest Fe atoms or those bonded with the PFOA. According to the calculated electron transfer in the Bader charge (Table 17), about 0.47 e could transfer from PFOA to Fe atoms on the surface of Fh, while only 0.35 e to Fe atoms on the surface of Ht, which further confirms the greater photocatalytic activity of Fh in FeO/CS over neat FeO for PFOA degradation.

Therefore, from the aspect of material structures, CS plays two critical roles in facilitating the enhanced adsorption and photocatalytic degradation of PFOA. First, the presence of CS facilitates multiple points adsorption of PFOA on FeO/CS, which weakens the energy demand for cleavage C—F bonds of PFOA, and second, the presence of CS results in the stable Fh structure in FeO/CS, which is more conducive to extracting electrons from PFOA under solar light irradiation

### Example 8

Analysis of Reactive Species with FeO/CS

To examine the role of .OH radical, the photodegradation kinetic experiments were carried out in the presence of ISA (10 mM) as a .OH scavenger. Electron paramagnetic resonance (EPR) was used to semi-quantitatively analyze the formation of .OH in the systems of virgin and PFOA-laden FeO/CS (1:1) under simulated solar light irradiation. EPR signals of radicals trapped by 5,5-dimethyl-1-pyrroline N-oxide (DMPO) (20 mM) were recorded at 25±1° C. on a JES FA 200 X-band spectrometer (JEOL, Japan). The settings for the EPR spectrometer were as follows: center field, 3231 G; sweep width, 50 G; microwave frequency, 9.05 GHz; modulation frequency, 100 kHz; and power, 2.00 mW.

Hydroxyl radical (.OH) is generally accepted as being ineffective in directly oxidizing PFOA. However, recent studies on PFOA degradation in photo-Fenton or homogenous Fe(III)-catalyzed photolysis systems, electrochemical and persulfate mechanochemical systems have revealed that .OH played important roles in PFOA degradation.

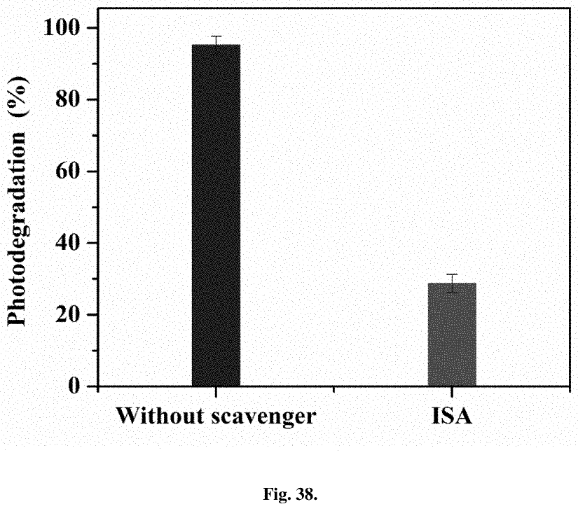

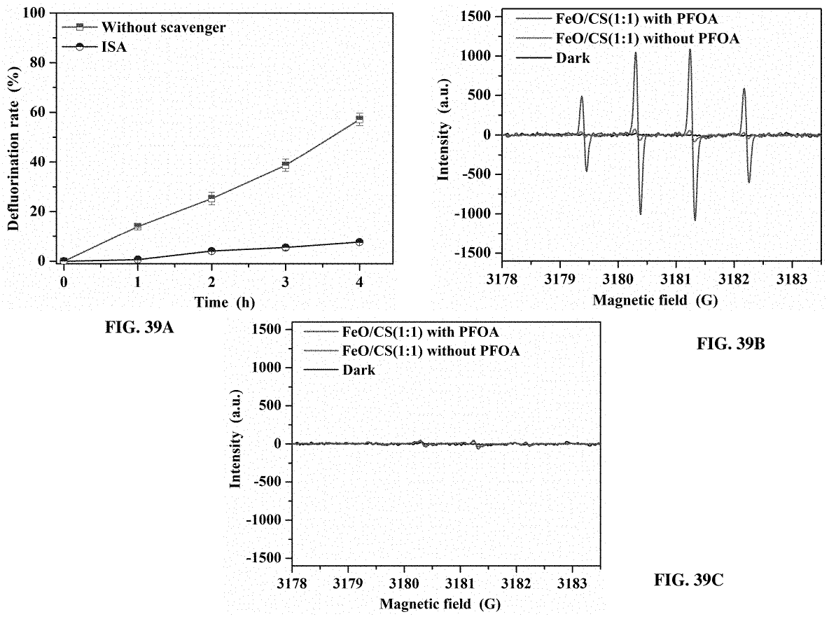

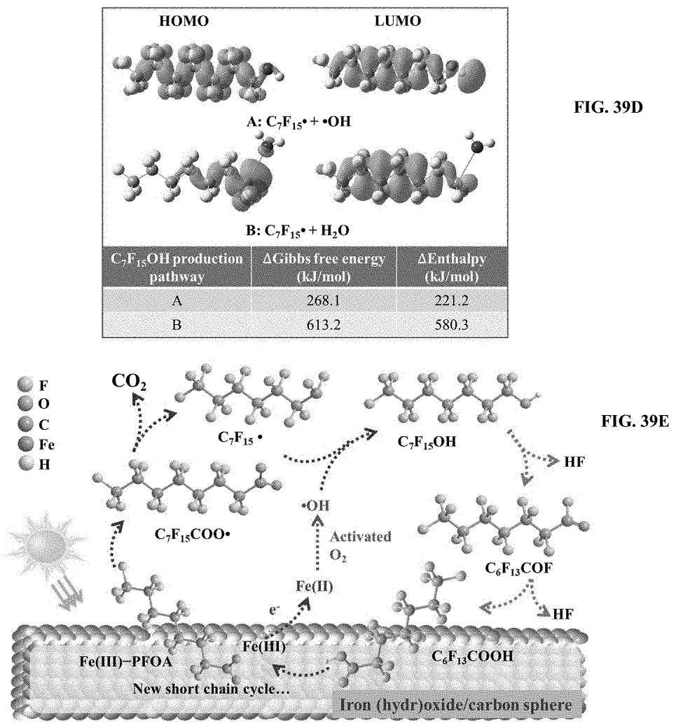

FIG. 38 compares the photodegradation extents of PFOA adsorbed on FeO/CS (1:1) after 4 h of the solar irradiation in the presence or absence of ISA, a known .OH scavenger. The presence of ISA decreased the PFOA degradation from 95.2% to 28.8%. In addition, the scavenger almost ceased defluorination of PFOA (FIG. 39A). The results indicate that .OH played an important role in the PFOA decomposition by FeO/CS.

FIGS. 39B and 39C show the EPR spectra of DMPO-.OH adducts produced by FeO/CS (1:1). When exposed to air, a weak .OH signal (four lines with an intensity ratio of 1:2:2:1) was observed in the system of FeO/CS (1:1) without PFOA; however, when PFOA was present, a much stronger .OH signal was evident, indicating that PFOA enhanced .OH generation. In contrast, under the argon condition, both systems showed weak .OH signals, indicating that O₂ is critical for .OH generation. In the FeO/CS system, there are two possible pathways to generate .OH: 1) direct photolysis of Fe(III), and 2) reaction between Fe(II) and dissolved O₂ through a sequential molecular oxygen activation pathway. Based on the EPR data, the Fe(II) induced molecular oxygen activation is believed to be the primary pathway of .OH generation.

Many researchers assert that classical photocatalytic degradation of PFOA starts with oxidative cleavage of the carboxyl group, and the resulting activated intermediate C₇F₁₅. reacts with water molecules to form the unstable perfluorinated alcohol (C₇F₁₅OH), which undergoes further decarboxylation and defluorination. However, some recent works indicated that .OH may react with C₇F₁₅. more efficiently than H₂O to form C₇F₁₅OH. To compare the thermodynamic favorability for reactions between C₇F₁₅. and .OH or H₂O, electronic structure calculations were used to obtain the corresponding frontier molecular orbitals, changes of Gibbs free energy, and change in reaction enthalpy.

FIG. 39D shows that the energy level of the HOMO for C₇F₁₅. combined with .OH was clearly lower than that for C₇F₁₅. with H₂O, leading to a narrower energy gap between HOMO-LUMO, and thus, smaller energy demand for excitation according to the frontier molecular orbital theory. Moreover, the reaction between C₇F₁₅. and .OH exhibited a much lower thermodynamic barrier of 268.1 kJ/mol and reaction enthalpy change of 221.2 kJ/mol than those (613.2 kJ/mol and 580.3 kJ/mol, respectively) with H₂O. Therefore, C₇F₁₅. is thermodynamically much more prone to reacting with .OH than H₂O.

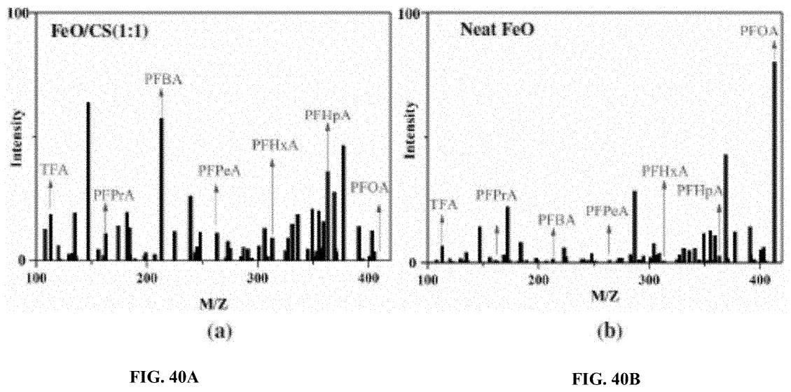

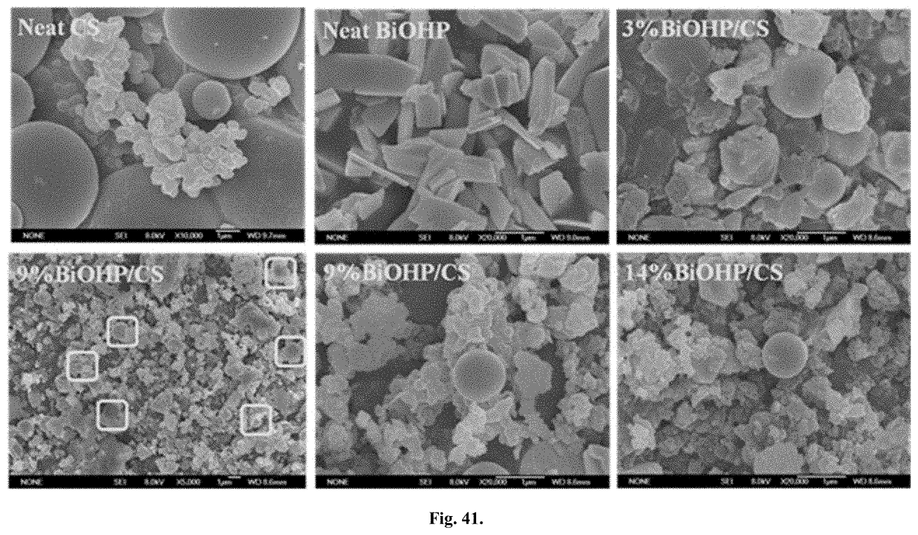

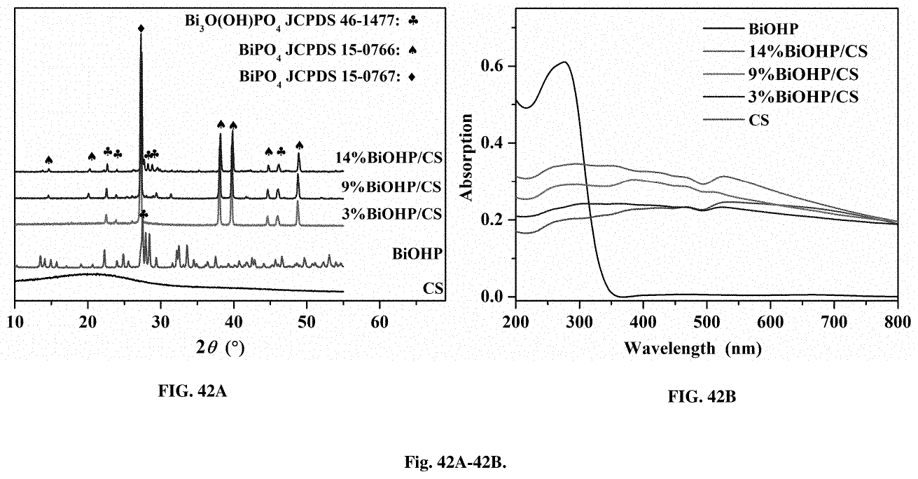

Based on the foregoing analyses and reaction by-products (FIG. 40), FIG. 39E presents the possible pathway of PFOA photodegradation in the FeO/CS system. First, PFOA is adsorbed with both head and tail attached on the photoactive sites of FeO/CS. Under solar light irradiation, the photo-excited electrons transfer from PFOA to Fe(III) to yield Fe(II) and the unstable free radical (C₇F₁₅COO.), which undergoes the Kolbe decarboxylation reaction to form C₇F₁₅. On the other hand, the resulting Fe(II) ions activate molecular oxygen to produce Fe(III) and .OH radicals, and the .OH radicals react with C₇F₁₅. to form C₇F₁₅OH. The perfluorinated alcohol undergoes defluorination with one fluorine converted into fluoride and generation of C₆F₁₃COF, which further decomposes into the shorter chain C₆F₁₃COOH with the cleavage of another fluorine. Then, the shorter-chain by-product may undergo the same cycle, each eliminating one CF₂ unit. For PFOA molecules adsorbed on CS without binding with the center Fe, direct electron transfer is likely less favored due to the molecular orientations. In this case, direct reaction with .OH radicals is likely the predominant degradation mechanism in the FeO/CS system.

### Example 9

### Synthesis and Characterization of BiOHP/CS Composite Compositions

For preparation of the exemplary composite composition BiOHP/CS, the following chemicals were purchased from Alfa Aesar, Ward Hill, Mass., USA: D-glucose (99%), Bi(NO₃)₃.5H₂O (99%), HNO₃ (68-70%), NaH₂PO₄.5H₂O (98%), ammonia (NH₃.H₂O, 25% (m/v)), isopropyl alcohol (ISA, 70%), benzoquinone (BQ, 99%), 5,5-Dimethyl-1-Pyrroline N-oxide (DMPO), and ethylenediaminetetraacetic disodium salt (EDTA, 99%).

BiOHP/CS was synthesized via a facile one-step hydrothermal method. In a typical synthesis, 0.04 mol D-glucose and 1.3, 3.9, or 6.5 mmol Bi(NO₃)₃ were dispersed in a solution consisting of 4 mL of concentrated HNO₃ and 36 mL of deionized water, and sonicated for 5 min, yielding three solutions of different Bi levels. Then, 10 mL of a NaH₂PO₄ solution containing 1.3, 3.9, or 6.5 mmol NaH₂PO₄ was added dropwise to the three solutions, respectively, giving a final Bi:P molar ratio of 1:1 in each precursor solution. The solution pH was raised to 10.0±0.1 using ammonia. Upon vigorous stirring for 2 h, the mixture was transferred into a Teflon-lined autoclave (100 mL) and allowed to react at 180° C. for 48 h. After naturally cooling to the room temperature (21±2° C.), the resulting black suspension was filtered through a 0.2 μm membrane filter and washed with deionized water until the pH of filtrate was neutral. The precipitate was then dried in an oven at 80° C. Depending on the molar percentile of Bi, i.e. Bi/(Bi+Glucose), the resulting materials were denoted as 3% BiOHP/CS, 9% BiOHP/CS and 14% BiOHP/CS, respectively. For comparison, neat BiOHP and CS were also prepared through the same approach but with only one precursor.

X-ray diffraction (XRD) patterns of the as-prepared composites were acquired using a Bruker D8 ADVANCE X-ray diffractometer, which was operated at 40 kV and 40 mA with the Cu Kα irradiation. The samples were scanned over a 20 range of 3° to 550 at a scanning speed of 2° min⁻¹. UV-vis diffuse reflectance spectra (DRS) were obtained using a Shimadzu UV-2550 double-beam digital spectrophotometer equipped with the conventional components of a reflectance spectrometer, where BaSO₄ was used as the reference. The point of zero charge (PZC) pH was determined by measuring the zeta potential as a function of solution pH on a Malvern Zetasizer Nano-ZS. To this end, a suspension containing 2.5 g L⁻¹ of BiOHP/CS was first prepared and then sonicated. The supernatant containing the stable fine particles was sampled and used to measure the zeta potential. The ionic strength was maintained using 10 mM NaCl, whereas the suspension pH was adjusted using dilute HCl (1 mM) or NaOH (1 mM). Electron paramagnetic resonance (EPR) analysis was conducted to determinate the g values and electronic properties of the materials using a Bruker EPR A300-10/12 spectrometer.

X-ray photoelectron spectroscopy (XPS) spectra were obtained on a Thermo Fisher Scientific K-Alpha spectrometer. The C1s peak from the adventitious carbon-based contaminant with a binding energy of 284.8 eV was used as the reference for calibration. Material morphological properties were analyzed using a scanning electron microscope (SEM, 6700-F, JEOL). The specific surface area was measured per the Brunauer-Emmett-Teller (BET) method on a Micromeritics ASAP 2020 M surface area analyzer. All samples were outgassed under vacuum at 180° C. for 12 h prior to N₂ adsorption measurements. The photoluminescence (PL) spectra were obtained using a Cary Eclipse 100 fluorescence spectrophotometer at an excitation wavelength of 250 nm. The functional groups were determined using a Fourier transform infrared (FTIR) spectrometer (Thermo, Nicolet iS50) with a resolution of 4 cm⁻¹ in the transmission mode through the KBr pellet technique.

To evaluate the interactions between PFOA and the material surfaces, in situ ATR-FTIR spectra were obtained using the FTIR spectrophotometer equipped with a diamond internal reflection element (IRE) (refractive index n_{diamond}=2.4, incidence angle r=42°). A thin layer of a specimen was deposited on the surface of the diamond IRE by drying ˜10 μL of a suspension containing 4 g/L of a material. The particle layer was then equilibrated with the electrolyte solution (10 mM NaCl), and then a spectrum was recorded as the background. Subsequently, the specimen was re-equilibrated with a solution containing both PFOA (100 mg/L, pH 7.0±0.1) and the background 10 mM NaCl. The use of the high concentration of PFOA was to obtain a relatively strong FTIR signal. The FTIR spectra were then collected at 25° C. and in the wavenumber range of 400-4000 cm⁻¹, with a resolution of 4 cm⁻¹ and 64 scans. The adsorption kinetics of PFOA on the material film was then obtained by recording the spectra at 10 min intervals until equilibrium, which was indicated when the subsequent spectra were no longer changing. No erosion of the neat BiOHP or BiOHP/CS film was observed at the end of each experiment.

The SEM images (FIG. 41) show that the neat CS appeared as a mixture of nearly perfect spheres and irregular-shaped flower-like aggregates, and the particle size of the spheres ranged from 100 nm to 9 μm; and neat BiOHP looked as broken fragments with well-defined boundaries. In contrast, the carbon spheres in BiOHP/CS turned much smaller (˜1 μm or less) than in neat CS, and the particle size decreased with increasing BiOHP content. In addition, the carbon spheres were attached with BiOHP in BiOHP/CS (e.g., the particles highlighted in the yellow squares in the SEM images of 9% BiOHP). More aggregates of irregularly shaped particles appeared in the BiOHP/CS composites, which are likely to be intermingled carbon-BiOHP composites (mixed phases). The results suggest that CS and BiOHP synergistically inhibited the full growth of the particles into the full spheres or BiOHP fragments, which can be attributed to steric hindrance and hindered mass transfer of the precursors. Such mutually modified mixed phases can function synergistically in adsorption and photodegradation of PFOA.

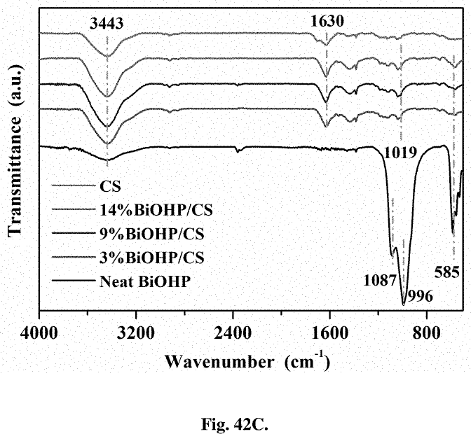

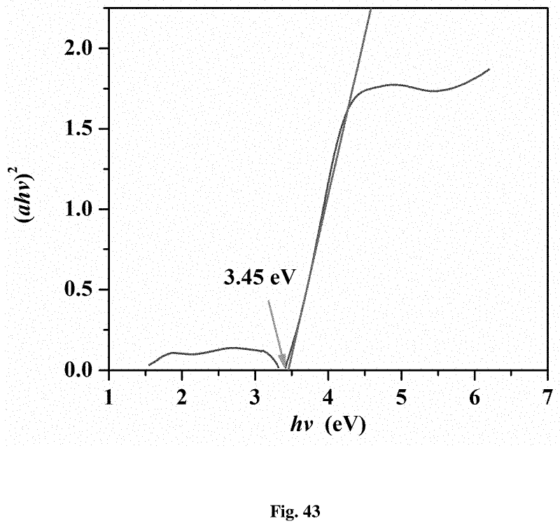

The XRD pattern of neat CS (FIG. 42A) exhibits no observable diffraction peak, indicating that the carbon spheres were amorphous. The XRD spectrum for neat BiOHP mimic that of Bi₃O(OH)(PO₄)₂ (JCPDS No. 46-1477). In contrast, the XRD patterns of BiOHP/CS manifest a mixture of the Bi₃O(OH)(PO₄)₂ phase and two other phases of BiPO₄, hexagonal (JCPDS No. 15-0766) and monoclinic (JCPDS No. 15-0767) BiPO₄. Moreover, instead of Bi₃O(OH)(PO₄)₂, BiPO₄ was the dominant phase in the BiOHP/CS composites, which again reveals that the presence of CS affected the crystal formation of BiOHP.

The UV-Vis DRS spectra (FIG. 42B) indicate that neat BiOHP exhibits excellent UV light absorption, especially at wavelength <300 nm. The Tauc plot (FIG. 43) yielded a bandgap of 3.45 eV for neat BiOHP. In contrast, neat CS shows weaker UV absorption, but is able to absorb a broad spectrum of light (200-800 nm). Notably, the BiOHP/CS composites exhibited enhanced light absorption in UV and visible lights. Moreover, the absorption intensity increased with increasing BiOHP content. The observation suggests that BiOHP/CS may act as an effective photocatalyst under UV irradiation.

FIG. 42C shows the FTIR spectra of neat CS, BiOHP, and BiOHP/CS composites. For CS, the absorption band at 1630 cm⁻¹ is the characteristic peak of C═O in carboxylic and aromatic groups. For neat BiOHP, the absorption bands at 1087 and 996 cm⁻¹ correspond to the symmetric (v₃) and asymmetric (v₁) P—O stretching vibrations, respectively. The band at 585 cm⁻¹ is due to the bending vibration of O—P—O. For BiOHP/CS, the band for the O—P—O bending vibration is the same as that of neat BiOHP, but an additional P—O stretching vibration appeared at 1019 cm⁻¹, which is consistent with the XRD data. The band at 1630 cm⁻¹ is assigned to the carbon or CS embedded in BiOHP/CS. For all cases, the peak at 3443 cm⁻¹ is due to the stretching vibration of O—H band, which is associated with the hydroxyl groups or water coordinated to the CS, BiOHP, or BiOHP/CS

### Example 10

### Adsorption of PFOA by BiOHP/CS

Batch adsorption kinetic tests were carried out with neat CS, BiOHP, or a BiOHP/CS in 45 mL high-density polyethylene (HDPE) vials. The adsorption was initiated by adding 1 g/L of a material to 40 mL a PFOA solution (5 mg/L or 200 μg/L, pH 7.0±0.1). The mixtures were kept in the dark and were shaken on a tumbler operated at 50 rpm. At predetermined times, 1 mL of aliquots was sampled and filtered through a 0.22 μm poly(ether sulfones) (PES) membrane, and the filtrate was then analyzed for PFOA. The use of 5 mg/L PFOA was to gauge the adsorption limits for the different materials, whereas 200 μg/L PFOA was used to simulate the actual waste treatment (adsorption+photodegradation) conditions. All tests were performed in duplicate and the results are presented as mean of the duplicates with errors indicating relative deviation from the mean.

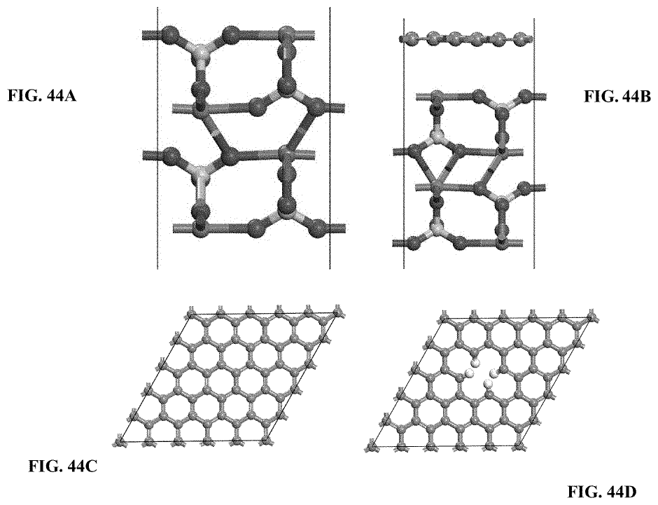

DFT-based calculations were performed to gain further insight into the underlying mechanisms for the adsorption and photocatalytic degradation of PFOA by BiOHP/CS. The first-principles computation was performed using the Vienna ab initio simulation package (VASP). The projector augmented wave (PAW) based potentials were used to describe nuclei-electron interactions. The generalized gradient approximation (GGA) within the Perdew-Burke-Ernzerh (PBE) of exchange-correlation function was employed. The BiPO₄ (001) was used to simulate BiOHP (FIG. 44A), where the material surface was modeled by a three-layer 2×6 unit cell, whereas CS was simulated by a model graphene layer (FIG. 44C). FIG. 44B shows the DFT optimized structure of BiOHP/CS.

The wave functions at each k-point were expanded with a plane wave basis set, and the kinetic cutoff energy was set to 450 eV. The k-point sets of 7×5×7, 9×9×3 and 1×1×1 were used for BiPO₄, CS, and PFOA, respectively. The BiPO₄ (001) surface was modeled using a (1×1) supercell with a thickness of 8 atomic layers, and the CS surface was modeled using a (5×5) supercell (FIG. 44C), defective CS model (FIG. 44D) by removing the lattice carbon atoms between two interstitial voids, with the vacuum thickness being larger than 20 Å in the (001) direction. During the geometrical optimization, the energy and force converged to 10⁻⁵ eV per atom and 0.02 eV Å⁻¹, respectively. In the DOS calculation, the k-points were increased to 5×3×1 for the BiPO₄ (001) surface. A grid of 3×3×1 Monkhorst-Pack mesh k-points was used to perform the integration in the Brillouin zone. The interaction energy of adsorbed PFOA on the CS surface was calculated via the equation ΔE=E(PFOA/CS)−E(CS)−E(PFOA), wherein E refers to the respective electronic energies.

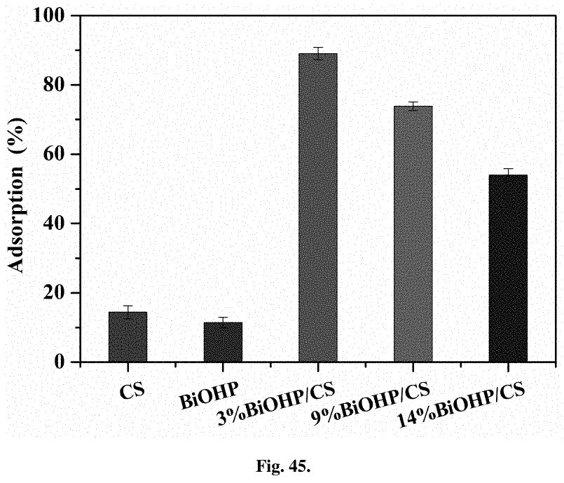

FIG. 45 compares the equilibrium uptake of PFOA by neat CS, BiOHP, and BiOHP/CS after 2 h of batch adsorption experiments. Both neat CS and BiOHP showed poor adsorption for PFOA, with only 14% and 10% of the initial 5 mg/L PFOA adsorbed, respectively. In contrast, the BiOHP/CS composites showed much enhanced PFOA adsorption efficiency (50%-90% removal). This observation clearly demonstrates the synergistic effect of CS and BiOHP when they were hydrothermally blended. The synergistic modification enabled multitude adsorption mechanisms, resulting in the enhanced adsorption capacity. For the three composites, the adsorption increased with decreasing BiOHP content, and 3% BiOHP/CS exhibited the highest PFOA adsorption efficiency (˜90%).

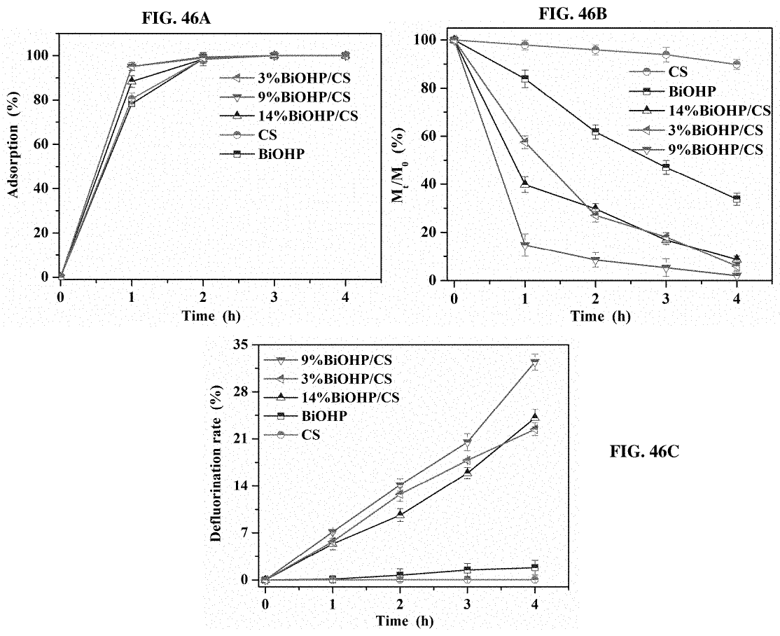

When the initial concentration of PFOA was lowered to 200 μg/L, all materials were able to remove nearly all the PFOA (99.5%) at equilibrium (within 2 h) (FIG. 46A).

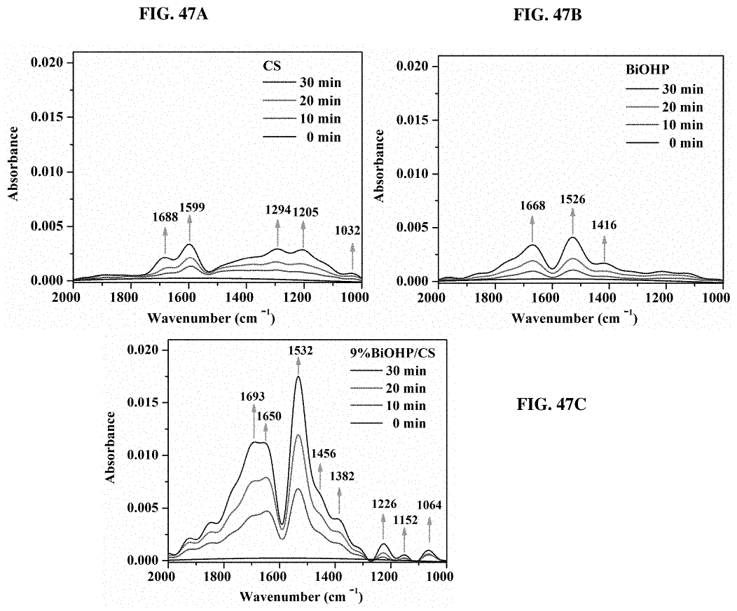

In situ ATR-FTIR spectra were acquired to identify the binding modes of PFOA on neat CS, BiOHP, and 9% BiOHP/CS. For neat CS (FIG. 47A), the vibrational modes at 1294 cm⁻¹, 1205 cm⁻¹, 1688 cm⁻¹, and 1589 cm⁻¹ were assigned to [νₐₓ(CF₂)], [νₐₛ(CF₂)+νₐₛ(CF₃)], [ν(C═O)], and [νₐₛ(COO—)], respectively. The results show that the adsorption of PFOA by neat CS involves the tail CF₃ terminal group, the intermediate CF₂ group, and the head carboxyl group, namely, a PFOA molecule is attached in parallel to the CS surface (side-on). In contrast, the spectra of PFOA-laden BiOHP (FIG. 47B) show only the stretching bands of the COO— group, but no vibrational mode of the C—F group, which indicates that the adsorption of PFOA on BiOHP was through the COO— group, i.e., in the head-on orientation.

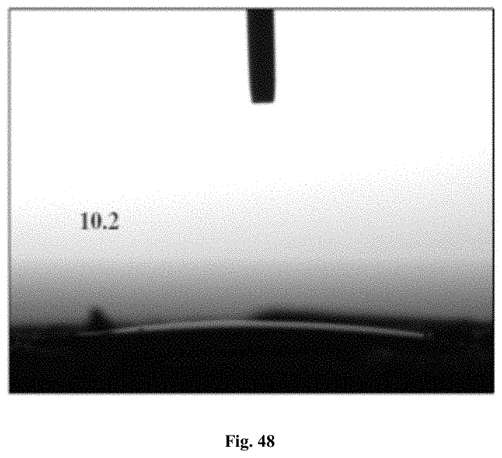

Because of the negative surface potential (pH_{PZC}=1.9, Table 18) and hydrophilic surface (water contact angle was 10.2°, FIG. 48) of neat CS, electrostatic attraction and hydrophobic interaction are not responsible for the update of PFOA by neat CS at the experimental pH (7.0). Instead, two weaker interactions are likely operative: 1) anion-π or π-CF interactions between the electron-deficient aromatic skeletons of CS and the CF groups of PFOA, and 2) hydrogen bonding between the PFOA's COO— and coordinated OH groups on the surface of CS. The pH_{PZC} for BiOHP was determined to be 6.9 (Table 18). As such, no strong electrostatic interactions would be expected between the BiOHP surface and the negatively charged COO— groups at neutral pH.

TABLE 18
The pH of point zero charge and specific surface area of neat CS,
neat BiOHP, and BiOHP/CS prepared at various BiOHP contents.

| | | 3% | 9% | 14% | |
|---|---|---|---|---|---|
| | CS | BiOHP/CS | BiOHP/CS | BiOHP/CS | BiOHP |
| pH at point | 1.9 | 8.8 | 8.2 | 7.9 | 6.9 |
| zero charge | | | | | |
| specific | 65.4 | 47.3 | 34.1 | 29.8 | 2.4 |
| surface | | | | | |
| area (m²/g) | | | | | |

Due to the presence of abundant surface OH group on neat BiOHP, the adsorption of PFOA may occur through ligand exchange by replacing the OH groups with the hydrophilic COO— groups. As expected, the spectra (FIG. 47C) of PFOA-laden 9% BiOHP/CS indicated that both C—F and COO— groups were involved in the adsorption of PFOA. Moreover, the intensities of the CF and COO— bands in PFOA-laden 9% BiOHP/CS were higher than those of PFOA-laden CS or BiOHP alone, which is in accord with the much higher PFOA adsorption capacity of 9% BiOHP/CS compared with either CS or BiOHP alone (FIG. 45). This enhanced adsorption of PFOA by BiOHP/CS is attributed to the synergistic interactions between the C₇F₁₅COO— and BiOHP and between the CF groups of PFOA and CS, which mainly occurs in mixed and mutually modified CS—BiOHP hetero-structures. Such an adsorption mode is conducive to the subsequent photocatalytic degradation of the pre-loaded PFOA. Because of the much elevated pH_{PZC} for BiOHP/CS (7.9-8.8, Table 18), the adsorption of PFOA by the composite is much more favorable than by either of the individual component materials.

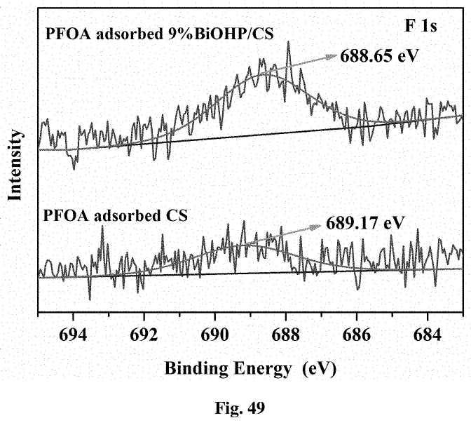

XPS analysis was carried out to further investigate that PFOA adsorption behavior by BiOHP/CS. FIG. 49 shows the XPS spectra of F is for PFOA-laden neat CS and 9% BiOHP/CS. While the peak of F appeared in both of the systems, the binding energy differed, namely, 689.17 eV and 688.65 eV for neat CS and 9% BiOHP/CS, respectively. The difference confirms the enhanced synergistic adsorption modes for BiOHP/CS compared to the plain CS.

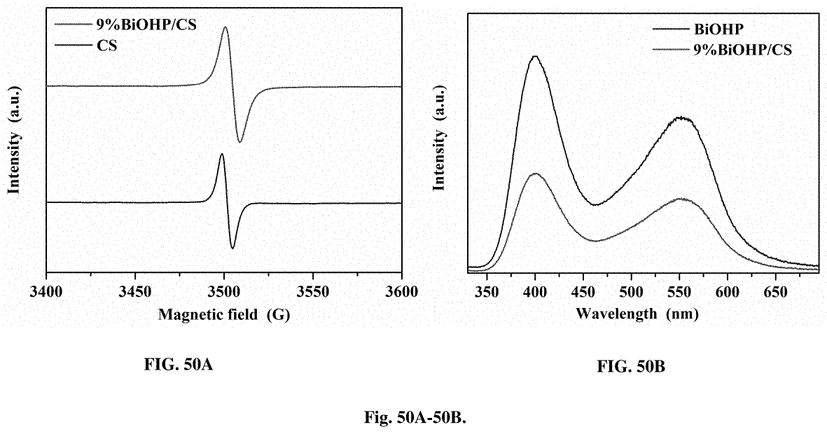

DFT-calculations were performed to gain further insight into the adsorption mechanisms of PFOA on CS. Taking into account that the existence of defect sites would affect the adsorption behavior, a defective CS model was also introduced into the DFT study by removing the lattice carbon atoms between two interstitial voids of graphene. The EPR spectra in FIG. 50A show that both neat CS and BiOHP/CS gave rise to strong EPR signals located at the g value of 2.003, indicating carbon vacancies were created in both neat CS and BiOHP/CS. The stronger signals for BiOHP/CS imply more carbon defects in the composite material.

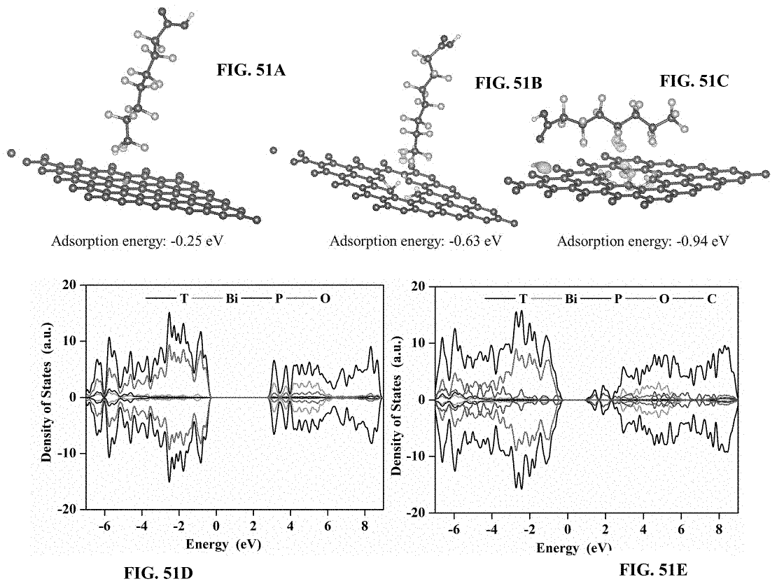

FIGS. 51A-51E presents the optimized adsorption modes and charge density difference of PFOA on virgin CS and defective CS with end-on configuration or side-on configuration. The tail-on adsorption energy of PFOA on CS was calculated to be −0.25 eV (FIG. 51A), which indicates that the adsorption of PFOA on CS surface through the π-CF interaction is thermodynamically favorable. In the presence of the carbon defects, however, the adsorption energy for the same tail-on configuration turned more negative (−0.63 eV) (FIG. 51B), indicating that the defective sites are much more favorable for PFOA adsorption. Furthermore, when the end-on and side-on adsorption configurations are compared, the latter is even more favorable with an adsorption energy of −0.94 eV (FIG. 51C). The results confirm that PFOA is prone to adsorption on the defective CS sites in the side-on mode, which is in accord with the ATR-FTIR results.

FIG. 51A-51C show the local charge density distributions as a result of the π-CF interactions. Evidently, the different binding modes resulted in very different charge distributions, with the most electron transfer observed for the side-on adsorption mode. The elevated electron density toward the fluorine atom in the C—F bond tends to induce activation of PFOA, facilitating the photocatalytic cleavage of the C—F bond (i.e., defluorination). Taken together, the enhanced PFOA adsorption by BiOHP/CS is attributed to the composite-rendered synergistc interactions, including ligand exchange, π-CF interaction, electrostatic interactions, and hydrogen bonding between PFOA and the intermixed BiOHP—CS phases with more defect CS sites.

### Example 11

### Photodegradation of PFOA by BiOHP/CS

Photodegradation experiments were performed following the PFOA adsorption (200 μg/L, pH 7.0±0.1), which transferred nearly all the PFOA from the solution onto the material surface. The PFOA-laden composite materials were separated from the solution by gravity, and then, 35 mL (or 87.5%) of the supernatant was pipetted out. The residual solid-liquid mixture was transferred into a quartz container with a quartz cover, which was then placed in a Rayonet photochemical reactor (Model RPR 100) with UV light irradiation (18 W low-pressure Hg lamp, 254 nm, 21 mW/cm²). At predetermined times (1, 2, 3, 4 h), 2 mL of the supernatant was sampled and filtered through a 0.22 m membrane filter, and the filtrate was analyzed for fluoride (F⁻); in addition, 3 mL of the solid-liquid mixture was sampled and extracted using 20 mL of methanol at 80° C. for 8 h to determine remaining PFOA in the solid phase. The extraction was repeated one more time upon gravity separation of the particles. Control tests indicated that the two consecutive extractions were able to recover >95% of adsorbed PFOA. To gauge the material reusability, 9% BiOHP/CS was repeatedly subjected to the same adsorption/photodegradation cycle for four consecutive times.

For terminological clarity, the term “degradation” in this work refers to decomposition or transformation of PFOA into other compounds (by-products or final products), whereas “defluorination” indicates complete cleavage of the C—F bond or conversion of fluorine into fluoride.

The effective adsorption concentrated PFOA from a large volume of water onto a small volume of BiOHP/CS, allowing for much more efficient photocatalytic degradation of PFOA than irradiating the bulk water. FIGS. 46B and 46C show that neat CS offered limited photocatalytic activity towards PFOA, with <10% of pre-adsorbed PFOA degraded and zero defluorination after the 4 h UV irradiation. While neat BiOHP was able to degrade ˜66.2% of PFOA, it defluorinated only 1.8% after 4 h reaction. In contrast, all the three BiOHP/CS composites were able to degrade >90% of PFOA after 4 h, and convert >20% of fluorine into F⁻. 9% BiOHP/CS showed the highest photocatalytic activity, with ˜90% PFOA photodegraded in 1 h and 32.5% defluorinated after 4 h reaction. The observation clearly unveils the synergistic effects of CS and BiOHP in the composites.

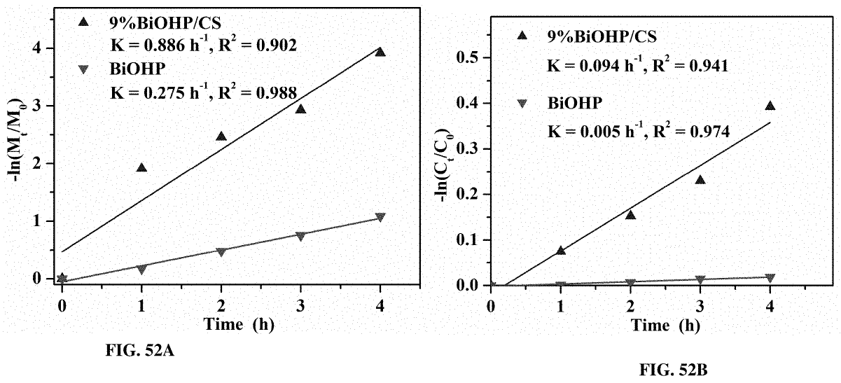

The pseudo first-order rate constant for degradation of PFOA water at pH 4.0 by neat BiOHP is believed to be ˜15 times greater than that of BiPO₄. In the instant example, the pseudo-first-order PFOA degradation and defluorination rate constants for 9% BiOHP/CS (with BiPO₄ being the primary phase) were ˜3 and ˜18 times higher than that for neat BiOHP (FIG. 52A-52B), indicating that the carbon modification greatly enhanced the photocatalytic activity, especially the mineralization activity of BiOHP.

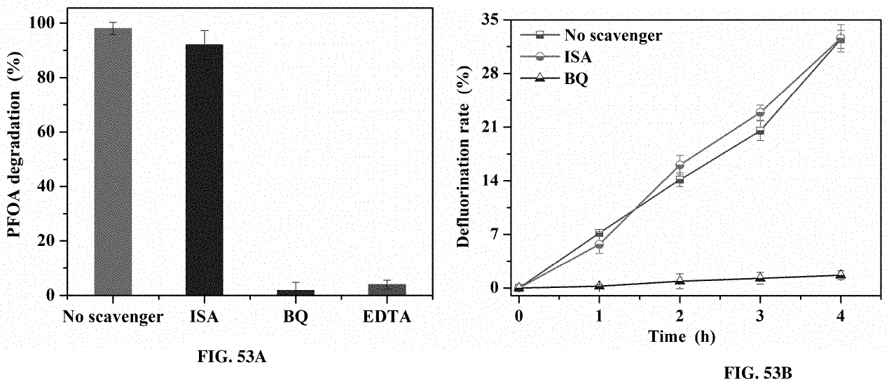

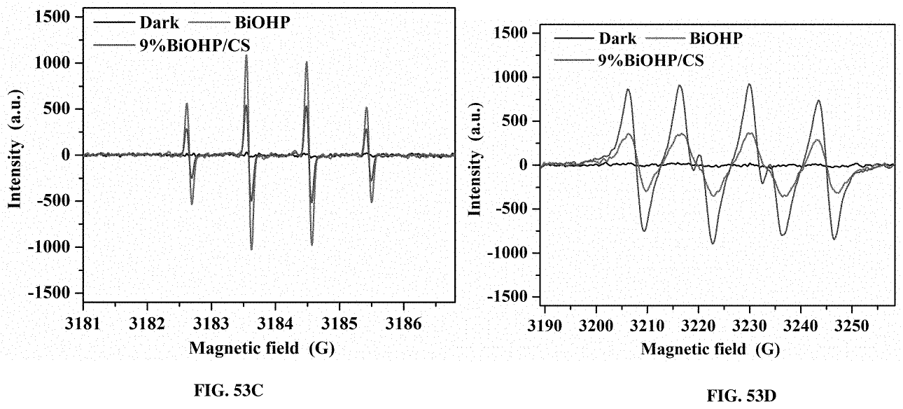

FIGS. 53A and 53B show PFOA degradation and defluorination rates in the presence of various radical scavengers to probe the role of .OH, h⁺ and O₂.⁻ in PFOA degradation by 9% BiOHP/CS. The presence of ISA (scavenger for .OH) did not significantly affect both the 4-h photodegradation and the defluorination rates, indicating that .OH radicals were not the major reactive species in the degradation/defluorination of PFOA. In contrast, the presence of the h⁺ scavenger (EDTA) or O₂.⁻ radical scavenger (BQ) nearly ceased the photocatalytic degradation/defluorination of PFOA. Therefore, the photo-generated holes and O₂.⁻ radicals played roles in the degradation/defluorination of PFOA in the 9% BiOHP/CS system.

FIG. 53C compares the EPR spectra of DMPO-.OH adducts generated in the neat BiOHP and 9% BiOHP/CS systems after 20 min UV irradiation. While the characteristic four-line spectra of DMPO-.OH adducts at the intensity ratio of nearly 1:2:2:1 were observed in both systems, the peak intensities in 9% BiOHP/CS system were much lower than in the neat BiOHP system. This observation indicates that the holes in the valence band of plain BiOHP were more reactive with surface-bound water or hydroxyl ions (OH⁻) and generated more .OH radicals. In contrast, the characteristic relative intensities of 1:1:1:1 four-line peaks of DMPO-O₂.⁻ adducts (FIG. 53D) reveal that the intensity of O₂.⁻ generated in the BiOHP/CS system was much higher than in the neat BiOHP system. This sheer difference indicates a role of the carbon modification, which not only induced cooperative adsorption mechanisms, but also facilitates separation of the hole-electron pairs by accepting electrons in the conduction band of BiOHP. As a result, more holes are available to oxidize the adsorbed PFOA. Moreover, the enriched electrons react with dissolved O₂, generating the O₂.⁻ radicals.

The corporative adsorption and side-on molecular orientation of PFOA on BiOHP/CS facilitate photocatalytic degradation of PFOA in a number of ways. FIG. 50B shows the PL emission spectra for neat BiOHP and 9% BiOHP/CS under UV 254 nm irradiation. It is evident that the peak intensity for the composite material is much lower than that for neat BiOHP, which implies that the carbon modification of BiOHP greatly inhibited the recombination of the photo-generated electron-hole pairs in the composite material. That is, the presence of CS could promote the separation efficiency of photo-generated charge carriers of BiOHP, resulting in more efficient utilization of the holes and/or electrons towards the target PFOA molecules as shown in FIGS. 46B and 46C.

The density of states (DOS) was calculated to study the electronic structures of BiOHP and BiOHP/CS. As illustrated in FIG. 51D, the neat BiOHP surfaces were spin-paired with the symmetric majority and minority states of Bi and O atoms, and the valence and conduction states were mainly derived from the O 2p orbitals (the Highest Occupied Molecular Orbital (HOMO)) and the Bi 3d orbitals (the Lowest Unoccupied Molecular Orbital (LUMO)), respectively. However, when CS and BiOHP are interblended and mutually modified, the conduction state of BiOHP/CS was mainly derived from the C 2p orbitals, with much narrowed bandgap (FIG. 51E), namely, the presence of CS lowers the energy required for electron transition. During the photocatalytic process, CS tends to attract electrons and repel holes, which facilitates the electron-hole pairs separation. Meanwhile, the attracted electrons in the conduction band of BiOHP/CS enhances the reduction of the adsorbed PFOA on the CS surface.

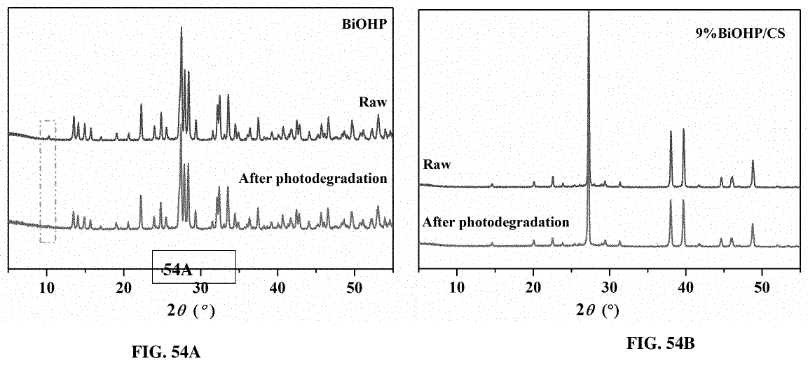

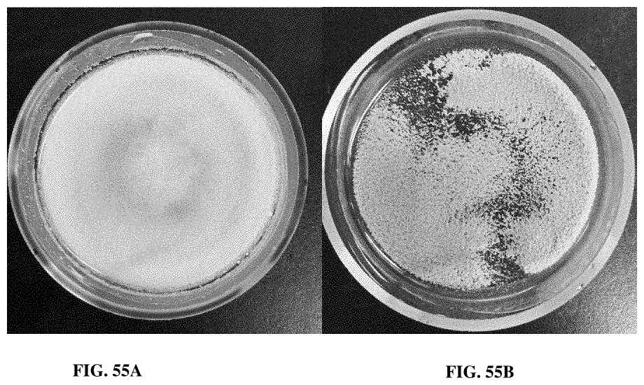

To gauge the material stability, XRD spectra were obtained for neat BiOHP and BiOHP/CS before and after the 4 h photocatalytic degradation reaction. FIG. 54A shows that the characteristic peak of bismuth oxy-hydroxy-phosphate at 10 almost disappeared for neat BiOHP upon the UV irradiation, implying occurrence of photochemical corrosion. The color of neat BiOHP turned from white to gray after the reaction (FIG. 55A-55B), suggesting that the UV irradiation damaged the BiOHP structure. Researchers have attributed the low stability of neat BiOHP to photo-mediated dissolution of phosphate ions. In contrast, the XRD patterns of 9% BiOHP/CS remained unchanged after the photoreaction (FIG. 54), indicating that the CS modification was able to inhibit the photo-corrosion of BiOHP.

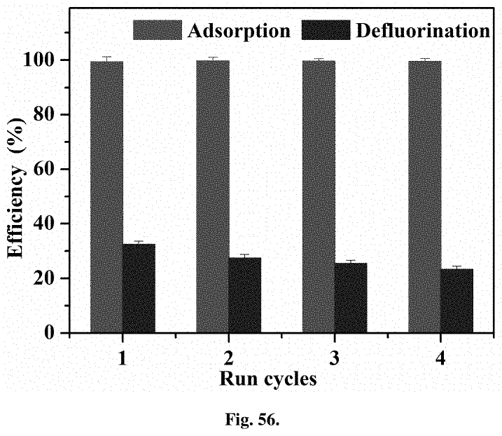

To test the reusability of the composite compositions, the same 9% BiOHP/CS was repeatedly used in four consecutive cycles of adsorption-photodegradation of PFOA without any other regeneration or treatment. FIG. 56 shows that the composite (1.0 g/L) was still able nearly completely adsorb the PFOA (200 μg/L) after four runs. In terms of photocatalytic activity, the 4 h defluorination of PFOA decreased from 32.5% for the fresh material to 23.2% after the four cycles. The decreased defluorination could be due to the presence of intermediates produced in the previous cycles, which consumed some of the reactive species.

### Example 12

Analysis of Reactive Species with BiOHP/CS

To understand the roles of free radicals and photo-generated holes in the photocatalytic process, the photo-defluorination kinetic experiments were also carried out in the presence of 10 mM of a scavenger. In the instant example, ISA was evaluated for hydroxyl radicals (.OH), BQ for superoxide radicals (O₂.⁻), and EDTA for the photo-generated holes (h⁺).

In addition, the formation of .OH and O₂.⁻ in the systems of neat BiOHP and 9% BiOHP/CS were also analyzed using a JEOL X-band EPR spectrometer (JES-FA200) under UV light irradiation. The EPR signals of radicals trapped by DMPO (20 mM) were obtained at 25±1° C., and EPR spectra were recorded with the 3231 G center field, 50 G sweep width, 9.05 GHz microwave frequency, 100 kHz modulation frequency, and 2.00 mW power.

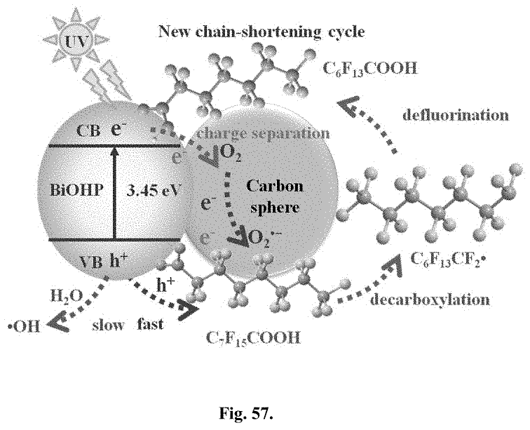

Based on the experimental results and theoretical calculations, FIG. 57 presents the proposed mechanism of PFOA degradation by BiOHP/CS under UV irradiation. First, PFOA is adsorbed on BiOHP/CS in the side-on mode, then the adsorbed PFOA on BiOHP/CS undergoes decarboxylation by holes and superoxide radicals via photo-Kloble reaction to yield the activated C₇F₁₅. Subsequently, C₇F₁₅. is reacts with H₂O to generate C₇F₁₅OH, which is quickly converted to C₇F₁₃COF through eliminating a HF entity, and then the unstable C₇F₁₃COF hydrolyzes to a shorter chain intermediate C₆F₁₃COOH by losing another F. The C₆F₁₃COOH undergoes another chain-shortening cycle, each losing one CF₂ unit until completely mineralized to CO₂ and fluoride ion or formation of smaller fluorinated byproducts.

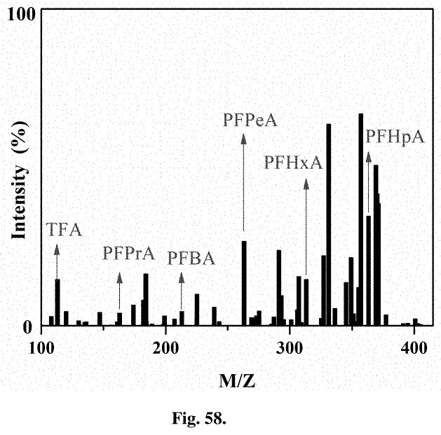

FIG. 58 presents some sample PFOA degradation byproducts by 9% BiOHP/CS. After the 4 h UV irradiation, six major intermediates of shorter-chain (C2-C7) perfluorinated carboxylic acids were detected, including C₆F₁₃COOH (PFHpA), C₅F₁₁COOH (PFHxA), C₄F₉COOH (PFPeA), C₃F₇COOH (PFBA), C₂F₅COOH (PFPrA) and CF₃COOH (TFA).

Mechanistically, BiOHP degrades organic chemicals through reactive species such as O₂.⁻ generated at the conductance band and .OH at the valence band. However, without the carbon modification, neat BiOHP exhibited very limited ability to defluorinate PFOA, which could be due to fast recombination of e⁻-h⁺ pairs, and the competition of water molecules for the photo-generated h⁺. For BiOHP/CS, the carbon-mediated side-on adsorption configuration renders more favorable direct hole-mediated decarboxylation of PFOA. Moreover, the carbon modification inhibits the e⁻-h⁺ recombination by transferring e⁻ from the valence band of BiOHP, which frees up more holes, promoting the direct hole-oxidation of PFOA. Based on the DFT calculations, it is also possible for the carbon-transferred electrons to reductively defluorinate PFOA.

### Example 13

### Synthesis and Characterization of Ga/TNTs@AC Composite Compositions

For preparation of the exemplary composite composition Ga/TNTs@AC, PFOS was purchased from Matrix Scientific (Columbia, S.C., USA). A 10 mg L⁻¹ of PFOS stock solution of was prepared and stored at 4° C. Gallium (III) chloride anhydrous (GaCl₃) was purchased from VWR International (Radnor, Pa., USA). Other chemicals were identical to those in Example 1.

Ga/TNTs@AC was prepared following similar procedure as for Fe/TNTs@AC described in Example 1. In brief, 1 g of the dried TNTs@AC was dispersed in 100 mL of DI water, and then 4 mL of a GaCl₃ solution (5 g L⁻¹ as Ga, pH=3.5) was dropwise added into TNTs@AC suspension. Adjust the pH to 7.0 and allow for 3 h adsorption, which was enough to reach equilibrium. The solid particles were separated via centrifugation, and then dried in an oven at 105° C. for 24 h. The resulting particulates were further calcined at 550° C. for 3 h under a nitrogen flow of 100 mL min⁻¹. The resulting Ga/TNTs@AC contained 2 wt. % of Ga. For comparison, Ga/TNTs@AC was prepared at different Ga contents (1, 2, 3, and 5 wt. %). Based on the subsequent adsorption/photodegradation results, Ga/TNTs@AC with 2 wt. % of Ga showed best adsorption rate and photodegradation activity for PFOS, and thus, was further evaluated.

Ga₂O₃ is known to be an excellent photocatalyst with a wide band gap (˜4.8 eV), and it can adsorb UV light efficiently to generate hole-electron pairs. Researchers have shown that the addition of Ga could enhance the photocatalytic activity of TiO₂ towards water cleavage and organic pollution degradation. Here, we hypothesized that Ga doping can act as an excellent electron conductor to prevent the electron-hole recombination TNTs@AC, thus facilitating the direct photocatalytic reactions between electrons/holes and PFOS molecules to achieve higher photodegradation efficiency. In this part of work, PFOS was used as the target PFAS, and preliminary batch adsorption and photodegradation of PFOS were analyzed.

### Example 14

### Adsorption and Photodegradation of PFOS by Ga/TNTs@AC

Adsorption and photodegradation of PFOS by Ga/TNTs@AC were tested following the same procedures for Fe/TNTs@AC as described Examples 3 and 4.

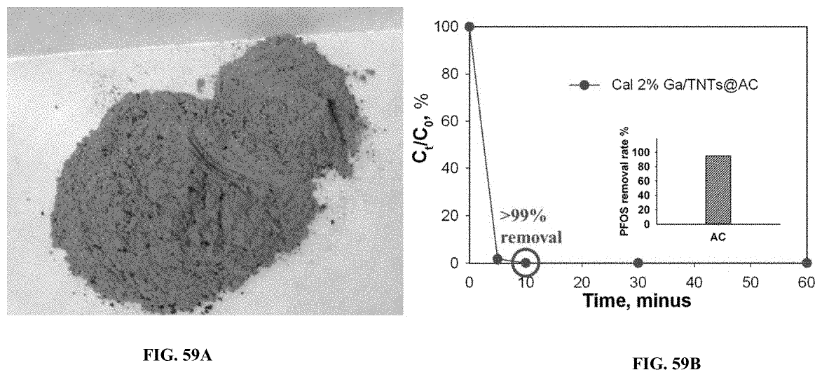

FIG. 59A shows the as-prepared powder Ga/TNTs@AC, whose size, shape and morphology resemble those of Fe/TNTs@AC. FIG. 59B shows that Ga/TNTs@AC was able to rapidly and nearly completely (>99%) remove PFOS from water within 10 min. In comparison, neat AC adsorbed only 95% of PFOS after 4 h, indicating much improved adsorption performance of Ga/TNTs@AC over the parent AC. Like Fe/TNTs@AC, the fast adsorption kinetics by Ga/TNTs@AC can be attributed to: 1) the concurrent hydrophobic interactions between AC surface and PFOS tail, and 2) the concurrent electrostatic and Lewis acid-base interactions between the Ga₂O₃ nanoparticles and PFOS's head group (pH of pH_{PZC} of Ga₂O₃=9.0).

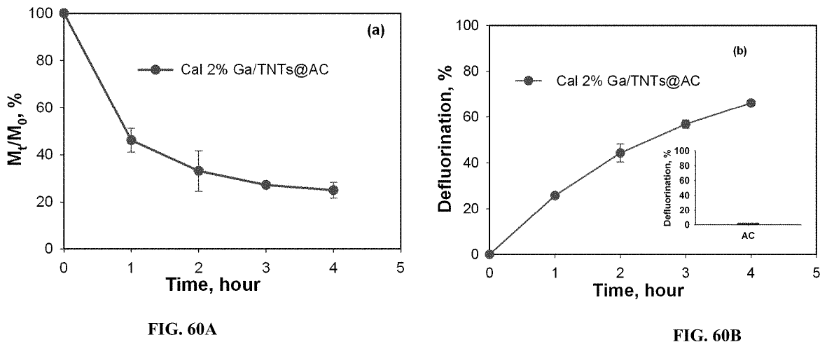

FIG. 60A shows that ˜75% of PFOS was photodegraded by Ga/TNTs@AC in 4 h under the UV irradiation. Moreover, Ga/TNTs@AC was able to achieve >66% of defluorination (FIG. 60B). In contrast, negligible PFOS (<3%) was defluoriated by neat AC after 4 h under the identical UV irradiation conditions, indicating the much enhanced photocatalytic activity of Ga/TNTs@AC. While the mechanisms for the enhanced adsorption and photocatalytic degradation of PFOS are expected to resemble those for Fe/TNTs@AC, the stronger redox potential generated by Ga₂O₃ may enhance the direct hole-facilitated oxidation pathway.

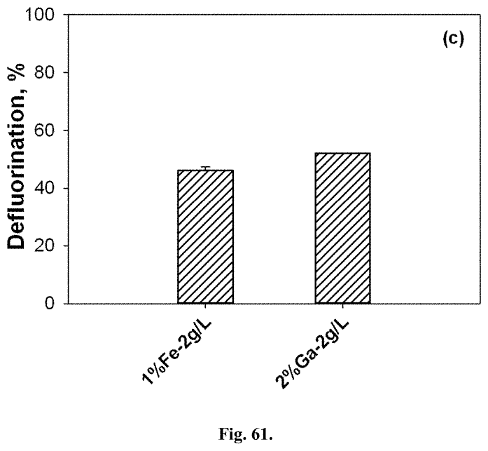

FIG. 61 compares the defluorination effectiveness of PFOS by Fe/TNTs@AC and Ga/TNTs@AC at the same dosage of 2 g L⁻¹. After 4 h UV irradiation, Ga/TNTs@AC defluorinated 56% of the PFOS, while Fe/TNTs@AC mineralized 46%.

In addition to the greater redox potential induced by the gallium oxide, the smaller ionic radius of Ga³⁺ (0.62 Å) than that of Fe³⁺ (0.79 Å) may also play a role in the more effective photodegradation of PFOS by Ga/TNTs@AC. The difference in ionic radius between Ga³⁺ and Ti⁴⁺ (0.645 Å) is less than that between Fe³⁺ and Ti⁴⁺. As a result, Ga³⁺ is much easier to replace Ti⁴⁺ ions due to their similarities in ionic radii, resulting in more oxygen vacancies. In addition, the calcination of Ga/TNTs@AC in nitrogen atmosphere may result in increased oxygen vacancies and oxygen ionic conductivity. Therefore, Ga₂O₃ is able to absorb UV light more efficiently, generating more hole-electron pairs. Moreover, Ga₂O₃ can strongly coordinate with PFOS in the bidentate or bridging mode, which is beneficial for the photocatalytic decomposition under UV irradiation. In addition, the Ga-doping eliminates the deep trap states that act as recombination centers.

### Example 15

### Soil Treatment Applications of Composite Compositions

Soil samples were air-dried and sieved through the standard sieve of 2 mm openings, and then homogenized through thorough mixing. For each analysis or experimental uses, at least three subsamples will be taken from different parts of the primary samples. Dispersants Corexit EC9500A was acquired per the courtesy of Nalco Company (Naperville, Ill., USA) and SPC1000 was purchased from Polychemical Corporation (Chestnut Ridge, N.Y., USA). Both dispersants were used as received upon proper dilution. A 500-mg Superclean Envi-18 SPE cartridge was purchased from Sigma-Aldrich (St. Louis, Mo., USA) to extract PFAS from various eluents.

The soil sample was extracted following the sequential extraction of acidified sediment/soil using methanol at 60° C. and under sonication. Briefly, a 500 μL aliquot of the 200 ng mL⁻¹ isotopically labeled surrogate (i.e., M8PFOA or M8PFOS) for the target analytes was spiked in 1 g of the homogenized soil sample (surrogate concentration=100 ng g⁻¹) and vigorously mixed on a horizontal shaker for 4 h before the extraction. Then, the sample was extracted first by adding 10 mL of a 1% acetic acid solution into a 50-mL HDPE vial, which was then treated under sonication at 60° C. in a water batch for 15 min, and then the supernatant was separated per centrifugation at 5000 rpm for 15 min. Upon decanting the supernatant into a second 50-mL HDPE vial, the sample was extracted again using 2.5 mL of a mixture containing 9:1 (v/v) methanol and 1% acetic acid in the original vial under sonication for 15 min at 60° C. This process of acetic acid washing followed by methanol/acetic acid extraction was repeated one more time. Finally, a 10-mL of 1% acetic acid washing was performed in the same manner. For each sample, all washes and extracts are combined, resulting in a total volume of ˜35 mL.

To concentrate the extracts and avoid potential matrix interferences, a solid phase extraction was performed to treat the extract. Briefly, a 500-mg Superclean Envi-18 SPE cartridge was preconditioned with 10 mL of methanol followed by 10 mL of 1% acetic acid at a rate of 1 drop/sec under vacuum. After loading the extract, two 7.5 mL aliquots of DI water were used to rinse the sample vials and drawn through cartridge, and the target analytes (PFOS and PFOA) were eluted with 4 mL methanol at a rate of 1 drop/sec and collected in 1:1 (v/v) methanol/acetone-washed polypropylene vial. The procedure was repeated with a second 4 mL aliquot of methanol. The eluent was then concentrated under a flow of high purity nitrogen to remove all the solvents (water/methanol). Then, appropriate amounts of the 96:4% (vol/vol) methanol:water solution and the internal standards (M4PFOA/PFOS) were added to the collection vial to bring the volume to 2 mL. Upon mixing and full dissolution of PFOS in the solvent, the samples were stored at 4° C. and analyzed for PFAS.

Based the soil analysis, PFOS was the major PFAS found in the soil, and hence was followed in the subsequent desorption and photodegradation experiments.

Batch desorption experiments were conducted in 43 mL amber glass vials with polypropylene caps. Briefly, 2 g of the homogenized soil were mixed with 40 mL of a desorbing solution containing dispersants Corexit EC9500 or SPC1000 from 50 to 500 mg L⁻¹ with or without NaCl. The mixtures were then sealed and rotated on an end-to-end tumbler at 50 rpm. At predetermined times, duplicate vials are centrifuged at 5000 rpm for 15 minutes to separate the soil from the aqueous phase. The supernatant was then spiked with a stock solution of M8PFOA/PFOS to give a surrogate concentration of 20 μg L⁻¹. Finally, the supernatant was subjected to the SPE cleanup process to minimize the matrix effects on the subsequent analysis.

It is noted that the desorption from the batch experiments was not exhaustive, i.e., it does not presents the maximum amounts of PFAS that can be eluted by a certain desorbing agent. Rather, the method was utilized to screen the most effective desorbing agent based on the equilibrium distribution of PFAS between soil and the liquid phases.

Successive desorption tests were further conducted to determine the maximum desorbable PFOS in the field soil using Corexit EC9500A, which outperformed SPC1000. Following each apparent desorption equilibrium, the vials were centrifuged and supernatants pipetted out, and replaced with 300 mg L⁻¹ of fresh Corexit EC9500A. At predetermined times (0, 1, 8, and 24 h), the vials were sacrificially sampled, and the supernatants were analyzed for the PFAS concentration in the aqueous phase following the same procedures as described above. The successive desorption tests were carried out in triplicate to assure data quality.

To reuse the spent dispersant solution, PFOS in the spent solution was removed by adsorption using Ga/TNTs@AC (Ga=2 wt. %). First, 2 g of PFOS-loaded soil was mixed with 40 mL of solution containing 300 mg L⁻¹ of Corexit EC9500A. The mixture was then sealed and rotated on an end-to-end tumbler at 50 rpm. At equilibrium, duplicate vials were sampled and centrifuged at 4000 rpm for 10 minutes to separate the soil from the aqueous phase. Then, the supernatant was transferred into clean vials containing 0.2 or 0.4 g of Ga/TNTs@AC (material dosage=5 or 10 g L⁻¹) to initiate the re-adsorption. At predetermined times, 1 mL of each supernatant was taken and analyzed for PFOS concentration upon proper QA/AC procedures (see SOP).

Following the adsorption equilibrium, PFOS desorbed from the field soil was reloaded on Ga/TNTs@AC. Upon gravity settling, 36 mL of the solution was pipetted out. Then, the remaining mixture of Ga/TNTs@AC+4 mL dispersant solution was transferred to the quartz UV reactor through 6 mL DI water rinsing, making the total solution volume to 10 mL. The reactor was then placed into the Rayonet chamber photo-reactor (Southern New England Ultraviolet CO., Branford, Conn., USA), and the photodegradation was conducted under UV at a wavelength of 254 nm and a light intensity of 21 mW cm². After 4 h UV irradiation, the sample vials were taken out and analyzed for the F⁻ in the aqueous phase and PFOS remaining in the solid phase. The tests were carried out at both material dosages, 5 and 10 g L⁻¹ to compare the PFOS degradation and defluorination rates.

The treated dispersant solution was re-used in another cycle of desorption test with the field soil. Briefly, 2 g of the field soil was mixed with the treated dispersant solution, which was replenished with 10% of the fresh dispersant solution (total dispersant solution volume=40 mL). The PFOS concentration in the aqueous phase was then followed as described above.

Table 19 summarizes the PFOA and PFOS concentrations detected in the field soil. PFOS was found to be the main PFAS in the field soil, with a concentration of 1507.7±37.6 ng g⁻¹. Likewise, PFOA was also detected but with a much lower concentration (21.4±6.8 ng g⁻¹). The extraction results indicate that PFOS should be the major concern at this site, which is consistent with the past usage and the fact that PFOS is more persistent in the environment than PFOA.

TABLE 19
Concentrations of PFOA and PFOS in
the soil of the Willow Grove site.

| Compounds | Concentration (ng g⁻¹) | SD |
|---|---|---|
| PFOS | 1507.7 | 37.6 |
| PFOA | 21.4 | 6.8 |

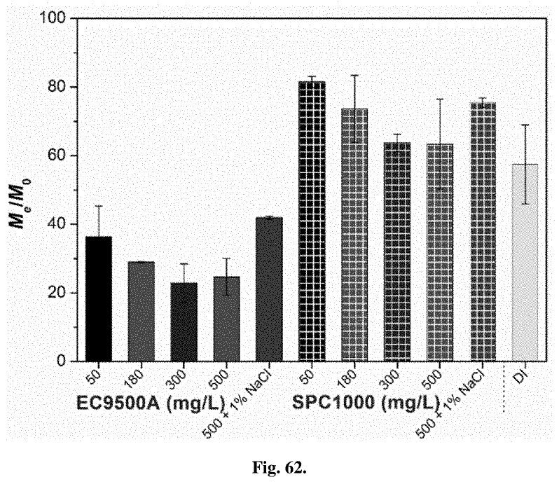

FIG. 62 compares the equilibrium desorption extents of PFOS using the following desorbing reagents: Corexit EC9500A at 50, 180, 300 and 500 mg L⁻¹, SPC1000 at 50, 180, 300, and 500 mg L⁻¹, Dispersant with 1 wt. % NaCl, and DI water. All the dispersant concentrations are higher than the respective critical micelle concentrations (CMC), e.g., the apparent CMC value for Corexit EC9500A was reported to be 22.5 mg L⁻¹. Generally, the PFOS desorption efficiency followed the order of: Corexit EC9500>Corexit EC9500+1% NaCl>DI water>SPC1000>SPC1000+1% NaCl. While Corexit EC9500 was able to effectively desorb PFOS from the field soil, SPC1000 actually inhibited the desorption process. The inhibitive effect of SPC1000 is attributed to the dual-mode and concentration-dependent effects of surfactants, namely, surfactants may partition between the soil and the aqueous phase and the adsorbed surfactants may increase the adsorption of hydrophobic compounds via adsolubilization. It is also noteworthy that the presence of 1 wt. % NaCl inhibited PFOS desorption in both dispersant systems. Like surfactants, NaCl may have some contrasting effects on the sorption or desorption of PFOS. On the one hand, Cl⁻ anions may help elute PFOS due to competitive adsorption for the anion exchange sites on the soil, on the other hand, Na⁺ cations can enhance PFOS uptake by suppressing the negative soil surface potential.

At a dosage of 50 mg L⁻¹, Corexit EC9500 was able to partition ˜64% of soil-sorbed PFOS into the solution phase. Increasing the dispersant concentration from 50 mg L⁻¹ to 300 mg L⁻¹ increased the PFOS desorption extent to 77%, indicating the low concentrations of the dispersant can effectively desorb PFOS from soil.

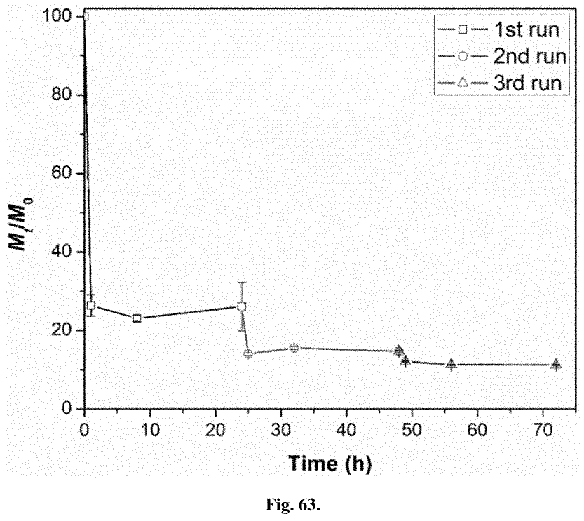

It should be noted that the desorption was not exhaustive because of the limitation of the batch system, where desorbed PFOS remained in the aqueous phase, preventing further desorption. When the tests were carried out in the successive desorption mode (i.e., replacing the eluent with fresh dispersant solution after each batch), >90% of PFOS was desorbed at a dispersant concentration of 300 mg L⁻¹ (FIG. 63). The desorption reached equilibrium in 1 h for every run and the amount of PFOS desorbed in three runs were 75%, 12%, and 3.5%, respectively. From a soil remediation viewpoint, the residual (˜10%) PFOS is hardly bioavailable, and thus, the dispersant washing may meet the treatment goal. In practice, the soil washing can be conducted either in situ by sprinkling the dispersant solution through the soil bed or through a column/tank flushing configuration. As such, more efficient PFOS elution can be achieved using lower dispersant concentration than in the batch experiments. Typically, oil dispersants are mixtures of anionic and nonionic surfactants and solvents. Oil dispersants are able to lower the oil-water interfacial tension, thereby breaking surface oil slicks into fine droplets and facilitating dispersion and dissolution of hydrophobic compounds into the water column. Corexit EC9500A contains two nonionic surfactants (48%) and an anionic surfactant (35%) in an aqueous hydrocarbon solvent (17%). Table 20 shows salient surfactant compositions of the dispersant. Corexit EC9500A has been listed as an EPA-approved dispersant and have been most widely used in coping will oil spills, and low concentrations of the dispersant is believed to show minimal adverse environmental effects. Compared to other soil washing agents, especially organic solvents such as methanol, Corexit EC9500A is not only much more cost-effective, but also much “greener”.

TABLE 20
Characteristics of surfactant compositions in the oil dispersant Corexit EC9500A.

| | | | | Critical micelle | |
|---|---|---|---|---|---|
| | | | Molecular | concentration | |
| | Ionic | | weight | (CMC) | |
| Surfactants | property | Molecular formula | (g/mol) | (mg L⁻¹) | Chemical structure |
| Polyoxy- ethylene (20) sorbitan monooleate (Tween 80) | Neutral | C₆₄H₁₂₄O₂₆ | 1310 | 14 (Yeom et al., 1995) | 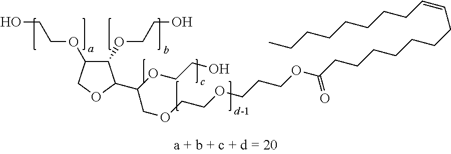 |
| Polyoxy- ethylene (20) sorbitan trioleate (Tween 85) | Neutral | C₆₀H₁₀₈O₈•(C₂H₄O)ₙ | | 23 (Wan and Lee, 1974) | 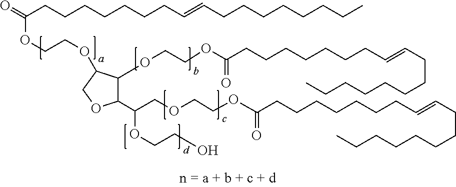 |
| Sodium dioctyl sulfo- succinate (SDSS) | Anionic | C₂₀H₃₇NaO₇S | 444.56 | 578 (Yehia, 1992) | 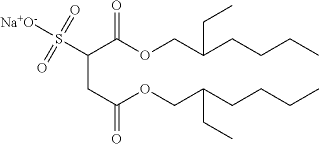 |

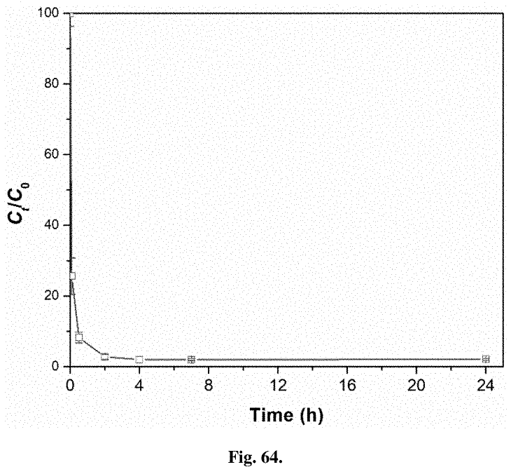

FIG. 64 shows re-adsorption kinetics of PFOS from the spent dispersant using Ga/TNTs@AC (Ga=2 wt. %). Although the desorption rate appeared slower compared to that in the DI water system, >98% of PFOS was reloaded on the photocatalyst within 4 h of contact time. Further increasing the material dosage to 10 g L⁻¹ resulted in faster and complete removal of PFOS from the spent dispersant solution. The highly effective adsorption enables the PFOS to be photodegraded subsequently through the same “Concentrate-&-Destroy” strategy, and allows for reuse of the treated dispersant solution in another cycle of desorption.

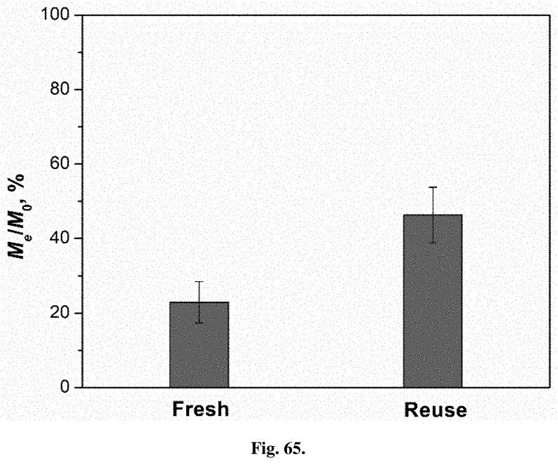

FIG. 65 compares the desorption efficiencies of fresh and treated dispersant solution (replenished with 10% fresh Corexit EC9500A) in the batch desorption systems. While the fresh dispersant eluted 77% of PFOS from the filed soil, the recycled solution eluted 54% of PFOS desorption, which is quite promising despite some inhibitive matrix effects from some dissolved soil components.

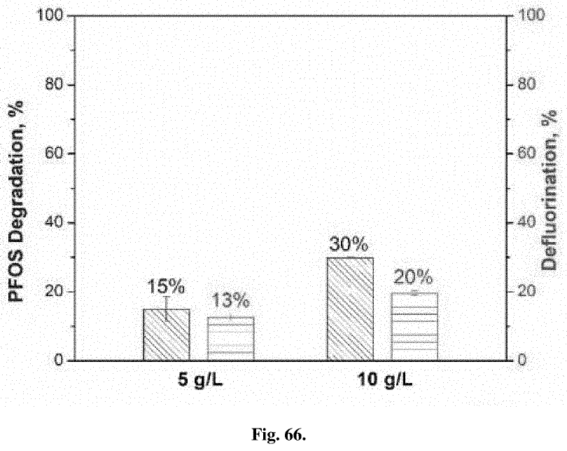

FIG. 66 shows that Ga/TNTs@AC degraded ˜18% of the pre-loaded PFOS when the adsorption was carried out using 5 g L⁻¹ of the photocatalyst, and the degradation was elevated to 30% when 10 g L⁻¹ was used to adsorb the PFOS from the spent dispersant solution. The much lower degradation than in the DI water system can be attributed to: 1) the unnecessary use of too high concentration of the dispersant and inhibition from the adsorbed dispersant, 2) inhibition from some dissolved components or suspended solids, especially DOM, and 3) competition of other photo-degradable co-solutes including other PFAS. Nonetheless, 13% and 20% of PFOS were completely mineralized in the two systems, respectively.

1. A method of removing one or more contaminants from an environmental medium, the method comprising the step of contacting a composite composition comprising i) a carbonaceous material and ii) a photocatalyst with the environmental medium to adsorb the contaminant on a surface of the composite composition.

2. The method of claim 1, wherein the contaminant is a per- and polyfluoroalkyl substance (PFAS).

3. The method of claim 2, wherein the PFAS is perfluorooctanoic acid (PFOA).

4. The method of claim 2, wherein the PFAS is perfluorooctane sulfonate (PFOS).

5. The method of claim 1, wherein the environmental medium is air.

6. The method of claim 1, wherein the environmental medium is soil.

7. The method of claim 1, wherein the environmental medium is water.

8. The method of claim 1, wherein the method further comprises the step of degrading the contaminant.

9. The method of claim 8, wherein the degrading is carried out by exposing the pre-adsorbed contaminant to light.

10. The method of claim 1, wherein the method further comprises the step of regenerating the composite composition, and wherein the step of regenerating comprises degrading the contaminant.

11. The method of claim 1, wherein the carbonaceous material comprises activated charcoal (AC).

12. The method of claim 1, wherein the carbonaceous material comprises a carbon sphere (CS).

13. The method of claim 1, wherein the photocatalyst comprises a metal.

14. The method of claim 1, wherein the photocatalyst comprises a metallic oxide.

15. The method of claim 14, wherein the metallic oxide is titanate.

16. The method of claim 14, wherein the metallic oxide is titanium dioxide (TiO₂).

17. The method of claim 14, wherein the metallic oxide is iron (hydr)oxide (FeO).

18. The method of claim 1, wherein the photocatalyst comprises bismuth phosphate (BiOHP).

19. The method of claim 1, wherein the composite composition comprises a dopant.

20. The method of claim 20, wherein the dopant is selected from the group consisting of iron, cobalt, nickel, gallium, bismuth, palladium, copper, aluminum, zirconium, platinum, and any combination thereof.
